(19) United States
(12) Patent Application Publication
(10) Pub. No.: US 2025/0326378 A1
(43) Pub. Date: Oct. 23, 2025

(54) WHEEL CHOCK POSITIONING ARRANGEMENT

(71) Applicant: 9172-9863 Quebec Inc., Terrebonne (CA)

(72) Inventors: CATALIN DUMITRASCU, LAVAL (CA); DANIEL GROTHÉ, TERREBONNE (CA); GAÉTAN JETTÉ, MASCOUCHE (CA); HANS DEWYSE, SHERBROOKE (CA); JEAN-FRANCOIS FORGET, MONTRÉAL (CA); IAN HAVILL, VAUDREUIL-DORION (CA); JEAN-FRANCOIS GAUTHIER, TERREBONNE (CA); RAPHAËL LÉANDRE, MASCOUCHE (CA)

(73) Assignee: 9172-9863 Quebec Inc., Terrebonne, QC (CA)

(21) Appl. No.: 19/135,166

(22) PCT Filed: Dec. 21, 2023
(86) PCT No.: PCT/IB2023/063121

§ 371 Date: Jun. 3, 2025

Related U.S. Application Data
(60) Provisional application No. 63/476,464, filed on Dec. 21, 2022.

(51) Int. Cl. B60T 3/00

(52) U.S. Cl. CPC B60T 3/00

(57) ABSTRACT

A wheel chock positioning arrangement comprises a support arm arrangement including a lateral support; a mounting plate connected to the lateral support; a first cantilever arm assembly and a second cantilever arm assembly each having opposite first ends and second ends, the first ends are pivotally mounted to the mounting plate for angular displacement of the first assembly and the second assembly in a transversal direction between a storage position and an extended position; and the second ends are pivotally connected to a wheel chock mount configured to receive a wheel chock; a track extending longitudinally; and a carriage for mounting the support arm arrangement and configured to move along the track. The arrangement can position and retrieve the wheel chock. Wear, tear and mechanical stress on system components are reduced, vehicle immobilization safety is improved and a misalignment of the chock when engaging a base plate can be tolerated.

### TECHNICAL FIELD

The technical field relates generally to the positioning of wheel chocks for preventing vehicles from moving in an unauthorized or accidental manner, for instance at a loading dock, a parking lot, or any other locations.

### BACKGROUND OF THE INVENTION

Wheel chocks are devices that can be positioned immediately next to a wheel of a parked land vehicle so as to act as an obstacle in the event of an unauthorized or accidental departure attempt. This event can happen as a result, for instance, of an error or a miscommunication, or because someone is trying to steal the vehicle. Many other situations exist, including ones where the vehicle movements are caused by other factors, such as trailer creep where the motion of a lift truck entering and exiting the semi-trailer can cause separation between the vehicle and the dock leveler, or gravity acting on the vehicle when parked on a sloping surface, to name just a few. Wheel chocks can also be used to create an obstacle in an arrival direction to prevent an arrival attempt, and some wheel chocks can be designed to work in two opposite directions. Other situations are possible as well.

Various wheel chock restraint systems have been suggested over the years. Examples can be found, for instance, in U.S. Pat. Nos. 10,793,119 and 10,864,895, as well as in U.S. patent application publication No. 2020/0216276 A1. The entire contents of these patent cases are hereby incorporated by reference. The underside of the wheel chocks can include, among other things, a plurality of teeth or other kinds of blocking elements engaging corresponding features provided on ground-anchored base plates on which the wheel chocks are set to create an obstacle in a given direction. Other configurations and arrangements exist as well.

Various wheel chock handling systems have also been suggested over the years for use with wheel chocks for helping a user in positioning the wheel chock by hand on a base plate. Examples can be found, for instance, in U.S. Pat. Nos. 7,032,720, 7,264,092 and 10,864,895, and in U.S. patent application publication No. 2021/0261101 A1, as well as in PCT patent application publication No. WO 2022/016265 A1. The entire contents of these documents are hereby incorporated by reference.

Among other things, some wheel chock handling systems can include articulated devices or units with one or more spring-loaded mechanisms. The user of a wheel chock handling system can be the driver of the vehicle or someone working at the site. Still, some spring-assisted articulated devices or units can be designed to generate a pulling force sufficient to overcome the friction of the wheel chock on the ground to bring it back automatically to its storage position. This can be useful to keep a wheel chock out of the way of pedestrians and incoming vehicles when a user omits to bring it back by hand to its storage position and simply moves it to the side of the base plate in the vicinity of its previous location.

While existing articulated spring-assisted devices have been useful for the handling of wheel chocks, they often required some compromises during their design and/or installation, and this often leads to a number of challenges. For instance, the spring-generated pulling force to bring a wheel chock back automatically to its storage position from a given location on the side of a base plate has to overcome the friction of the wheel chock on the ground, even when it is placed at the farthermost position, but it is also desirable that the pulling force does not require excessive manipulative efforts to position the wheel chock by hand, or does not cause the wheel chock to arrive unduly fast at its storage position when released at a given distance, among other things. They also require a person to be physically present next to the wheel chock to conduct a manual intervention for positioning it on the base plate and, later, for disengaging it from the base plate and at least moving it to the side thereof.

Using a mechanized system for positioning a wheel chock at every stage would be a desirable approach. Such a system can involve, for instance, moving the wheel chock next to the vehicle along a first path to set the wheel chock at a desired longitudinal position along the base plate, and then moving the wheel chock under the vehicle along a second path to place it immediately in front of a wheel to be blocked and establish a latching engagement between the wheel chock and the base plate. However, in practice, implementing this approach is not so simple, and there are many challenges to be solved. For instance, a wheel chock is generally made of a material that is much harder than that of the base plate, and pushing or pulling a wheel chock over a base plate can potentially damage its upper surface after only a brief time, particularly when there is a sizable downward vertical force involved. Attempts to mitigate the deterioration of base plates by using rollers, low-friction coatings or layers, or other features between them met with only limited success. They also create recurring maintenance costs. Still, using base plates made of a harder material would generally increase their manufacturing costs far beyond what most customers are willing to pay.

Moving a wheel chock along the first path generally requires that the underside of the wheel chock be kept at a minimum distance above the blocking elements on the base plate. The wheel chock could also, in theory, be kept vertically above the surface of the base plate until it reaches its final position. However, this may not always be possible or desirable. Among other things, a wheel chock is usually a heavy object and the horizontal distance over which it must be carried along the second path can be relatively important. It would then require an immensely complex and costly arrangement in most implementations. The available space next to a wheel to be blocked by the wheel chock can sometimes be extremely limited and/or irregular. In many instances, the wheel chock can barely fit in the available space and can only be inserted and retrieved when moving it sideways while its underside engages the surface on the base plate.

Positioning a wheel chock on a base plate can also be difficult when the orientation of the teeth under the wheel chock is not perfectly parallel to that of the blocking elements on a base plate. Such misalignment can be caused by the cumulation of the tolerance imperfections of multiple parts. Using stringent tolerances for most of the parts could potentially mitigate the likelihood of jamming a wheel chock on the base plate due to a severe misalignment, but stringent tolerances can also hinder the natural self-alignment by gravity of a wheel chock and even maintain it above the top edges of the blocking elements or resulting in a jam. Other factors, such as deficiencies in the positioning of some of the parts during the installation, ground imperfections or land subsidence, wear and tear of parts, or damages resulting from vehicle collisions to name just a few, could also play a role at some point.

Still, loading docks and other similar locations are often very rough and demanding environments for several reasons. Any machinery or equipment operating at these locations has to be very robust and durable. A commercial implementation involving a sophisticated high-end equipment, such as a robotic arm or the like, to position a wheel chock would not be cost-effective. In most cases, a sophisticated high-end equipment would add prohibitive costs and unnecessary complexities for manufacturing, installing and maintaining the equipment, thereby increasing overall costs far beyond what most customers are willing to pay.

Various systems have been suggested over the years to position a blocking feature, such as a tubular member, next to a wheel instead of using a wheel chock. Such blocking feature can be considerably smaller and lighter compared to a wheel chock. In some systems, a first translation mechanism is provided for moving the distal end of the blocking feature in and out of a space next to a wheel to be blocked, and a second translation mechanism is provided for moving the blocking feature along the longitudinal direction when the blocking feature is out of the space next to a wheel. The structure of such a system is also what holds the blocking feature if the wheel forcefully pushes thereon during an unauthorized or accidental maneuver attempt. The structures of these systems as well as the various mechanisms must then be extraordinarily strong and resistant. The stretched length of the blocking feature is generally relatively limited because the moment of force at the proximal end of the blocking feature during an unauthorized or accidental maneuver attempt could otherwise exceed what the system can withstand if it is too long. This is generally not a desirable approach.

Overall, there is always room for further improvements in this area of technology.

### SUMMARY OF THE INVENTION

The proposed concept relates to an arrangement capable of positioning a wheel chock that can be very robust and durable, and that does not involve a sophisticated high-end equipment.

According to an aspect, a wheel chock handling apparatus comprises a support arm arrangement including a lateral support; a mounting plate connected to the lateral support; a first cantilever arm assembly and a second cantilever arm assembly each having opposite first ends and second ends, the first ends being pivotally mounted to the mounting plate for angular displacement of the first assembly and the second assembly in a transversal direction between a storage position and an extended position; and the second ends being pivotally connected to a wheel chock mount configured to receive a wheel chock thereon; a track extending in a longitudinal direction; and a carriage for mounting the support arm arrangement thereto and configured to move along the track.

In embodiments, the support arm arrangement enables the mounting plate to pivot downwardly thereby lowering the wheel chock.

In embodiments, the wheel chock mount comprises a support member extending substantially transversally and a body of the wheel chock defines an aperture for receiving the support member therethrough.

In embodiments, the apparatus further comprises a wheel mounted to the support member for supporting the support member, and the wheel chock is configured to receive the support member and the wheel through the aperture.

In embodiments, the apparatus further comprises displacement detection means for measuring a displacement of the carriage along the track.

In embodiments, the track further comprises a guide bar including a plurality of apertures, the apertures being substantially equally sized and substantially equally spaced, and the displacement detection means comprises a sensor assembly mounted to the carriage and configured to detect a beam traveling through the apertures.

In embodiments, the displacement detection means comprises an index wheel mounted to the carriage and in contact with the track.

In embodiments, the carriage comprises at least one low-friction element disposed between the track and the carriage for sliding the carriage on the track.

In embodiments, the carriage comprises at least one wheel mounted thereto for displacing the carriage on the track.

In embodiments, the apparatus further comprises: one or more sensors for determining a position of at least one wheel of a vehicle; displacement detection means for measuring a displacement of the carriage along the track; a controller operatively connected to the one or more sensors, the displacement detection means, the support arm arrangement and the carriage; the controller being configured to cause the apparatus to displace the wheel chock supported on the support arm arrangement to a wheel blocking position associated with the determined position of the at least one wheel of the vehicle.

In embodiments, the apparatus further comprises at least one mechanical fuse subassembly, the mechanical fuse subassembly comprising an outboard portion proximate the wheel chock and an inboard portion proximate the second ends of the first and second assemblies, the outboard portion and the inboard portion being configured to separate in response to a force exerted on the mechanical fuse subassembly exceeding a predetermined threshold.

In embodiments, the apparatus further comprises at least one frangible element configured to break in response to a predetermined force, extending between the outboard portion and the inboard portion, and the at least one frangible element provides the sole structural connection between the outboard portion and the inboard portion.

In embodiments, the mechanical fuse subassembly comprises a ball portion on one of the outboard and inboard portions and a socket portion on the other of the outboard and inboard portions, the socket portion being configured to receive the ball portion therein and to disengage from the ball portion in response to a predetermined force.

In embodiments the track further comprises heating means for heating at least a portion of the track.

In embodiments, the first assembly and the second assembly are articulated. In embodiments, the first assembly and the second assembly are telescopic.

In embodiments, the first assembly and the second assembly are mounted to the mounting plate so as to define an angle between the first assembly and the second assembly.

In embodiments, the first assembly and the second assembly are mounted to the mounting plate so as to substantially define a V-shape having a downwardly pointing vertex.

In embodiments, the wheel chock is configured to stop both forward and rearward movement of a vehicle wheel.

According to an aspect, a method of securing a wheel chock on a base plate, comprises determining a longitudinal and a transversal position of a wheel to be blocked by the wheel chock; determining a blocking position for the wheel chock in response to the longitudinal and transversal position of the wheel; displacing the wheel chock in a longitudinal direction towards the blocking position; engaging the wheel chock with the base plate; and sliding the wheel chock on the base plate in a transversal direction to the blocking position.

In embodiments, the method further comprises providing first engagement means on a bottom portion of the wheel chock and second engagement means on the base plate, the second engagement means being complementary to the first engagement means, and the engaging the wheel chock comprises engaging the second engagement means and the first engagement means to prevent movement of the wheel chock in the longitudinal direction.

According to an aspect, a vehicle immobilization system comprises a ground-anchored base plate; at least one wheel chock, the wheel chock having a body defining an aperture for receiving a support member therethrough; transversal displacement means having a first end mounted to a base and a second end having the support member mounted thereto, configured to: support the wheel chock on the support member; displace the wheel chock in a transversal direction between a storage position and an extended position; and longitudinal displacement means for displacing the transversal displacement means in a longitudinal direction.

In embodiments, the system further comprises sensor means for detecting: a position of at least one wheel of a vehicle; and a position of the transversal displacement means in the longitudinal direction; a processor operatively coupled to the sensor means, the transversal displacement means and the longitudinal displacement means; non-transient storage means for storing instructions that, when executed by the processor, cause the system to: detect the position of the at least one wheel of the vehicle; determine a blocking position for the at least one wheel chock to block movement of the wheel in a departure direction; cause the longitudinal displacement means to displace the transversal displacement means to a longitudinal position associated with the blocking position; and cause the transversal displacement means to extend from a storage position towards an extended position to place the wheel chock in the blocking position.

In embodiments, the wheel chock comprises a plurality of teeth disposed on a lower surface and the base plate comprises a plurality of transversally extending projections complementary to the plurality of teeth.

Details on the several aspects of the proposed concept and on various possible combinations of technical characteristics or features will become apparent in light of the following detailed description and the appended figures.

### BRIEF DESCRIPTION OF DRAWINGS

FIG. 1 is a semi-schematic side view illustrating an example of a wheel chock located in front of a wheel of a generic vehicle.

FIG. 2 is an enlarged side view of some of the parts shown in FIG. 1.

FIG. 3 is a front isometric view illustrating an example of a wheel chock and a base plate similar to the ones of FIG. 1.

FIG. 4 is a rear isometric view illustrating an example of a wheel chock having a longitudinal extension.

FIG. 5 is a front isometric view of the wheel chock of FIG. 4.

FIG. 6 is a side view of the wheel chock of FIG. 4.

FIG. 7 is an enlarged fragmentary view of some of the teeth under the wheel chock shown in FIG. 6.

FIG. 8 is a front view of the wheel chock of FIG. 4.

FIG. 9 is an isometric view illustrating an example of a bidirectional wheel chock.

FIG. 10 is a semi-schematic view illustrating an example of a generic vehicle having a swap body configuration at a loading dock where a wheel chock restraint system can be provided.

FIG. 11 is an isometric view illustrating an example of a wheel chock restraint system having a wheel chock positioning arrangement as proposed herein.

FIG. 12 is an enlarged isometric view of the wheel chock restraint system of FIG. 11.

FIG. 13 is a top plan view of the wheel chock restraint system shown in FIG. 12.

FIG. 14 is a side view of the wheel chock restraint system shown in FIG. 12.

FIG. 15 is a partial isometric view of the wheel chock restraint system shown in FIG. 12.

FIG. 16 is a view similar to FIG. 15, taken from another viewpoint.

FIG. 17 is an isometric view of the support arm subsystem in the wheel chock positioning arrangement shown in FIG. 12.

FIG. 18 is an enlarged semi-schematic isometric view of the proximal end of the support arm subsystem of FIG. 17.

FIG. 19 is an enlarged isometric view of the wheel chock mount provided at the distal end of the support arm subsystem of FIG. 17.

FIG. 20 is an enlarged isometric view of the wheel chock shown in FIG. 12.

FIG. 21 is a bottom isometric view illustrating the wheel chock and the wheel chock mount of FIGS. 19 and 20 when assembled.

FIG. 22 is an end view of the wheel chock restraint system of FIG. 12 when the support arm subsystem is in a retracted position and the carriage subsystem is at or near the proximal end of the rail.

FIG. 23 is a partial side view illustrating some of the components of the wheel chock positioning arrangement shown of FIG. 12.

FIG. 24 is a partial isometric bottom view illustrating some of the components of the wheel chock positioning arrangement shown of FIG. 12.

FIG. 25 is a partial isometric top view illustrating some of the components of the wheel chock positioning arrangement shown of FIG. 12.

FIG. 26 is a partial isometric view of some of the components of the wheel chock positioning arrangement shown in FIG. 12.

FIG. 27 is an abridged and semi-schematic side view of the wheel chock being in a latched engagement with the base plate.

FIG. 28 is a partial cutaway view illustrating the wheel chock mount inside the wheel chock shown in FIG. 22.

FIG. 29 is a semi-schematic top view depicting semi-schematically an example of the engagement of the wheel chock over the blocking elements of the base plate when the wheel chock is misaligned in a first direction about a yaw axis.

FIG. 30 is a bottom isometric view corresponding to the situation shown in FIG. 29.

FIG. 31 is a semi-schematic top view similar to FIG. 29 where the misalignment is in a second direction that is opposite to the first direction in FIG. 30.

FIG. 32 is a bottom isometric view corresponding to the situation shown in FIG. 31.

FIGS. 33 to 36 are simplified end views illustrating in sequence the support arm subsystem moving from a retracted position to a fully extended position to set the wheel chock on the base plate.

FIG. 37 is an enlarged end view of the parts at the proximal end of the support arm subsystem shown in FIG. 36.

FIG. 38 is a schematic top view depicting an example of a carriage subsystem moving along the rail to detect where the wheel chock can be set on the base plate.

FIG. 39 is a simplified block diagram schematically depicting an example of a control system that can be provided with the wheel chock restraint system as provided herein.

FIG. 40 is an isometric view illustrating an example of a generic vehicle having a swap body configuration at a loading dock where the wheel chock restraint system of FIG. 12 is provided.

FIG. 41 is an isometric view illustrating another example of a wheel chock restraint system having a wheel chock positioning arrangement as proposed herein.

FIG. 42 is a partial isometric view of a wheel chock restraint system similar to the one shown in FIG. 41.

FIG. 43 is an end view of the wheel chock restraint system shown in FIG. 41.

FIG. 44 is an enlarged view of the track subsystem and some of the components of the carriage subsystem of FIG. 43.

FIG. 45 is a partial isometric view of some of the parts at the proximal end of the support arm subsystem of FIG. 41.

FIG. 46 is an enlarged cutaway view of what is shown in FIG. 45.

FIG. 47 is an abridged top view illustrating a wheel chock positioning arrangement similar to the one of FIG. 41 but having another kind of drive system.

FIG. 48 is a side view of what is shown in FIG. 47.

FIG. 49 depicts an example of a generic vehicle backing up within the loading dock without being properly aligned with the geometric centerline.

FIGS. 50 to 54 are views illustrating an example of a mechanical fuse subassembly that can be provided on the wheel chock positioning arrangement as proposed herein.

FIG. 55 is a partial cutaway view illustrating the wheel chock mount and a positioning wheel inside a wheel chock supported on the support arm subsystem according to an embodiment.

FIG. 56 is a cutaway view of an index wheel displacement detection means mounted to the carriage subsystem according to an embodiment.

FIG. 57 is a schematic view of a track subsystem comprising heating means according to an embodiment.

FIG. 58 is a partial cutaway view of a mechanical fuse subassembly according to an embodiment.

FIG. 59 is an isometric view of the mechanical fuse subassembly of FIG. 58.

FIG. 60 is a partial cutaway view of a mechanical fuse subassembly according to an embodiment.

FIG. 61 is a partial isometric view of a carriage subsystem comprising wheels according to an embodiment.

### DETAILED DESCRIPTION OF THE INVENTION

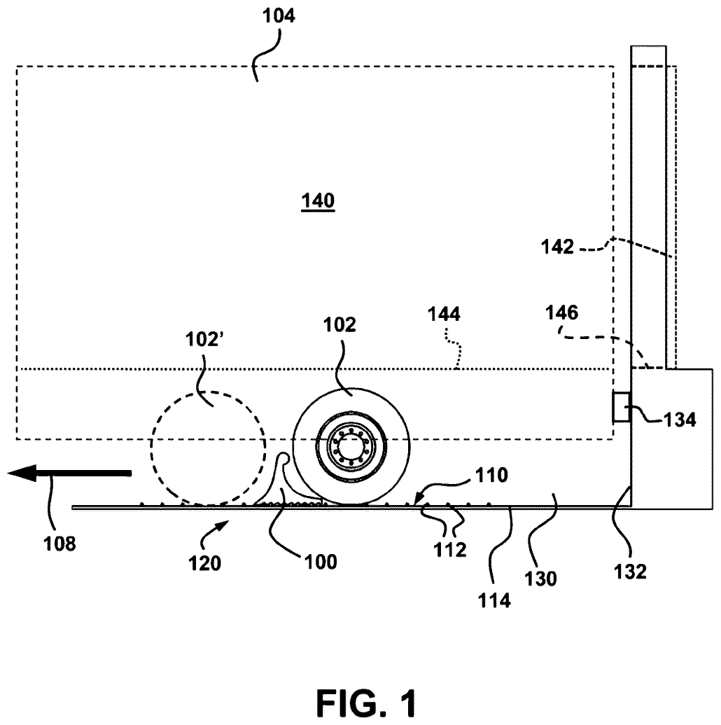

FIG. 1 is a semi-schematic side view illustrating an example of a wheel chock 100 located in front of a wheel 102 of a generic vehicle 104. It should be noted that the wheel chock 100 and the vehicle 104 illustrated in FIG. 1 are only provided for the sake of explanation. The wheel chock 100 is positioned for preventing the vehicle 104 from moving away in the event of an unauthorized or accidental departure attempt. The wheel chock 100 creates an obstacle to be removed only at the appropriate moment when the vehicle 104 is authorized to leave. It is otherwise left in position.

Wheel chocks can also be used to create an obstacle in an arrival direction to prevent an arrival attempt, and the generic term “maneuver attempt” applies to all situations. Nevertheless, terms such as “departure attempt” and “moving away” may still be used in the interest of brevity, and these terms are not excluding the possibility of using of wheel chocks for preventing vehicles from moving into position in the event of an unauthorized or accidental arrival attempt. While throughout the present specification wheel chocks may be described using specific reference to shape and size features, including but not limited to the features shown in the drawings, it is understood that positioning arrangements, systems and methods described herein may be applicable to any object configured to provide an obstacle to the departure of a vehicle. Accordingly, for example, the wheel chock positioning arrangement provided herein may be used with any wheel chock which may be transversally displaced for blocking a wheel.

The generic vehicle 104 depicted in FIG. 1 is a semi-trailer and only the rear portion is schematically illustrated. A semi-trailer is designed to be hauled by a truck tractor, but this is only one among a multitude of possibilities. Among other things, the wheel chock 100 can be used to restrict the motion on the ground of other kinds of vehicles, including vehicles that are not semi-trailers such as small delivery vans, and even vehicles completely unrelated to the transport industry. Other variants are possible as well.

In FIG. 1, the illustrated vehicle 104 has a tandem axle arrangement located at the rear of the vehicle 104, and the wheel chock 100 is positioned within an intervening space between the wheel 102 of the rearmost axle and an adjacent wheel 102′ on the other axle that is immediately in front of the wheel 102. These wheels 102, 102′ are non-driving wheels in the example. Other configurations and arrangements are possible. Among other things, the wheel chock 100 can be positioned elsewhere and does not necessarily need to be placed next to a wheel at the rear of a vehicle. The wheel chock 100 can also cooperate with a wheel that is not part of a tandem axle arrangement. Truck tractors with large engines can generate a very considerable torque, and while wheel chocks often work more efficiently with non-driving wheels since driving wheels are more likely to generate an uplifting force when the traction conditions are optimal and then roll over or otherwise overrun a wheel chock in the event of an unauthorized or accidental maneuver attempt, the wheel chock 100 can still be used to block a driving wheel if this is found to be appropriate for the intended purpose or for other reasons. Other variants are possible as well.

Many vehicles, like the semi-trailer of the example shown in FIG. 1, can have a dual wheel arrangement where two wheels are positioned side-by-side at each end of each axle. In this case, the word “wheel” used in the context of the wheel chock 100 refers to the exterior wheel and/or the interior wheel at the end of the corresponding axle, depending on where the wheel chock 100 is positioned. Most implementations will have the wheel chock 100 facing only the exterior wheel because it is generally easier to access from the side of the vehicle 104. However, the wheel chock 100 can also be placed simultaneously in front of the two side-by-side wheels in some situations, or even only in front of the interior wheel in others. The word “wheel”, even in a singular form, means either only one of the side-by-side wheels or both side-by-side wheels simultaneously in the context of a dual wheel arrangement. Other configurations and arrangements are possible. Among other things, the wheel chock 100 can be used with a wheel that is not part of a dual wheel arrangement. Some wheel arrangements may include more than two juxtaposed wheels at each end of a same axle, and the preceding remark also applies to this situation. Other variants are possible as well.

The wheel chock 100 in the example shown in FIG. 1 is designed to cooperate with a ground-anchored base plate 110. The base plate 110 is generally a relatively flat structure anchored to the ground that does not create a significant obstruction to movements or to other operations occurring at the location where it is installed. The wheel chock 100 and the base plate 110 are part of a wheel chock restraint system 120. This wheel chock restraint system 120 is designed so that a latching engagement can be established between the wheel chock 100 and the base plate 110 simply by putting the wheel chock 100 at the right place on the base plate 110 without having to use removable mechanical fasteners, for instance as bolts or the like. The latching engagement allows the wheel chock 100 to be in a wheel-blocking position so as to prevent the vehicle 104 from moving in at least one direction. The wheel chock 100 prevents the vehicle 104 from moving in the direction that corresponds to the longitudinal axis 108 in the illustrated example. The base plate 110, for instance, prevents the wheel chock 100 from being pushed away over a significant distance in the event of an unauthorized or accidental maneuver attempt. Other configurations and arrangements are possible. Among other things, the base plate 110 can be replaced by another feature or even be omitted from the wheel chock restraint system 120 in some implementations. While a wheel chock 100 and a base plate 110 are often designed to work without the need of using removable mechanical fasteners for holding the wheel chock 100 in position, removable mechanical fasteners could nevertheless be employed in some specialized implementations. Others may include locking devices to prevent the wheel chock from being removed by an unauthorized person. Other variants are possible as well.

The illustrated wheel chock 100 has an overall wheel chock height, an overall wheel chock length, and an overall wheel chock width. The wheel chock height is the vertical dimension that is generally perpendicular to the top surface of the base plate 110. The wheel chock length is the horizontal dimension that is generally parallel to the longitudinal axis 108, and the wheel chock width is the horizontal transversal dimension that is perpendicular to the longitudinal axis 108. The direction of motion may not always be the forward travel direction of the vehicle 104 in all situations, and the wheel chock 100 can also be positioned and/or configured to prevent the wheel chock 100 from moving in its rearward travel direction. The terms “front” and “rear” are also contextual. For instance, in FIG. 1, the front side of the wheel chock 100 can be facing the front side of the wheel 102 of the vehicle 104. Other variants are possible as well.

The vehicle 104 in the example of FIG. 1 is shown as being parked at a loading dock 130 and its rear side is adjacent to a wall 132 located at a back end of the loading dock 130. The rear bumper of the vehicle 104 can rest against one or more cushions 134 provided on the wall 132, as shown schematically in FIG. 1. The wall 132 can be part of a commercial building, for instance a warehouse, a distribution center, or the like. Other configurations and arrangements are possible. Among other things, while the term “loading dock” generally refers to areas where freight or other kinds of payload can be loaded or unloaded in vehicles, this term is used herein essentially for the sake of simplicity. Loading docks are not the only locations where wheel chocks can be provided. For instance, wheel chocks can be used in parking lots or areas, at truck stops, etc. The term “ground” refers generally to the top surface of the loading dock 130 or of any other location where the wheel chock restraint system 120 is provided, whether this location is indoors or outdoors. The ground can have a relatively flat and horizontal top surface, as shown, but this top surface can also be slopped and/or irregular on at least a portion thereof. It is not necessarily a paved surface and in the case of an indoor location, it can be referred to as the floor. The wheel 102 of the vehicle 104 can rest over the top surface of the base plate 110 and/or over the top surface of the ground when the vehicle 104 is parked and in some cases, even when the wheel 102 pushes on the wheel chock 100. For the sake of simplicity, the generic term “ground surface” cover all these possibilities. Other variants are possible as well.

The vehicle 104 illustrated in FIG. 1 includes a cargo compartment 140. Access into the cargo compartment 140 can be made, for instance, using a rear door provided on the vehicle 104. This rear door will generally be in registry with the centerline of a corresponding dock door 142 when the vehicle 104 is parked at the end of the loading dock 130. The dock door 142 allows an opening provided through the wall 132 to be selectively closed and opened. The floor 144 inside the cargo compartment 140 and the floor 146 in front of the dock door 142 are shown being at the same height or at a similar height. A ramp or dock leveler (not shown) can otherwise be used between both floors 144, 146 if the height difference is too important for allowing a person or equipment, such as a lift truck or the like, to load and/or unload the cargo inside the cargo compartment 140 of the vehicle 104. Other configurations and arrangements are possible. Among other things, the vehicle 104 may not include a rear door and/or it can be designed differently in some implementations. The loading dock 130 can also be designed differently. Other variants are possible as well.

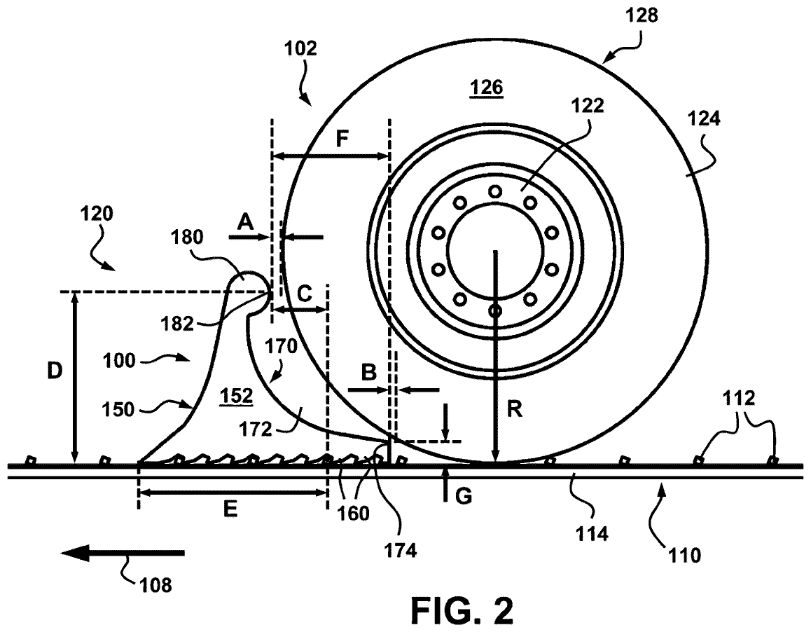

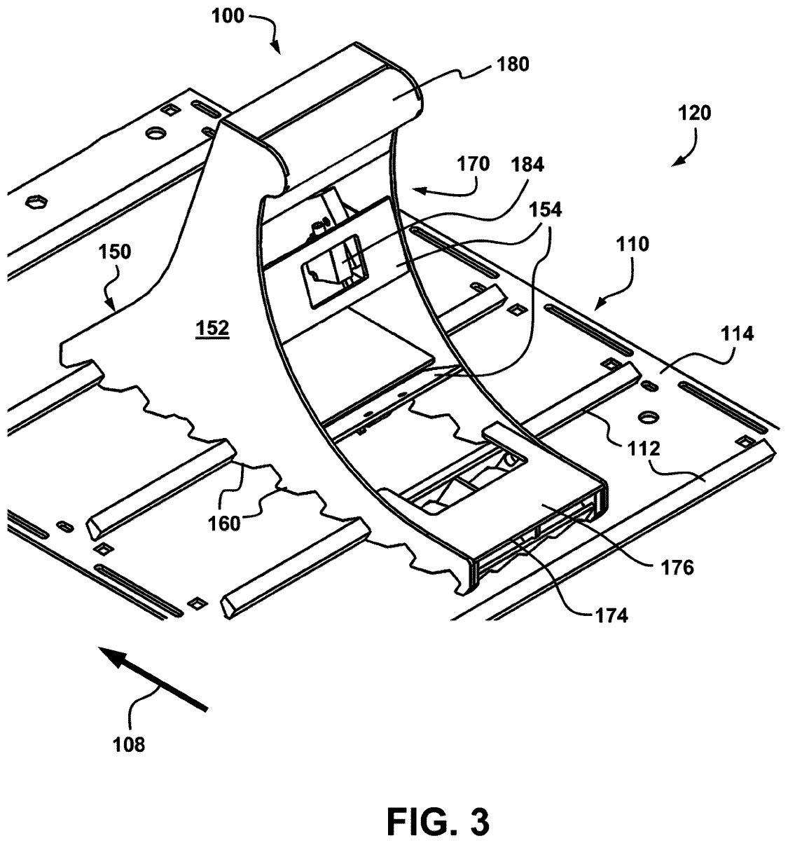

The illustrated base plate 110 includes a plurality of blocking elements 112 transversally disposed thereon. These blocking elements 112 can also be seen in FIGS. 2 and 3. FIG. 2 is an enlarged side view of some of the parts shown in FIG. 1. FIG. 3 is a front isometric view illustrating an example of a wheel chock 100 and a base plate 110 similar to the ones of FIG. 1. The blocking elements 112, also sometimes referred to as teeth or stoppers, can be in the form of transversally disposed rectilinear bars or rods projecting above the top side of corresponding main plate members 114. Each blocking element 112 can extend uninterruptedly across the width of the base plate 110 and can be spaced apart from one another along the longitudinal axis 108, for instance regularly spaced individually or in pairs, as shown. Each blocking element 112 in the illustrated example has two opposite slanted flat surfaces, one at the front and one at the rear. Other configurations and arrangements are possible. Among other things, each blocking element 112 or at least some of them can be designed differently, for instance, be in the form of two or more spaced apart segments instead of extending uninterruptedly across the width of the base plate 110. The lateral surfaces of the blocking elements 112 can also be designed completely differently in some implementations. The blocking elements 112 can be in the form of holes, for instance holes made through the main plate members 114. Other variants are possible as well.

The blocking elements 112 and the main plate members 114 can be made of a metallic material, such as aluminum, steel, or alloys thereof. For instance, the main plate members 114 can be sturdy flat metal sheets having a rectangular shape, and the blocking elements 112 can be rigidly attached to the main plate members 114 by welding. Among other things, the main plate members 114 can include a plurality of transversally extending slots so that the bottom side of each blocking element 112 can be inserted in a corresponding one of these slots and then welded from the underside of the main plate members 114 when the base plate 110 is manufactured. This method can leave the junctions between the blocking elements 112 and the top surface of the main plate members 114 substantially free of welding cords. Other configurations and arrangements are possible. Among other things, nonmetallic materials can be used in some implementations. The blocking elements 112 can be rigidly attached to the main plate members 114 without using slots, for instance be welded from the top side. Other manufacturing methods and processes are also possible, including ones not involving welding. Other variants are possible as well.

The base plate 110 has an elongated and substantially overall rectangular shape in the illustrated example. It extends linearly along the longitudinal axis 108. The base plate 110 can be made much longer than required and this can allow the wheel chock 100 to be placed at many different longitudinal positions to accommodate vehicles of assorted sizes and wheel layouts. Having these numerous possible positions for the wheel chock 100 can be particularly useful to maximize the versatility of the wheel chock restraint system 120. The base plate 110 can be manufactured in small sections to be assembled on site, each section corresponding, for instance, to a main plate member 114 with a number of blocking elements 112 or other features. Such modular design can be convenient for customizing the length of the base plate 110 by simply using the corresponding number of sections for each site. Each section can include a plurality of spaced-apart holes around the periphery of the main plate members 114 for receiving the fasteners, for instance using bolts or any other kinds of mechanical fasteners to anchor them to the ground or floor. The modular design can also decrease manufacturing costs, as well as costs related to storage, transportation, handling, and installation of the base plate 110. Other configurations and arrangements are possible. Among other things, in some implementations, the base plate 110 can be designed to only provide a limited number of possible positions, or even only a single position. Some or even all the sections of a base plate 110 can be spaced apart from one another instead of being juxtaposed end to end, and these sections or groups of sections do not necessarily need to be in registry with one another with reference to the longitudinal axis 108 to be considered as being part of a same base plate. Manufacturing the base plate 110 as a single monolithic element still remains a feasible option. The base plate 110 can be anchored to the ground without using mechanical fasteners such as bolts or the like. The main plate members 114 can have non-rectangular shapes and/or not be in the form of flat sheets in some implementations. Other variants are possible as well.

As shown in FIG. 2, the wheel 102 can include a rigid rim 122 at the center, for instance one made of a metallic material, and a tire 124 that is mounted around the rim 122. The rim 122 can be bolted or be otherwise removably attached to a rotating element at the end of a corresponding axle of the vehicle 104. The tire 124 can be made of a resilient material, for instance a material including rubber or the like, and can be a gas-inflated pneumatic tire filled with a gas under pressure, for instance pressurized air or pure nitrogen. Other configurations and arrangements are possible. Among other things, some tires can be designed without having a gas-inflated interior, and the wheel 102 may not necessarily include a tire or a resilient material in some implementations. For instance, the wheel 102 could be made entirely of a rigid material. Other variants are possible as well.

The illustrated tire 124 includes two opposite sidewalls 126, one being on the exterior side (outboard side) and the other on the interior side (inboard side). It also includes a circumferentially disposed tire tread 128. The tire tread 128 is essentially the part of the tire 124 engaging the ground surface. Even when the cargo compartment 140 is empty, the contact area between the bottom of the tire tread 128 and the ground surface is relatively flat, and the tire tread 128 is thus not entirely circular. The size of this contact area, however, can significantly increase during the loading process when the vehicle 104 is a semi-trailer or another kind of vehicle that can transport a heavy payload. Pneumatic tires for semi-trailers are often pressurized at a relatively high pressure, for instance, about 100 psi (689 kPa), but the size of the contact area may still noticeably increase because semi-trailers are often designed to carry heavy payloads that can be several times the weight of the empty vehicle. For the sake of simplicity, the tire tread 128 can be considered to be in an undeformed state when the cargo compartment 140 is empty, and FIG. 2 illustrates the tire tread 128 being essentially circular for this reason.

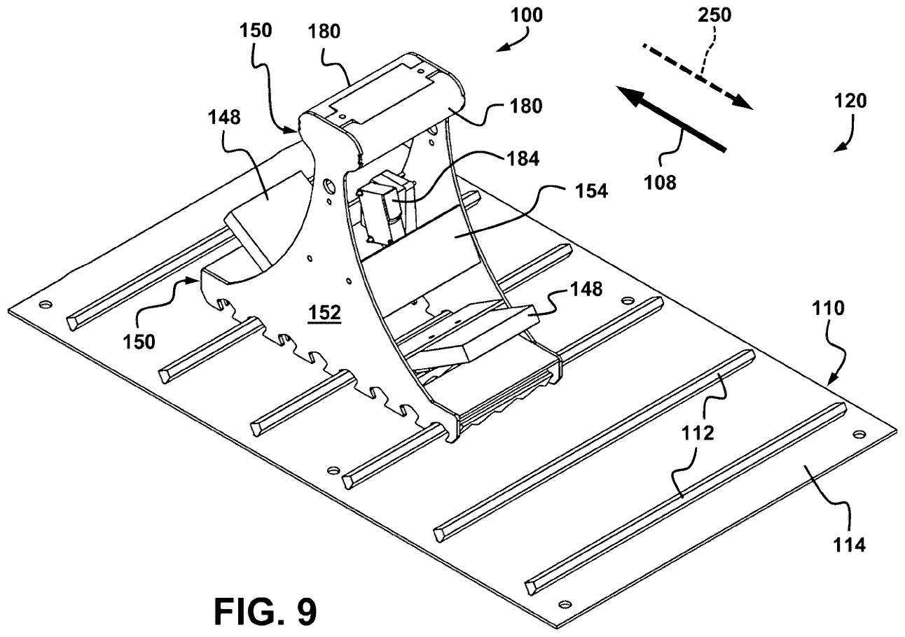

An increase in size of the contact area during the loading process can occur during the loading process, for instance when a payload is loaded into an empty cargo compartment 140. The front end of the wheel chock 100 is generally placed relatively close to the tire tread 128, and this could cause this front end to become stuck underneath the wheel 102 if the contact area increased to a point where it now overlaps this part of the wheel chock 100. This overlapping can prevent the wheel chock 100 from being removed. In some situations, if the vehicle 104 cannot be backed up just enough to free the wheel chock 100, for instance because the vehicle 104 is already at the very end of the loading dock 130, it may be necessary to remove at least some of the payload from the cargo compartment 140. This situation is highly undesirable since it will create delays and additional work, among other things. A resilient spacer 148 (see FIG. 9) can be useful to help users keep an optimum distance between the wheel 102 and the wheel chock 100 when it is set in position over the base plate 110. The resilient spacer 148 can be made, for instance, of rubber or another flexible material, and can project at an oblique angle at the front and/or the rear of a wheel chock 100. Other configurations and arrangements are possible. Among other things, the spacer can be designed differently and/or be made of a different material in some implementations, and it may also be omitted in others. Other variants are possible as well.

The wheel chock 100 includes a main body 150. The main body 150 is the supporting rigid structure of the wheel chock 100. It includes a reinforced framework having the structural strength to resist the forces applied by the wheel 102 on the wheel chock 100 in the event of an unauthorized or accidental maneuver attempt. It is an assembly of various strong rigid parts, for instance parts made of a metallic material such as aluminum, steel, or alloys thereof, and that can be welded or otherwise rigidly attached to form the main body 150. It is often constructed as an open structure to save weight. The main body 150 of the illustrated wheel chock 100 has a monolithic construction, thus no moving or easily detachable part once it is fully assembled, for improving strength and for minimizing the manufacturing costs. Additional components can be added to the main body 150, if desired and/or required, but in general, a monolithic main body does not require any movable parts to cooperate with the base plate 110. Other configurations and arrangements are possible. Among other things, the main body 150 can still have a construction that is not monolithic or entirely monolithic in some implementations. Other materials or combination of materials can be used in the construction of the main body 150. Other variants are possible as well.

In the illustrated example, the main body 150 includes two spaced-apart main side members 152. The side members 152 can be in the form of substantially vertically extending plates that are rigidly connected together using an intervening substructure, which substructure can include a plurality of transversal plate members 154, as shown. The side members 152 form the exterior and interior walls of the main body 150 of the wheel chock 100. Other configurations and arrangements are possible. Among other things, the main body 150 does not necessarily need to be sized and shaped as shown and/or described in all implementations. The various components can also be designed, positioned and/or attached differently. Other variants are possible as well.

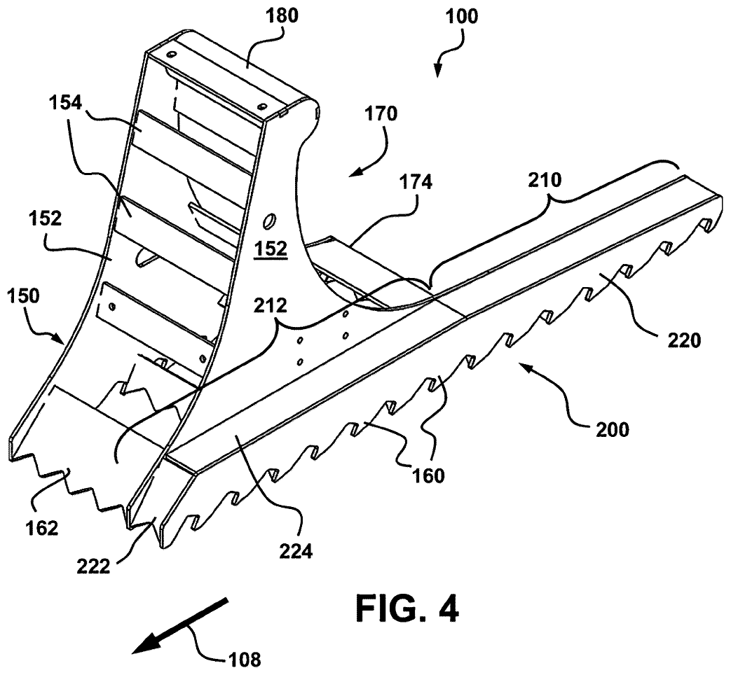

As best shown in FIGS. 2 and 3, blocking elements, referred to hereafter as “teeth 160”, are provided on the underside of the main body 150 of the wheel chock 100. They are designed to cooperate with the blocking elements 112 on the base plate 110 when the wheel chock 100 is set and oriented parallel to the longitudinal axis 108. Each tooth 160 can be formed by the surfaces and/or edges of two or more transversally spaced apart corresponding subparts forming a row in the transversal direction, these subparts being for instance added features and/or remnants between successive cutouts machined along the bottom of each side member 152. Some of the teeth 160 can also include and/or be formed by other elements, for instance transversally extending reinforcing flanges or blades 162 (FIG. 4) spanning between two corresponding subparts within the same row. Other configurations and arrangements are possible. Among other things, the wheel chock 100 can be designed differently and at least some of the teeth 160 can be formed using added subparts or elements instead of cutouts. The wheel chock 100 can include blocking elements that are not teeth in some implementations, and at least some of the blocking elements could even be omitted entirely in others. Other variants are possible as well.

In the illustrated example, the blocking elements 112 of the base plate 110 include opposite bottom-facing surfaces, and the subparts and/or the other elements of each tooth 160 under the wheel chock 100 include a slanted surface or edge configured and disposed to engage or otherwise fit under a corresponding one of these bottom-facing surfaces. At least some of the teeth 160 can include sharp edges at their free end in some implementations. These sharp edges can be useful for instance in freezing weather conditions when the base plate 110 has some ice or snow thereon. The edges can pierce through a layer of ice or packed snow to reach the blocking elements 112. Other configurations and arrangements are possible. Among other things, the blocking elements 112 of the base plate 110 can be designed without having bottom-facing surfaces. For instance, the teeth 160 under the wheel chock 100 could be configured and disposed to extend under a bottom edge of the blocking elements 112 so as to resist upward vertical forces. The sharp edges at the free end of the teeth 160 under the wheel chock 100 can be omitted in some implementations. Other variants are possible as well.

The longitudinal distance between two successive teeth 160 under the wheel chock 100 can be subdivided into a fraction of the longitudinal distance between two successive blocking elements 112 on the base plate 110. This allows the position of the wheel chock 100 on the base plate 110 to be adjusted by increments that are smaller than the longitudinal distance between two successive blocking elements 112, thereby providing a greater flexibility for positioning of the wheel chock 100 with reference to the wheel 102. For instance, the spacing between each tooth 160 under the illustrated wheel chock 100 corresponds approximately to one third of the spacing between two successive blocking elements 112. Still, the longitudinal distance between two successive teeth 160 can be made slightly smaller, for instance about 1 mm or 2 mm smaller. The wheel chock 100, however, is designed so that this narrower tooth spacing does not create any mismatch between the blocking elements 112 and the underside of the main body 150. The offset spacing is a feature that can be useful to prioritize the frontmost engagement between a tooth 160 and a corresponding blocking element 112, leaving the other adjacent sets slightly away from one another. Among other things, it mitigates the likelihood of inadvertently creating a pivot point at the backmost engagement between a tooth 160 and a blocking element 112, which pivot point can increase the risks of tipping when the wheel chock 100 is subjected to a significant force during an unauthorized or accidental maneuver attempt. Other configurations and arrangements are possible. Among other things, while having spacing between successive teeth 160 that is a fraction of the spacing between two successive blocking elements 112 and/or having a slightly narrower overall spacing for the teeth 160 can generally be desirable, it is possible to omit one or even both of these features in some implementations. Other variants are also possible as well.

The wheel chock 100 includes a wheel-facing side 170, and this wheel-facing side 170 can be greatly recessed so as to provide a tire deformation cavity 172. The tire deformation cavity 172 can have a generally curved profile to follow the circular shape of the wheel 102, as shown for instance in FIG. 2. The tire deformation cavity 172 can also be located immediately below a wheel-engaging bulge 180 projecting outwardly towards the front at a top end of the wheel-facing side 170. This wheel-engaging bulge 180 can be made integral with the main body 150. It provides the main engagement point, hereafter called the bulge engagement point 182, on which the tire 124 of the wheel 102 will initially exert its pressing force at the top of the wheel chock 100 in the event of an unauthorized or accidental maneuver attempt. The main purpose of the tire deformation cavity 172 is to capture as much volume as possible of the tire tread 128 below the wheel-engaging bulge 180 when the wheel 102 is urged forcefully against the wheel chock 100. Other configurations and arrangements are possible. Among other things, the wheel-engaging bulge 180 could be replaced by another feature in some implementations. It is also possible to design the wheel chock 100 without a bulge or a similar feature, or with a bulge having a completely different configuration or purpose. For instance, the bulge can be used as a base for a horizontal lateral bar that projects transversally on the side of the wheel chock 100. This configuration can be useful when there is not enough space to position an entire wheel chock directly in front of a wheel. The space limitation can be the result, for instance, of the presence of a mudguard, an underride guard, an adjacent wheel set, or another feature or structure. Other variants are possible as well.

The illustrated wheel-engaging bulge 180 has a non-puncturing shape to prevent the tire 124 from being punctured or be otherwise damaged. It can include a smooth and continuous rounded convex surface extending transversally, as shown. When viewed from the side, the wheel-engaging bulge 180 has a profile that can include a top surface portion and a bottom surface portion, and the approximate medial line at the boundary between these top and bottom surface portions is approximately where the bulge engagement point 182 is located. Other configurations and arrangements are possible. Among other things, other shapes and designs are also possible. For instance, the wheel-engaging bulge 180 can be designed differently. Other variants are possible as well.

The front end of the main body 150 includes an upper front edge 174 extending transversally along a top plate 176 (FIG. 3). This top plate 176 has an upper surface that is configured and disposed to be engaged by the tire tread 128 if the wheel 102 moves against the wheel chock 100 or if the contact area significantly increases in size during the loading process. The upper front edge 174 is relatively deep within the space between the tire tread 128 and the ground surface. Other configurations and arrangements are possible. Among other things, the front end of the main body 150 can be designed differently in some implementations, including without a top plate 176. Other variants are possible as well.

FIG. 2 shows that in the illustrated example, the horizontal distance A between the tire tread 128 and the bulge engagement point 182 is slightly smaller than the horizontal distance B between the tire tread 128 and the upper front edge 174 of the wheel chock 100. This can be useful in the event of an unauthorized or accidental maneuver attempt because the wheel 102 can then exert a vertical downward force on the wheel chock 100 at least just before it contacts the bulge engagement point 182. For instance, the wheel chock 100 could have been simply put on a base plate 110 on which there is a layer of ice or packed snow preventing them from fully engaging one another. The local weight applied on the top plate 176 is only a small fraction of the total weight of the vehicle 104 but it is often sufficient to pierce or otherwise break a layer of ice or packed snow. An analogous situation can occur when there is sand or small debris of some sort on the base plate 110. Other configurations and arrangements are possible. Among other things, the wheel chock 100 can be designed differently in some implementations, including having the horizontal distance B smaller than the horizontal distance A. Other variants are possible as well.

FIG. 2 further shows the horizontal distance C between the bulge engagement point 182 and the location of the frontmost engagement between a blocking element 112 and a corresponding one of the teeth 160. It also shows the vertical distance D between the bulge engagement point 182 and the ground surface, which is the top surface of the base plate 110 in FIG. 2 since the wheel 102 rests on the base plate 110 in this example. The horizontal distance E is between the rearmost end of the wheel chock 100 engaging the ground surface, and the location of the frontmost engagement between a blocking element 112 and a corresponding one of the teeth 160. The horizontal distance F is between the upper front edge 174 and the bulge engagement point 182. The vertical distance G is between the upper front edge 174 and the ground surface. R is the radius of the wheel 102 in an undeformed state.

In general, a wheel chock having a minimum C/D ratio of 0.3, and a minimum E/D ratio of 1.1 will perform much better. Increasing at least one of these ratios is generally desirable, but this can be particularly challenging because changing one dimension can affect another ratio and/or other factors or parameter, such as the overall weight, the manufacturing costs, the maximum force it can withstand, etc. For instance, increasing the size of a wheel chock will generally increase the overall weight, and there is almost always a maximum chock weight beyond which the wheel chock 100 will be considered too heavy to be handled by most users. There are also other aspects or goals that those skilled in the art may want to consider when designing a wheel chock, such as a minimum D/R ratio of 0.8 to mitigate the risks of having the wheel 102 rolling over the wheel chock 100. On the other hand, simply making the wheel chock taller to improve the D/R ratio can cause the C/D ratio to fall under 0.3, and this may not be desirable. Designing a relatively small and lightweight wheel chock having a remarkably high rollover resistance and a very high-tipping resistance is often not easy. Other configurations and arrangements are possible. Among other things, the specified ratios and/or factors can be different in some implementations. Other parameters and/or combinations of parameters can be considered. Other variants are possible as well.

If desired, the base plate 110 can include a peripheral slanted rim (not shown) to smooth the edges of the base plate 110. The peripheral rim can also be useful to protect the blocking elements 112 when snow removal operations or similar tasks are conducted. The peripheral rim can include longitudinal and/or transversal rim portions on each section. These rim portions can be welded or otherwise attached on each main plate member 114 during manufacturing and/or during installation. Other configurations and arrangements are possible. Among other things, the peripheral rim can be designed differently in some implementations, and it can also be entirely omitted in others. Other variants are possible as well.

If desired, the base plate 110 can be provided with a heating system (not shown) capable of melting ice and snow in wintry weather conditions. This heating system can be for instance in the form of a heated mat, or include electrical wires or pipes with a heating fluid provided within a substructure buried in the ground right under the base plate 110. Other configurations and arrangements are possible. Among other things, the heating system can be designed differently in some implementations, and can be omitted in others. Other variants are possible as well.

The wheel chock 100 can include one or more sensors, such as a wheel sensor 184 located inside the main body 150 to detect the presence of the wheel 102 next to the wheel chock 100 during operation, for instance the proximity of the tire thread 128 of the wheel 102 on the wheel-facing side 170. Various kinds of wheel sensors 184 can be used, such as non-contact sensors (for instance photocells, lasers or the like). The wheel sensor 184 illustrated in FIG. 3 is based on an optical approach and it is located underneath one of the transversal members 154. This transversal member 154 has a relatively large rectangular opening at the center to provide a suitable field of vision across the opening while the solid part of the transversal member 154 protects it. Other configurations and arrangements are possible. Among other things, other kinds of sensors, for instance mechanical sensors, can be used. The wheel sensor 184 can be positioned and/or arranged differently, and it can be omitted in some implementations. Other variants are possible as well.

The wheel sensor or sensors 184 can be linked to one or more remote systems, for instance security and safety systems, using wired and/or wireless communication (not shown in FIG. 3). These systems can use signals from the wheel sensor or sensors 184 to trigger distinct functions and/or to prevent other systems from operating unless the wheel chock 100 is properly placed next to a wheel 102. Triggered functions can include, for instance, issuing audible and/or visual alarm signals if a sensor does not indicate a proper positioning of the wheel chock 100 while someone attempts to initiate a task that must only be done if the wheel chock 100 is properly positioned. Signals from the wheel sensor or sensors 184 can also be sent to other active security and safety systems, such as interlocks, locking systems, barriers, etc. Some may require the use of identification (ID) cards and/or rely on biometric sensors, such as retina, fingerprints, or others. Other configurations and arrangements are possible. Among other things, at least one of these features can be designed differently and/or can be omitted in some implementations. The wheel sensor 184 can be linked or otherwise connected to other devices. Other variants are possible as well.

FIG. 4 is a rear isometric view illustrating an example of a wheel chock 100 having a longitudinal extension 200. This extension 200 is provided along the bottom of the wheel chock 100 and includes, among other things, a portion 210 protruding beyond the front end of the main body 150 in a direction that is generally parallel to the longitudinal axis 108. It also includes a base portion 212 that is laterally adjacent to the bottom of the main body 150. The protruding portion 210 can define a marginally downward angle with reference to its base portion 212, and it can also decrease in height towards the free end thereof, as shown. Most of the parts of the extension 200, if not all of them, are made of a strong rigid material, such as a metallic material. Other configurations and arrangements are possible. Among other things, the extension can be omitted in some implementations. The protruding portion 210 and the base portion 212 of the extension 200 can be designed differently in others. The extension 200 can include one or more nonmetallic materials. While the wheel chock 100 in FIG. 4 and the ones shown in other figures are essentially configured for use on one side (e.g., the left side) of the vehicle 104, the ones for use on the opposite side (e.g., the right side) of the vehicle 104 will generally be substantially mirror symmetrical to those illustrated. They are not separately illustrated only for the sake of brevity. Other variants are possible as well.

In use, the wheel chock 100 can be positioned so that the protruding portion 210 of the extension 200 extends along the tire sidewall 126 of the corresponding wheel 102 over a relatively long distance. This allows the wheel chock 100 to engage one or more blocking elements 112 located beyond the front end of the main body 150, which is something that was not previously possible because of inherent physical limitations. The presence of the extension 200 increases the efficiency of the wheel chock 100 by increasing the horizontal distance between the bulge engagement point 182 and the location of the frontmost engagement between a blocking element 112 and a corresponding one of the teeth 160. This dimension corresponds to the horizontal distance C in FIG. 2. The horizontal distance E is also increased.

While moving the frontmost engagement between a blocking element 112 and a tooth 160 further away from the bulge engagement point 182 can be a very desirable feature, the extension 200 can also be useful for other reasons. Among other things, it can give more flexibility to designers and even allow the main body 150 of the wheel chock 100 to have a shorter front end without significantly decreasing its efficiency. Having a shorter front end, for instance one that is shorter of the equivalent of one tooth 160, could be a desirable feature in some implementations to mitigate the risks of having the wheel chock 100 completely stuck under the tire 124 after a significant increase of the vehicle weight. This can be particularly useful for a wheel chock restraint system that includes an arrangement for automatically positioning and removing the wheel chock 100 on the base plate 110. With the extension 200, the front end of the main body 150 can be made shorter. A shorter front end can also keep the wheel 102 on the ground surface during an unauthorized or accidental maneuver attempt, thereby preventing the vertical distance D in FIG. 2 from decreasing. This vertical distance D decreases slightly when the wheel 102 rolls over the top plate 176 (FIG. 3) since its upper surface is vertically above the ground surface. Even a small decrease can sometimes be enough to overcome the wheel chock 100 if there is a very intense and powerful maneuver attempt. A shorter front end, however, may prevent the local weight of the vehicle 104 to push the wheel chock 100 through a layer of ice or packed snow, for instance, but this can be mitigated by using embedded heaters or other kinds of systems to melt the ice or snow on the base plate 110. This may also not be necessary in regions where the climate is not prone to the accumulation of ice or snow, or when a wheel chock restraint system is installed indoors. Other configurations and arrangements are possible. Among other things, the front end of the main body 150 can be made shorter for other reasons, and an automatic positioning arrangement can be implemented without necessarily having a wheel chock with a shorter front end. Other variants are possible as well.

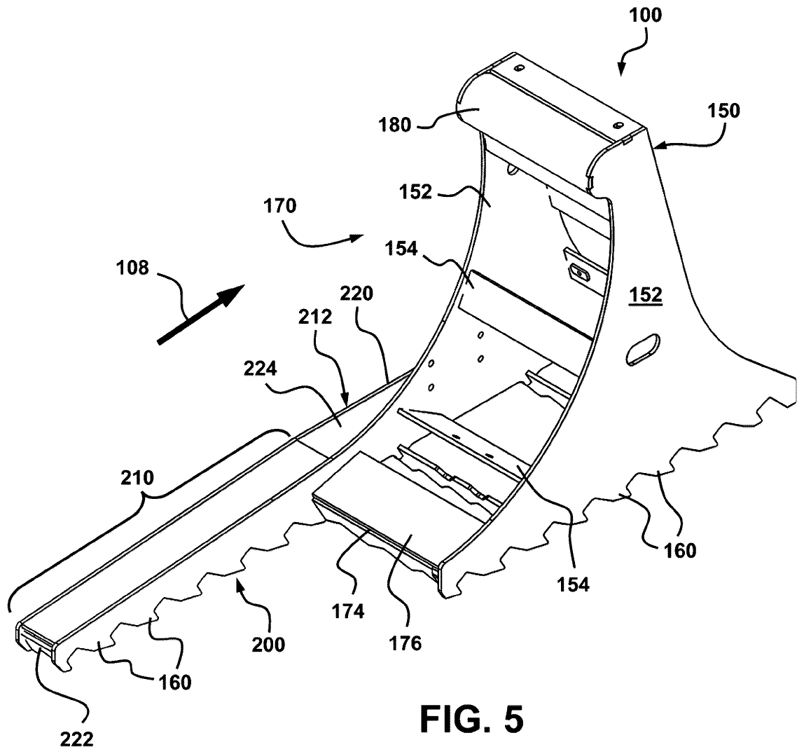

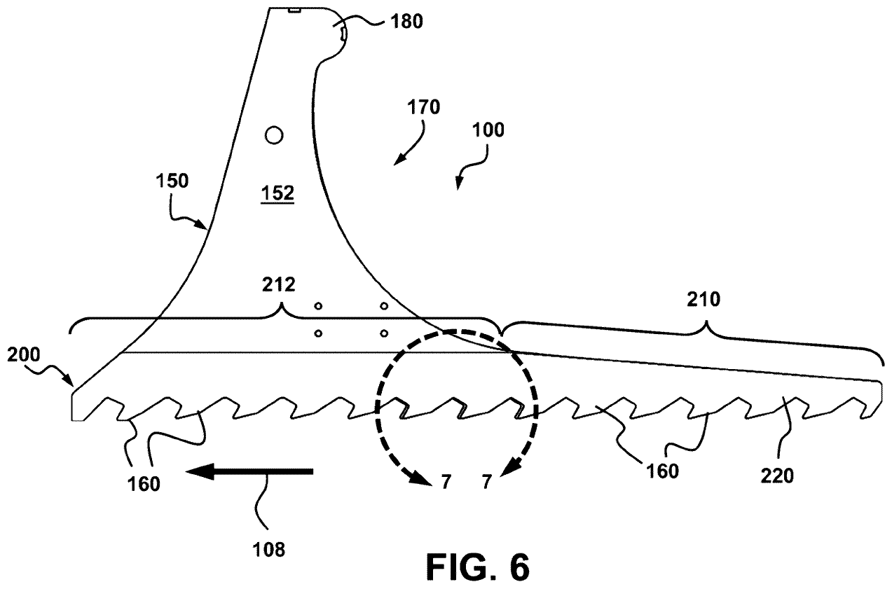

FIG. 5 is a front isometric view of the wheel chock 100 of FIG. 4, and FIG. 6 is a side view thereof. As can be seen, the front end of one of the side members 152, namely the one on the exterior side, can include an elongated front section. The exterior side member 152 is then significantly longer compared to the interior one in the illustrated wheel chock 100, and this elongated front section forms a part of the extension 200. The extension 200 also includes a lateral member 220 disposed substantially parallel next to the bottom of the exterior side member 152. The lateral member 220 can be rigidly attached to the exterior side member 152 using an intervening substructure, for instance one including a plurality of transversally extending brackets 222 (see also FIGS. 4 and 8) spanning at various spaced apart locations along the extension 200, as shown. At least some of these brackets 222 can be subparts for some of the teeth 160. The illustrated extension 200 also includes an elongated horizontally disposed top strip 224 covering the top side of the extension 200. Other configurations and arrangements are possible. Among other things, the extension 200 can be designed differently in some implementations. In its simplest form, the extension 200 can include only a protruding portion 210 formed by the elongated front section of the exterior side member 152 under which at least one additional tooth 160 is provided beyond the upper front edge 174. The extension 200 may not necessarily always be at least partially made integral with the main body 150 of the wheel chock 100. For instance, it can be a completely independent part or assembly of parts that is affixed to the main body 150, and it can also be implemented as a retrofit kit to be installed on other models of wheel chocks, including older ones. The intervening substructure of the extension 200 can be in the form of a longitudinally extending beam having a rectangular cross-section. The parts or groups of parts can be rigidly attached together and/or to the main body 150 by welding and/or using mechanical fasteners. The extension 200 can be rigidly attached to the main body 150 through an intervening element, such as a longitudinally extending beam having a rectangular cross-section. Another one among the numerous possibilities is to create the extension 200 using a solid bar that is molded and/or machined into its final shape. The extension 200 can be made removable from the main body 150. Other variants are possible as well.

In the example shown in FIGS. 4 to 8, both the front elongated section of the exterior side member 152 and the lateral member 220 are essentially flat rectilinear upstanding workpieces. They include subparts forming the additional teeth 160 provided under the protruding portion 210 of the extension 200. These teeth 160 continue the pattern of at least some of the teeth 160 provided elsewhere under the wheel chock 100 and for this reason, they are identified using the same reference numeral. The base portion 212 of the illustrated extension 200 is provided on the lateral side of the main body 150 and extends interruptedly over the entire length thereof. The lateral member 220 includes subparts matching the corresponding subparts of each tooth 160 along the main body 150. Other configurations and arrangements are possible. Among other things, the extension 200 can be designed differently in some implementations. The design and layout of the teeth 160 under at least a part of the extension 200 can be different from what is shown and described. The base portion 212 of the extension 200 can be shorter than the main body 150 in some implementations, and the extension 200 can even include another portion protruding at the rear end in others. The lateral member 220 can be designed differently. Other variants are possible as well.

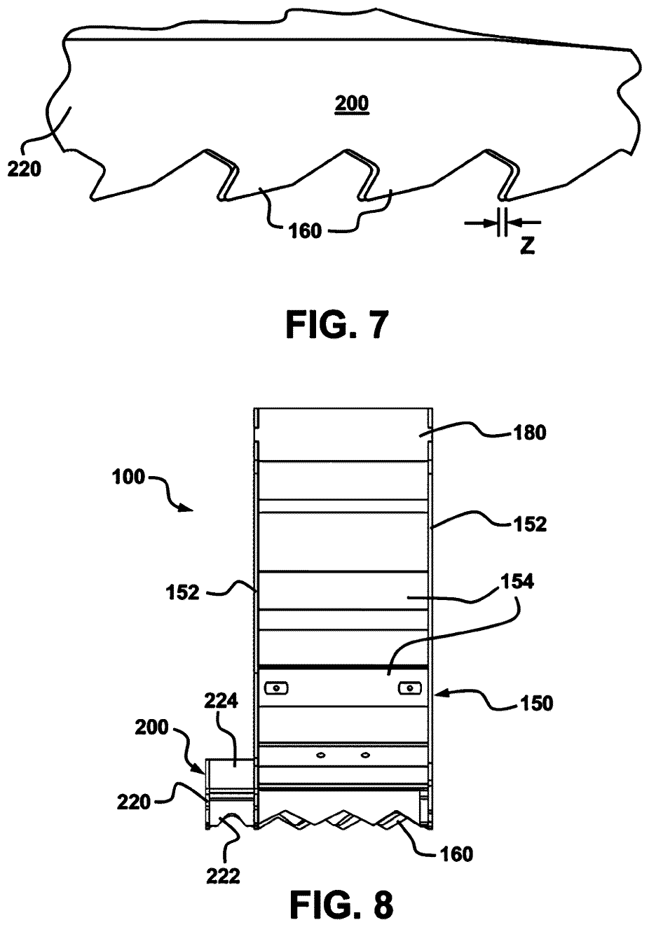

FIG. 7 is an enlarged fragmentary view of some of the teeth 160 under the wheel chock 100 shown in FIG. 6. It shows that at least some of the subparts on the lateral member 220 can be slightly offset towards the front of the wheel chock 100 with reference to the corresponding subparts on a same row. This offset is schematically depicted in FIG. 7 as the horizontal distance Z. This horizontal distance Z can be for instance about 0.0625 in (1.6 mm). Only the first three teeth 160 at the front that also have subparts under the main body 150 are offset in the illustrated example. The subparts of each of these teeth 160 are aligned along an axis that is then not entirely perpendicular to the longitudinal axis 108. This feature allows counterbalancing at least in part the moment of force created when the wheel chock 100 and the wheel 102 are not centered due to the presence of the extension 200. Other configurations and arrangements are possible. Among other things, the indicated value of the horizontal distance Z is only an example, and other values are possible. The lateral offset can be done for only some of the teeth 160 or, in some cases, for all teeth 160. Still, this lateral offset feature can be entirely omitted in some implementations. Other variants are possible as well.

FIG. 8 is a front view of the wheel chock 100 of FIG. 4.

FIG. 9 is an isometric view illustrating an example of a bidirectional wheel chock 100. This figure also illustrates an example of a base plate 110 that is similar to the one shown in FIG. 3. The wheel chock 100 and the base plate 110 are part of a wheel chock restraint system 120.

FIG. 9 shows examples of resilient spacers 148 that can be useful to help users keep an optimum distance between the wheel 102 and the wheel chock 100 when it is set in position over the base plate 110. There are two spacers 148 in FIG. 9, one for each side, because the example shows a bidirectional model. A wheel chock that is not a bidirectional model has only one tire-facing side and will generally have only one spacer for this reason. Nevertheless, these spacers 148 are only illustrated for the sake of explanation and they can be omitted in some implementations. Other variants are possible as well.

Bidirectional wheel chocks can be useful, among other things, to block vehicles when they can depart and/or arrive in both the forward and rearward travel directions. They have two opposite wheel-facing sides, and two corresponding bulges. The forward travel direction generally corresponds to the direction shown by the arrow depicting the longitudinal axis 108. The rearward travel direction 250 is depicted in FIG. 9. It is a direction that is generally parallel but diametrically opposite to that of the longitudinal axis 108.

The bidirectional wheel chock 100 includes a main body with teeth oriented in opposite directions. Some of the teeth are configured and disposed to create a latching engagement with a corresponding one of the blocking elements 112 on the base plate 110 when a wheel exerts a force on the wheel chock 100 in one direction, and the opposite teeth are configured and disposed to create a latching engagement with a corresponding one of the blocking elements 112 on the base plate 110 when a wheel exerts a force on the wheel chock 100 in the opposite direction. Other configurations and arrangements are possible. Among other things, the bidirectional wheel chock 100 can be designed differently in some implementations, for instance without a bulge on one or both sides. The teeth under the bidirectional wheel chock 100, or at least some of them, can also be designed and/or configured differently. The opposite teeth do not need to be substantially symmetrical or otherwise similar in all implementations. Other variants are possible as well.

Further details on bidirectional wheel chocks and corresponding wheel chock restraint systems can be found, for instance, in U.S. Pat. No. 10,793,119.

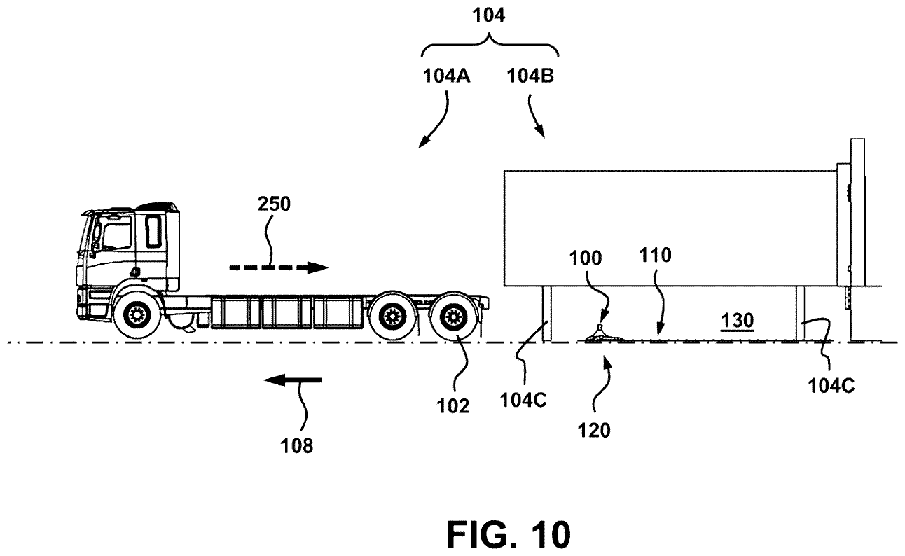

FIG. 10 is a semi-schematic view illustrating an example of a generic vehicle 104 having a swap body configuration at a loading dock 130 where a wheel chock restraint system 120 can be provided. This wheel chock restraint system 120 can include a bidirectional wheel chock 100, for instance one as shown in FIG. 9.

A vehicle 104 having a swap body configuration includes essentially two basic parts, namely a chassis 1404A and a container 104B that can be selectively detached from the chassis 104A. The chassis 104A is the motorized part, and the container 104B includes the cargo compartment. The two basis parts are shown unconnected in FIG. 10, and the wheel chock 100 is positioned between them. The container 104B has supporting legs 104C to keep it above the ground surface when detached from the chassis 104A, and the chassis 104A can back up to position its rear frame section directly under the container 104B. Once in position, the container 104B can be attached to the chassis 104A and then carried away once the legs 104C of the container 104B are in a stowed position. The chassis 104A is generally designed to cooperate with more than one container 104B, and vice versa. For instance, the chassis 104A can transport the container 104B at a first location, detach from the container 104B once at the first location and move away from it, then pick up another container 104B at a second location, and the container 104B at the first location can be picked up subsequently by another chassis 104A. Other configurations and arrangements are also possible. Among other things, the vehicle 104 as illustrated in FIG. 10 is only a generic example and any basic part, such as the chassis 104A and/or the container 104B, of a vehicle having a swap body configuration can be designed differently in other implementations compared to what is shown and described herein. The wheel chock 100 for use with a vehicle having a swap body configuration does not necessarily need to be a bidirectional model. Depending on how they are positioned or oriented on the base plate 110 for the intended purpose, another model, such as any of the ones illustrated for instance in FIGS. 3 and 4, can prevent the chassis 104A from getting under the container 104B when the latter is standing on its supporting legs 104C, as shown in FIG. 10, or from moving away in the departure direction 108 when the chassis 104A is parked at the loading dock 130, with or without the container 104B being carried. Other variants are possible as well.

As can be seen, FIG. 10 further shows that the wheel chock 100, bidirectional or not, can be in a working position on the base plate 110 without necessarily being adjacent to a wheel or to another feature. The bidirectional wheel chock 100 can be used for preventing the chassis 104A from moving away in a departure direction, for instance when parked at the loading dock 130, and also for preventing it from moving into the loading dock 130 to get under the container 104B standing on its supporting legs 104C as shown in FIG. 10, in a rearward travel direction 250. When the chassis 104A is parked at the loading dock 130, the wheel chock 100 can prevent it from leaving, with or without the container 104B. The wheel chock 100 can also prevent the chassis 104A from moving into the loading dock 130 when the container 104B is already present, on its supporting legs 104C, and even when no container 104B is present.

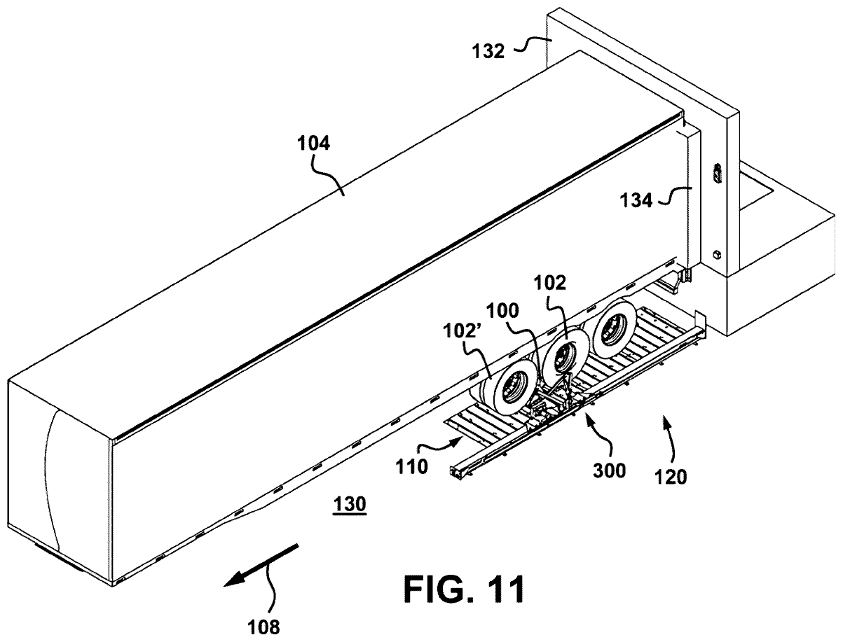

FIG. 11 is an isometric view illustrating an example of a wheel chock restraint system 120 having a wheel chock positioning arrangement 300 as proposed herein. The wheel chock restraint system 120 includes a wheel chock 100 and a base plate 110, as shown. The wheel chock positioning arrangement 300, as its name suggests, is provided to move the wheel chock 100 from one location to another.

Many other implementations of the proposed wheel chock positioning arrangement 300 are possible. For instance, the wheel chock positioning arrangement 300 can be designed and constructed as a mechanized and machine-controlled system that normally operates autonomously for the entire process, for instance placing the wheel chock 100 immediately in front of a wheel 102 to be blocked and later removing the wheel chock 100 when the vehicle 104 is authorized to depart, or placing the wheel chock 100 in the path of a wheel of an incoming vehicle to be blocked and later removing the wheel chock 100 when the vehicle 104 is authorized to move into position. Any actuator and motor of the wheel chock positioning arrangement 300 can then be controlled and/or monitored by a computer or another kind of control device, with the intervention of a person being only necessary if an unusual situation occurs, such as a power outage. Some implementations may require the intervention of a person to initiate the process, but it may start automatically in others. The implementations where the wheel chock positioning arrangement 300 operates autonomously can include motors and/or actuators receiving power from a corresponding source of energy, for instance electrical power received through a wire connection and/or from one or more batteries mounted thereon. An actuator or motor can also be powered using a pneumatic or hydraulic arrangement. Some implementations can rely at least in part to human force for the normal operation. Other variants are possible as well.

The wheel chock positioning arrangement 300 positions the wheel chock 100 on the base plate 110 and in the event of an unauthorized or accidental maneuver attempt, the intense forces exerted on the wheel chock 100 will only be transferred to the base plate 110, not on the wheel chock positioning arrangement 300. This is a desirable advantage because, among other things, the wheel chock positioning arrangement 300 can be manufactured at significantly lower costs compared to a common wheel blocking arrangement where its positioning mechanism must withstand these intense forces during an unauthorized or accidental maneuver attempt. Wheel blocking arrangements usually have many inherent limitations, for instance the length over which the blocking element can be extended sideways to reach a blocking position in front of a wheel.

FIG. 11 depicts a vehicle 104 being parked at a loading dock 130, its rear side resting against one or more cushions 134 provided on a wall 132 at the back end of the loading dock 130. The wall 132 can be part of a commercial building, for instance. The wheel chock 100 is a wheel-blocking position in FIG. 11 so as to prevent the vehicle 104 from moving away in the direction that corresponds to the longitudinal axis 108. Most of the wheel chock 100 was previously inserted within the intervening space between the wheel 102 and a corresponding adjacent wheel 102′ located in front of the wheel 102 on another axle. Other configurations and arrangements are possible. Among other things, the wheel chock 100 can be positioned elsewhere on the base plate 110 to prevent the vehicle 104 from moving away. The position of the wheel chock 100 in FIG. 11 is only for the sake of example. Other variants are possible as well.

It should be noted that the wheel chock 100, the base plate 110 and the wheel chock positioning arrangement 300 are distinct components cooperating together. They are all part of the wheel chock restraint system 120 in the illustrated example. Among other things, the wheel chock positioning arrangement 300 can be manufactured and sold without a wheel chock and/or without a base plate.

Although the figures include implementations where the wheel 102 to be blocked by the wheel chock 100 is located on the left side of the illustrated vehicle 104, such as FIG. 11, a wheel chock restraint system 120 can be configured and disposed for use on the opposite side of the vehicle 104. Many of the parts will then be a mirror image of what is shown and/or described herein. Other configurations and arrangements are also possible. Among other things, a loading dock is not the only location where a wheel chock restraint system 120 can be useful, and some locations can be designed differently. Some may even allow vehicles to enter an area from both directions. The left/right and/or forward/rearward orientations are mostly provided herein for the sake of explanation. Other variants are possible as well.

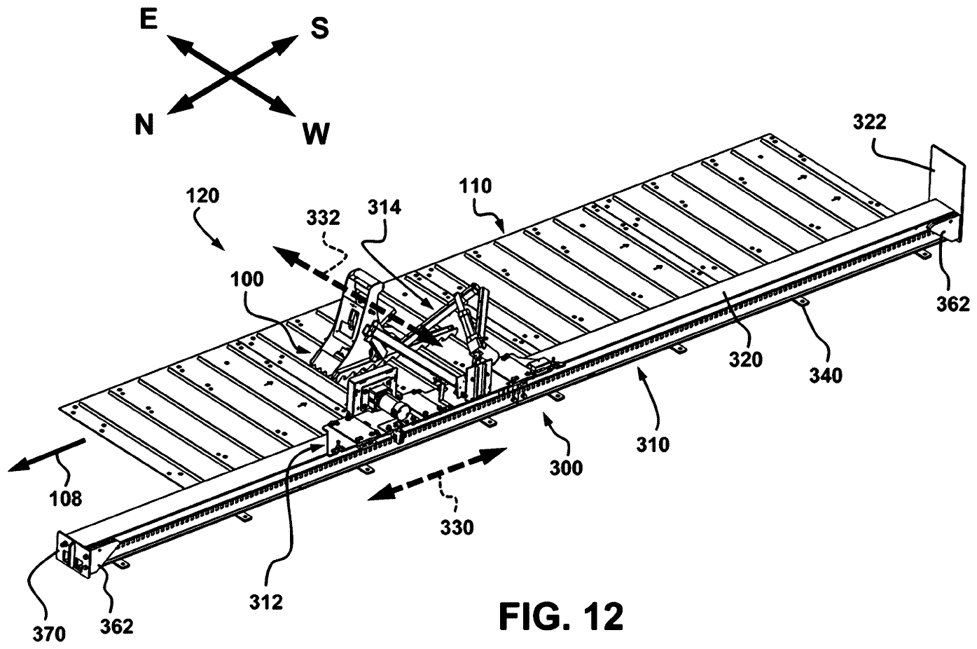

FIG. 12 is an enlarged isometric view of the wheel chock restraint system 120 of FIG. 11. The vehicle 104 and the wall 132 were removed in order to show the wheel chock restraint system 120 with a magnified view. The wheel chock 100 and the wheel chock positioning arrangement 300 are at the same positions they have in FIG. 11.

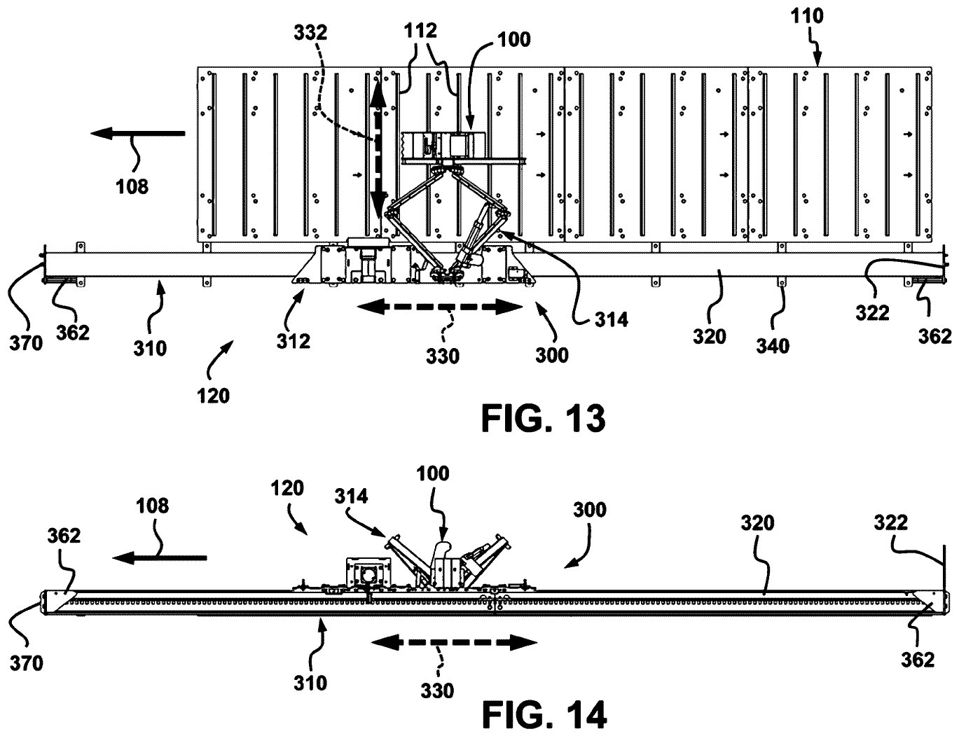

FIG. 13 is a top plan view of the wheel chock restraint system shown in FIG. 12, and FIG. 14 is a side view thereof.

The wheel chock positioning arrangement 300 can include three main parts cooperating together, namely a track subsystem 310, a carriage subsystem 312, and a support arm subsystem 314, as shown in FIGS. 12 to 14. In the illustrated example, the support arm subsystem 314 is mounted onto the carriage subsystem 312, and the carriage subsystem 312 is slidably mounted over the track subsystem 310. The wheel chock 100 is also mounted at the distal end of the support arm subsystem 314 when the wheel chock restraint system 120 is fully assembled. Other configurations and arrangements are also possible. Among other things, the wheel chock positioning arrangement 300 can be designed and/or shaped differently in some implementations. Other variants are possible as well.

The track subsystem 310 can include, among other things, an elongated rail 320 extending substantially parallel to the longitudinal axis 108, as shown. The carriage subsystem 312 uses the top portion of the rail 320 as a track in the illustrated example. The motion of the carriage subsystem 312 with reference to the rail 320 is essentially a translational movement that also changes the position of the support arm subsystem 314 mounted thereon. The support arm subsystem 314 can be an articulated mechanism having a pair of interconnected arms, as shown. The illustrated support arm subsystem 314 has a proximal end attached to the carriage subsystem 312, and a distal free end to which the wheel chock 100 can be removably attached. The support arm subsystem 314 is movable between a retracted position and a fully extended position. Other configurations and arrangements are possible. Among other things, one or more of these features can be designed and/or positioned differently in some implementations, and at least one of them can be omitted in others. Other variants are possible as well.

FIGS. 12 to 14 show that the track subsystem 310 can include a proximal end plate 322 at the proximal end of the rail 320. This proximal end plate 322 can extend vertically and include an upper portion projecting above the top of the rail 320, as shown. Various ancillary components, such as electrical junction boxes, control buttons, etc., can be positioned at the proximal end plate 322. Other configurations and arrangements are possible. Among other things, the proximal end plate 322 can be designed and/or positioned differently. It can also be omitted in some implementations. Other variants are possible as well.

The travel motion of the carriage subsystem 312 along the rail 320 follows a first path 330, and the travel motion of the wheel chock 100 created by the support arm subsystem 314 follows a second path 332. These two paths 330, 332 are schematically depicted in the FIGS. 12 to 14. As can be seen, the second path 332 is generally orthogonal to the first path 330. The first path 330 is substantially parallel to the longitudinal axis 108 in the illustrated example and for this reason, it will be referred to as the longitudinal path 330. The second is referred to as the transversal path 332, but this designation is essentially for the sake of convenience. In particular, notwithstanding its schematic representation in FIG. 12, this does not mean that the motion of the wheel chock 100 along the transversal path 332 is purely rectilinear in the three-dimensional space over the entire travel distance thereof.

The travel motion along each of the two paths 330, 332 is bidirectional, each path 330, 332 having two opposite directions. For ease of illustration, a frame of reference involving the four main cardinal points of the compass in their usual two-dimensional sense is used, namely North (N), South(S), East (E) and West (W), and they each designate a corresponding direction. The North direction and the South direction are associated with the longitudinal path 330, and the East direction and the West direction are associated with the transversal path 332. The North direction points away from the wall 132 (FIG. 11), and the South direction points towards the wall 132. The East direction points away from the rail 320, and the West direction points towards the rail 320. Other configurations and arrangements are possible. Among other things, the frame of reference is simply for the sake of convenience and it does not mean, for instance, that the motion of the wheel chock 100 along in the transversal path 332 (East and West directions) is purely rectilinear in the three-dimensional space over the entire travel distance thereof. Other variants are possible as well.

This rail 320 is basically a rigid structure that is anchored to and located near the ground surface. The rail 320 can be made of a rigid material, such as structural steel. The rail 320 can be made of a plurality of rail segments in juxtaposition. It can also be a single monolithic piece. It is generally desirable to keep the vertical height rail 320 as low as possible and below the rear bumpers, for instance the rear bumpers of semi-trailers and other types of vehicles. Other configurations and arrangements are also possible. Among other things, other materials can be used, and the rail 320 can be designed and/or positioned differently in some implementations. Still, another kind of structure could replace the rail. A rail may not be necessary in some cases because, for instance, there is already a suitable structure at the site or for other reasons. Other variants are possible as well.

The rail 320 can be anchored to the ground surface using a plurality of transversal bedplates 340 located at various spaced apart locations under the rail 320, as shown. These bedplates 340 can have an elongated flat rectangular shape, as shown. They can be made of a metal and be welded or otherwise attached under the rail 320. Each bedplate 340 can be made longer than the width of the rail 320, and each section extending on the opposite lateral sides can include a through-hole to receive fasteners (not shown), such as anchor bolts or the like, and affix the track subsystem 310 to the ground surface. Other configurations and arrangements are possible. Among other things, the bedplates 340 can be designed and/or positioned differently. Other materials are possible, and the bedplates 340 can be attached to the rail 320 without necessarily being welded thereon. Bedplates 340 can be replaced by other features in some implementations, and they can be entirely omitted in others, for instance because the track subsystem 310 is anchored using a different kind of arrangement. Other variants are possible as well.

FIG. 13 shows that the bedplates 340 can also be useful to properly align and position the rail 320 with reference to the lateral edge of the base plate 110. In the example, the end surface at one end of the bedplates 340 is in abutment contact with a corresponding surface on the corresponding lateral edge of the base plate 110, thereby simplifying the alignment and the positioning of these parts during the installation and maintenance. Other configurations and arrangements are possible. Among other things, the bedplates 340 can be designed and/or positioned differently, and they can also be omitted. Other variants are possible as well.

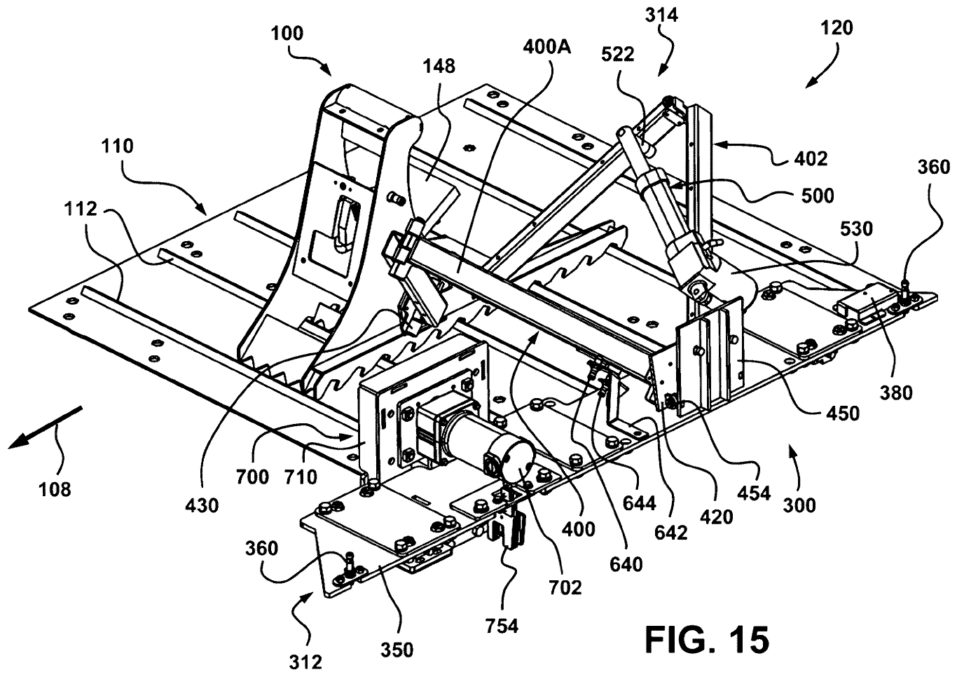

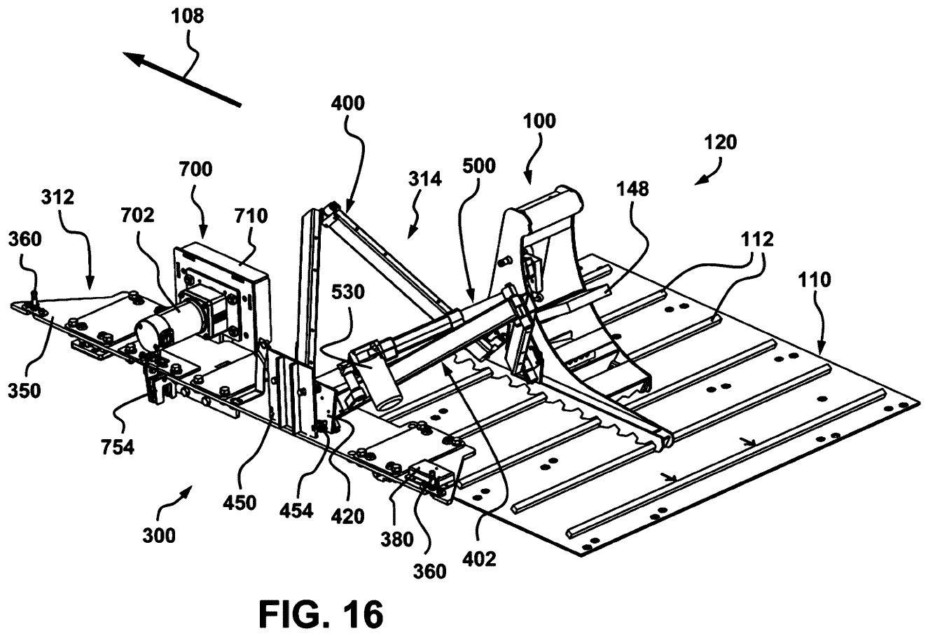

FIG. 15 is a partial isometric view of the wheel chock restraint system 120 shown in FIG. 12. FIG. 16 is a view similar to FIG. 15, taken from another viewpoint. Among other things, some of the parts were removed for the sake of illustration, and only one section of the base plate 110 is shown in FIGS. 15 and 16.

The illustrated carriage subsystem 312 includes a base structure 350 to which the support arm subsystem 314 and other components are mounted. The base structure 350 can be an assembly of a multitude of imbricated horizontal plates bolted together consecutively in longitudinal alignment so as to form an elongated platform. Such an arrangement can be desirable for minimizing manufacturing costs. Other configurations and arrangements are possible. Among other things, the base structure 350 can include fewer plates and/or plates that are connected differently to one another. The base structure 350 could be a made of a monolithic workpiece that is machined or otherwise manufactured into its final shape. Other variants are possible as well.

The carriage subsystem 312 can include proximity sensors 360 at the proximal end and the distal end of the base structure 350, as shown. These proximity sensors 360 can be positioned in registry with a corresponding slot through the base structure 350 to detect the presence of a corresponding marker 362 extending on and parallel to the side of the rail 320, for instance the outboard side thereof, as shown. One marker 362 can be provided at the proximal end of the rail 320 and be affixed to the proximal end plate 322, and the other marker 362 can be provided at the distal end of the rail 320 and be affixed to a distal end plate 370. The markers 362 can have a triangular shape, with the top flat edge extending parallel to the longitudinal path 330, just under where the corresponding proximity sensor 360 is located. Each proximity sensor 360 can detect the presence of the corresponding marker 362, for instance by induction. The analog and/or digital signals from the inductive proximal sensors 360 can be sent to a control system to indicate that the carriage subsystem 312 has reached the vicinity of either the proximal end or the distal end, thereby immediately or gradually stopping the motion of the carriage subsystem 312. The markers 362 can be made of a metallic material or include a metallic material or the like at least on the top edge thereof. Other configurations and arrangements are possible. Among other things, the proximity sensors 360 and/or the markers 362 can be designed and/or positioned differently. Other methods or sensor technologies can be used. The sensors can be omitted in some implementations. Other variants are possible as well.

FIGS. 15 and 16 further show that the wheel chock positioning arrangement 300 can include a scanning device 380 mounted on the carriage subsystem 312, as shown. The scanning device 380 is provided near the proximal end of the base structure 350 in the illustrated example. This scanning device 380 can include a laser scanner having a line-of-sight pointing towards the interior to detect the position of the wheels and the presence of any obstacles. The analog and/or digital signals from the scanning device 380 can be sent to a control system to determine where the wheel chock 100 will be positioned. These signals can also provide information on the model of the vehicle. Still, the scanning device 380 can also detect that no wheel is present, which can be indicative of the presence of a container 104B and that the wheel chock 100 must be positioned to prevent a chassis 104A from moving under the container 104B. Further details on the scanning device 380 will be given hereafter. Other configurations and arrangements are possible. Among other things, the design and/or position of the scanning device 380 can be different. The scanning device 380 can be provided, for instance, under the inboard edge of the carriage subsystem 312. The scanning device 380 can be mounted elsewhere, including on the wheel chock 100 or even at a location that is not on the wheel chock positioning arrangement 300. A digital camera or other methods can also be used. More than one scanning device 380 can be provided. The scanning device can be omitted in some implementations. Other variants are possible as well.

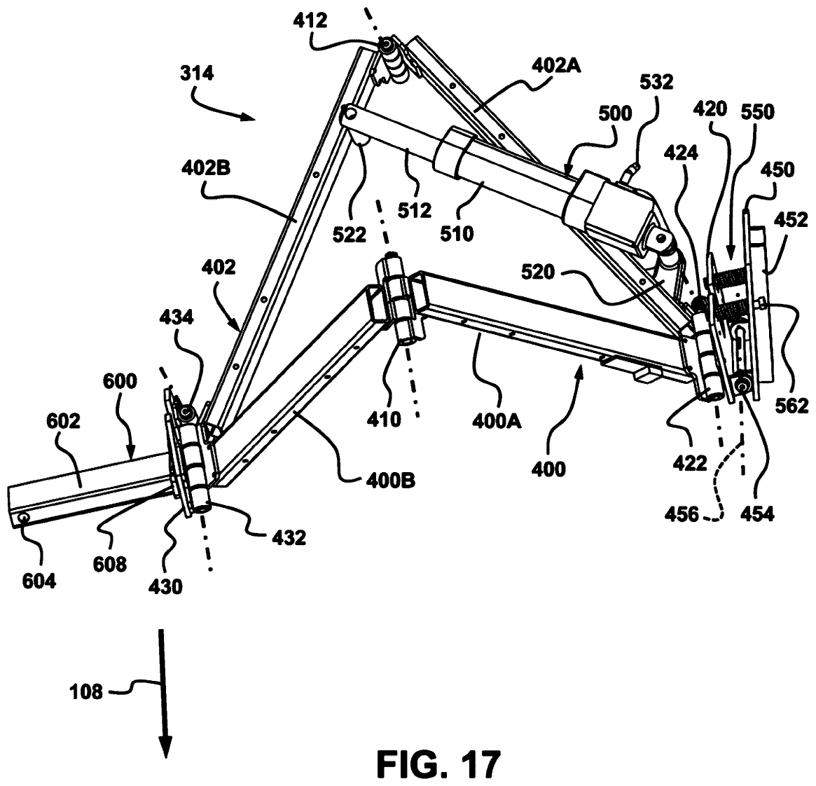

FIG. 17 is an isometric view of the support arm subsystem 314 in the wheel chock positioning arrangement 300 shown in FIG. 12. In the illustrated example, the support arm subsystem 314 includes a first articulated cantilever arm assembly 400 and a second articulated arm assembly 402. The first articulated cantilever arm assembly 400 and the second articulated cantilever arm assembly 402 each include a proximal end and a distal end. The first articulated cantilever arm assembly 400 includes a first proximal arm 400A and a first distal arm 400B, and the second articulated cantilever arm assembly 402 includes a second proximal arm 402A and a second distal arm 402B. The distal end of the first proximal arm 400A is pivotally interconnected with the proximal end of the first distal arm 400B through a first intermediate hinge 410, and the distal end of the second proximal arm 402A is pivotally interconnected with the proximal end of the second distal arm 402B through a second intermediate hinge 412. Each arm can include a given length of a rectilinear hollow tube having a substantially rectangular cross-section as well as rounded edges on the exterior surface. They are generally made of a rigid material. Other configurations and arrangements are possible. Among other things, at least some of the arms can be made shaped and/or positioned differently. Other variants are possible as well.

It is understood that while throughout the present description the cantilever arm assemblies 400, 402 are described as articulated, other suitable arrangements of the arm assemblies are possible. For example, the arm assemblies may be telescopic. In a non-limiting example, the arm assemblies may comprise a plurality of telescopic members configured to extend in the transversal direction. The telescopic members may extend at an angle with respect to the transversal direction and may be appropriately mounted using appropriate means, such as but not limited to pivots, to provide for substantially straight movement of the wheel chock in the transversal direction.

The two articulated cantilever arm assemblies 400, 402 are disposed generally upwards in a substantially V-shaped manner. They are substantially symmetrical with reference to a transversal vertical plane, and they are at a 90-degree angle with reference to one another. The proximal end of the first proximal arm 400A and the proximal end of the second proximal arm 402A are pivotally attached to a proximal mounting plate 420 through corresponding first and second proximal hinges 422, 424. These proximal hinges 422, 424 are spaced apart from one another and are located on the outboard side of the proximal mounting plate 420. The distal end of the first distal arm 400B and the distal end of the second distal arm 402B are pivotally attached to a distal mounting plate 430 through corresponding first and second distal hinges 432, 434. These distal hinges 432, 434 are spaced apart from one another and are located on the inboard side of the distal mounting plate 430. The various hinges 410, 412, 422, 424, 432 and 434 of the illustrated example have a single axis. Other configurations and arrangements are possible. Among other things, the support arm subsystem 314 and/or at least some of the parts can be designed and/or positioned differently. At least some of the hinges can be biaxial or multiaxial in some implementations. Other variants are possible as well.

The two articulated cantilever arm assemblies 400, 402 are then interrelated and interdependent. They create a mechanism where the distal end can be moved in a linear manner with reference to the proximal end. However, the proximal mounting plate 420 is pivotally attached to the base structure 350 of the carriage subsystem 312, and the wheel chock 100 mounted at the distal end is also pivotally attached. Accordingly, the first portion of the transversal path 332 can be curved in the three-dimensional space before being rectilinear once the wheel chock 100 rests on the base plate 110.

The wheel chock positioning arrangement 300 can include a lateral support 450 extending vertically above the base structure 350 of the carriage subsystem 312, as shown in the illustrated example. The lateral support 450 can be in the form of a flat plate generally oriented parallel to the longitudinal axis 108, and it can include a number of vertically disposed reinforcing members 452 on its back side, as shown. The proximal mounting plate 420 can be pivotally attached to the lateral support 450 through a pivot joint 454 located near the bottom edge of the proximal mounting plate 420. In the example, this pivot joint 454 includes a first portion extending from the outboard side of the lateral support 450, and a second portion extending from the inboard side of the proximal mounting plate 420. It thus creates an intervening space between the proximal mounting plate 420 and the lateral support 450. The pivot joint 454 defines a pivot axis 456 that is substantially horizontal and substantially parallel to the surface on the inboard side of the lateral support 450. Other configurations and arrangements are possible. Among other things, the lateral support 450 can be constructed and/or positioned differently. The pivot joint 454 can also be constructed and/or positioned differently. At least some of the features can be omitted in some implementations. Other variants are possible as well.

The support arm subsystem 314 can include an actuator mechanism 500 for changing and maintaining the position of the wheel chock 100 provided at its distal end. The actuator mechanism 500 can also generate the force required for pushing or pulling the wheel chock 100 and overcoming the friction when it rests on the base plate 110. The actuator mechanism 500 can be responsive to command signal sent by a control system. The actuator mechanism 500 of the illustrated example includes a single linear actuator 510 having a first end or base pivotally attached to the proximal arm 402A of the second articulated cantilever arm assembly 402 through a proximal mount 520 provided in the vicinity of the proximal end of the second proximal arm 402A. It also has a second end at the extremity of a rod 512, this second end being pivotally attached in the vicinity of the proximal end of the distal arm 402B, for instance through a distal mount 522. Such configuration can provide a good leverage when a force is applied, and it can allow support arm subsystem 314 to fold compactly. Although the actuator mechanism 500 is only provided on the second articulated cantilever arm assembly 402, the two articulated cantilever arm assemblies 400, 402 are interrelated and interdependent, and extending or retracting one will also simultaneously extend or retract the one. Other configurations are arrangements are possible. Among other things, the actuator mechanism 500 can be constructed and/or positioned differently in some implementations. For instance, it may not include a linear actuator in some implementations. The actuator mechanism can be attached to the first articulated cantilever arm assembly 400 in some implementations. Others can have an actuator mechanism on each of the articulated cantilever arm assemblies 400, 402. Still, some parts can also be replaced by other features or be omitted entirely. This includes not having any actuator mechanism, such as for a wheel chock positioning arrangement where the support arm subsystem 314 is always positioned by hand. Other variants are possible as well.

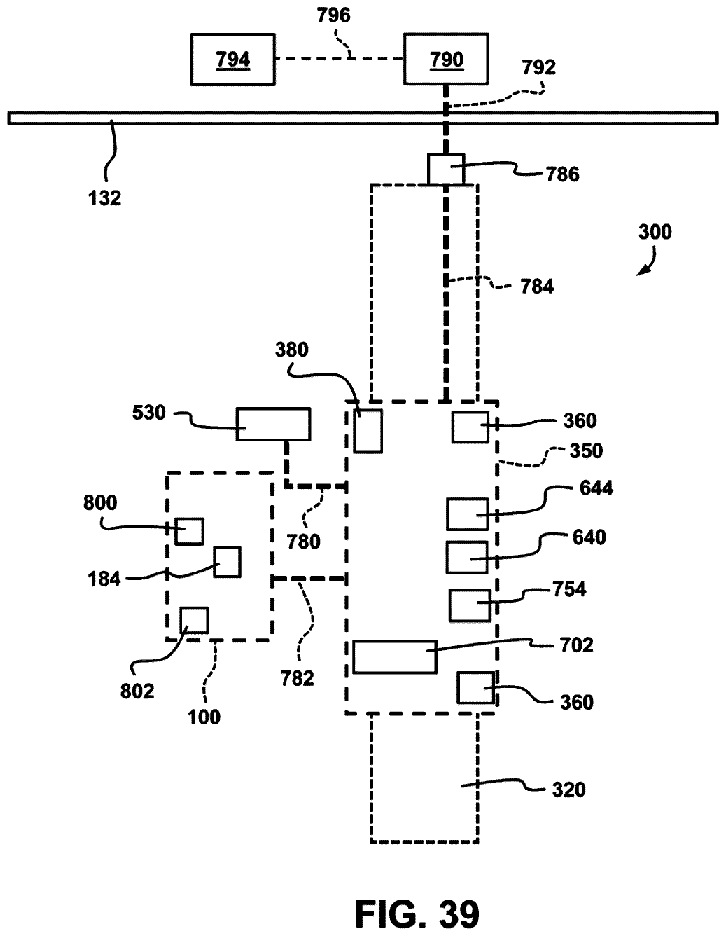

The linear actuator 510 in the illustrated example can include a self-locking jackscrew to remain stationary when no rotation force is applied by a corresponding drive motor 530. The self-locking capability can be useful as an anti-theft feature to prevent an unauthorized person from removing the wheel chock 100 when it is in a latching engagement with the base plate 110 and blocking the wheel 102. The drive motor 530 can be, for instance, an electric motor mounted at or near the proximal end of the actuator 510. The outer casing of the drive motor 530 can be seen in FIG. 16 and in other figures. Its location can be chosen to mitigate or otherwise minimize the probabilities of the drive motor 530 being accidentally damaged by a misaligned vehicle. The drive motor 530 can receive power through a corresponding wire or cable 780 (see FIG. 39) that can be removably attached to a connector 532. Other configurations and arrangements are possible. Among other things, an actuator that is not a self-locking jackscrew or even a jackscrew can be used in some implementations. Another kind of motor, for instance a hydraulic motor or a pneumatic motor, can be provided instead of an electric motor. Other variants are possible as well.

FIG. 17 further shows, among other things, that a counterbalancing mechanism 550 can be provided between the proximal mounting plate 420 and the lateral support 450 for partially counterbalancing the weight of the wheel chock 100 and the weight of the support arm subsystem 314. The counterbalancing mechanism 550 can also limit the pivot angle of the proximal mounting plate 420 with reference to the lateral support 450 in some implementations. FIG. 17 also shows that the support arm subsystem 314 can include a wheel chock mount 600 at the distal end thereof. The illustrated wheel chock mount 600 is an example of a part to which the wheel chock 100 can be attached to the support arm subsystem 314. Other configurations and arrangements are possible. Among other things, the wheel chock mount 600 can be designed and/or positioned differently in some implementations. Other variants are possible as well.

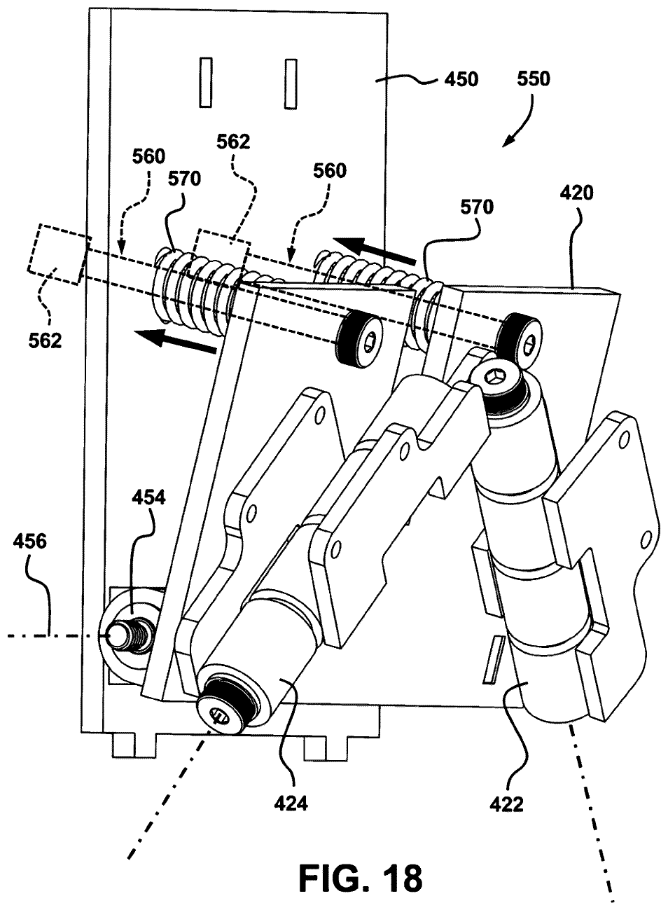

FIG. 18 is an enlarged semi-schematic isometric view of the proximal end of the support arm subsystem 314 of FIG. 17. The counterbalancing mechanism 550 of the illustrated example includes a pair of elongated pins, referred to hereafter as bolts 560, each having a first end attached to the proximal mounting plate 420, near the upper edge thereof, and a second end located on the opposite side of the lateral support 450. The second end includes a bolt head 562 that is larger than its shank. The shank of each bolt 560 passes across the lateral support 450 through a corresponding hole. The shank of each bolt 560 is in a sliding engagement with the lateral support 450, but the bolt head 562 is made larger than the hole. Each bolt head 562 can engage the surface around the periphery of the hole on the back side of the lateral support 450. The bolt heads 562 then function as stoppers to prevent the pivot angle of the proximal mounting plate 420 from going beyond a maximum. The proximal mounting plate 420, however, can pivot in the opposite direction, and this will move the bolt heads 562 away from the back side of the lateral support 450. Other configurations and arrangements are possible. Among other things, the counterbalancing mechanism 550 can be constructed and/or positioned differently. One or more of these features can be designed and/or positioned differently in some implementations, and at least one of them can be omitted in others. The counterbalancing mechanism can be entirely omitted in some implementations. Other variants are possible as well.

The counterbalancing mechanism 550 can include a pair of springs 570, for instance helical tension springs, as shown. The springs 570 can be provided to exert a counterbalancing force urging the top edge of the proximal mounting plate 420 towards the lateral support 450. In the illustrated example, each spring 570 is coaxially mounted around the shank of a corresponding one of the bolts 560. Each spring 570 has a first end affixed to the proximal mounting plate 420 and a second end affixed to the lateral support 450. Other configurations and arrangements are possible. Among other things, using only one bolt 560, or more than two, is possible. The spring or springs 570 can be located on the opposite side of the lateral support 450. At least some of the parts can be replaced by equivalents or be omitted. For instance, torsion springs or other kinds of springs can be provided in some implementations, and springs can be omitted in others. The bolt heads 562 can be replaced by other features mounted on the bolts 560 or on other parts. Other variants are possible as well.

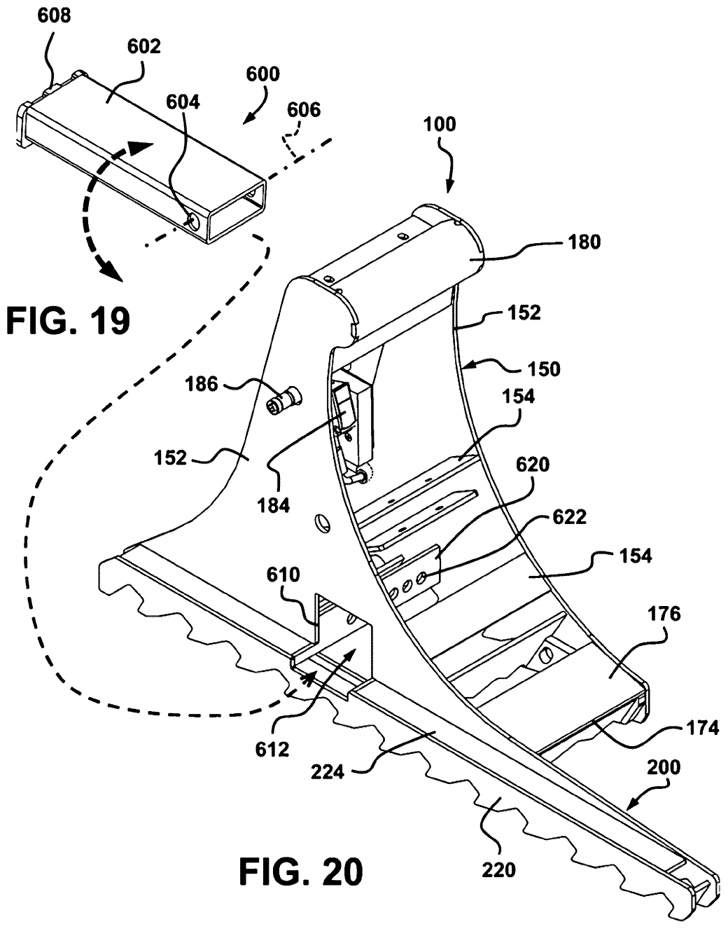

FIG. 19 is an enlarged isometric view of the wheel chock mount 600 provided at the distal end of the support arm subsystem 314 of FIG. 17. The illustrated wheel chock mount 600 includes an elongated support member 602 having a proximal end and a distal end. This support member 602 is a rectilinear segment of a hollow rectangular tube. It includes a through hole 604 made across the major axis near the distal end thereof. The through hole 604 is provided in this implementation to pivotally attach the wheel chock 100 to the wheel chock mount 600 around a pivot axis 606. The proximal end of this wheel chock mount 600 includes a proximal base portion 608 by which the wheel chock mount 600 can be rigidly attached to the inboard side of the distal mounting plate 430. Other configurations are arrangements are possible. Among other things, the parts can be constructed and/or positioned differently in some implementations. For instance, the support member 602 can have a different shape. The wheel chock mount 600 can include a flexible link made of resilient material, such as rubber or the like, at some point between the distal mounting plate 430 and its pivotal connection with the wheel chock 100. Some parts can also be replaced by other features or be omitted entirely. Other variants are possible as well.

FIG. 20 is an enlarged isometric view of the wheel chock 100 shown in FIG. 12. As can be seen, the wheel chock 100 includes a side opening 610 made through a corresponding one of the side members 152 of the main body 150. The side opening 610 is rectangular and it is made through the side member 152 along which the extension 200 is provided in this implementation. Its width is slightly larger than that of the support member 602, thereby allowing a long section of the support member 602 to be inserted into an interspace 612 inside the main body 150. The side opening 610 height, however, can be greater than that of the support member 602 so that the wheel chock 100 can pivot over a given range of angles with reference to the wheel chock mount 600. The height and/or position of the side opening 610 can be designed to limit the pivot movement. The side opening 610 can be positioned relatively close to the bottom of the wheel chock 100 and this may require the extension 200 to be modified since the bottom edge of the side opening 610 is below the top edge of the extension 200, as shown. In the illustrated example, the top edge of the lateral member 220 and the top strip 224 of the extension 200 are cut to free the space immediately in front of the side opening 610. Other configurations and arrangements are possible. Among other things, the exact shape and/or position of the side opening 610 can be different in some implementations. The extension 200 may not require a modification in some implementations, and others may not have an extension on the wheel chock 100. Wheel chocks can be designed differently compared to the one shown in the example, and the main body of some wheel chocks may already have one or more lateral openings large enough to receive the support member 602 of the wheel chock mount 600. Still, the distal end of the support arm subsystem 314 could be attached to the wheel chock 100 at a different location, including one that is on the exterior surface of the main body 150. The pivotal relative movement between the wheel chock 100 and the wheel chock mount 600 can be limited or otherwise controlled through other features. Other variants are possible as well.

FIG. 20 further shows that the wheel chock 100 can include a wire connector 186 projecting from a hole made through the side member 152 on the outboard side. This connector 186 can removably receive a plug provided at the free end of an external wire 782 (see FIG. 39) to establish a wired data communication link between with the wheel sensor 184 and/or other electronic or electric devices on the wheel chock 100. This external wire can pass inside the rail 320 and inside and/or outside the arms of one of the articulated cantilever arm assemblies 400, 402, and be configured and disposed to follow the motion of the various moving parts. The external wire can also provide electrical power to the wheel sensor 184 and/or other electronic or electric devices. The wired link inside the main body 150 of the wheel chock 100 can pass inside a protective conduit 188 extending between the connector 186 and the wheel sensor 184 and/or other electronic or electric devices on the wheel chock 100. Other configurations and arrangements are possible. Among other things, the connector 186 and the corresponding wire can be designed and/or positioned differently in some implementations. The wheel sensor 184 and/or other devices on the wheel chock 100 can establish communication with a control system through a wireless communication arrangement. All or at least some of these features can be omitted in some implementations. Other variants are possible as well.

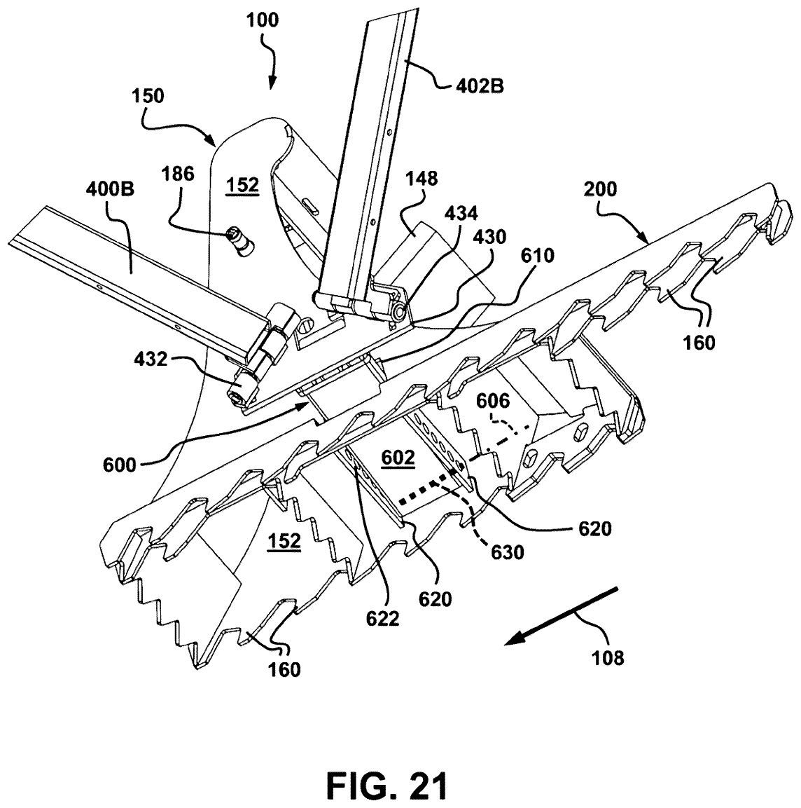

FIG. 21 is a bottom isometric view illustrating the wheel chock 100 and the wheel chock mount 600 of FIGS. 19 and 20 when assembled. As can be seen, the main body 150 of the wheel chock 100 includes two spaced-apart transversal upright walls 620 bordering the internal area through which extends the support member 602 of the wheel chock mount 600. The distal end of the support member 602 can be inserted almost all the way across the interior of the main body 150. Each transversal wall 620 in this example includes at least one hole 622, each being in registry with a corresponding one on the other transversal wall 620 along a direction that is substantially parallel to the longitudinal axis 108. The distal end of the wheel chock mount 600 is then pivotally connected to a connector, such as a pin or bolt, extending longitudinally from one transversal wall 620 to another and passing inside the through hole 604 (FIG. 19) of the support member 602. The connector is schematically depicted in FIG. 21 at 630. It allows the wheel chock 100 to pivot with reference to the wheel chock mount 600 about the pivot axis 606 that is close to the interior surface of the side member 152 opposite to the one through which the side opening 610 is made. FIG. 21 further shows that the transversal walls 620 include multiple pairs of holes 622, and this feature can be useful to change the location of the connection point if an adjustment is required. The connector 630 can be designed to be removable, for instance using common or even specialized tools. It can also allow different interchangeable models of wheel chocks to be used with the same wheel chock positioning arrangement 300. Other configurations and arrangements are possible. Among other things, the connector 630 can be designed and/or positioned differently. One or more of the features inside the wheel chock 100 and/or on the wheel chock mount 600 can be designed and/or positioned differently in some implementations, and at least one of them can be omitted in others, including the possibility of adjusting the position of the pivot axis 606. Other variants are possible as well.

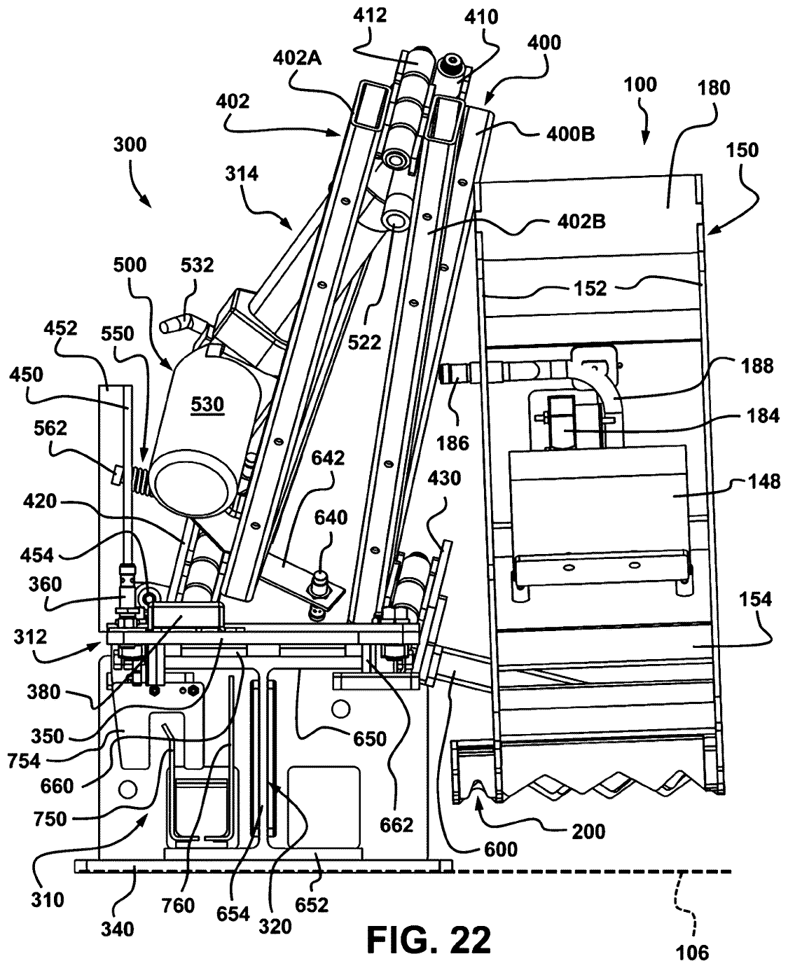

FIG. 22 is an end view of the wheel chock restraint system 120 of FIG. 12 when the support arm subsystem 314 is in a retracted position and the carriage subsystem 312 is at or near the proximal end of the rail 320. This figure is simplified for the sake of illustration. For instance, the proximal end plate 322 and other features were removed to better show some of the parts in this example, such as parts inside the track subsystem 310 and the carriage subsystem 312. The ground surface is schematically depicted in FIG. 22 at 106. As can be seen, the wheel chock 100 is located a few centimeters above the ground surface 106. The bottommost part of the wheel chock 100 is also above the top edge of the blocking elements 112. Other configurations and arrangements are possible. Among other things, one or more of the features in this illustrated example can be designed and/or positioned differently in some implementations, and at least one of them can be omitted in others. Other variants are possible as well.

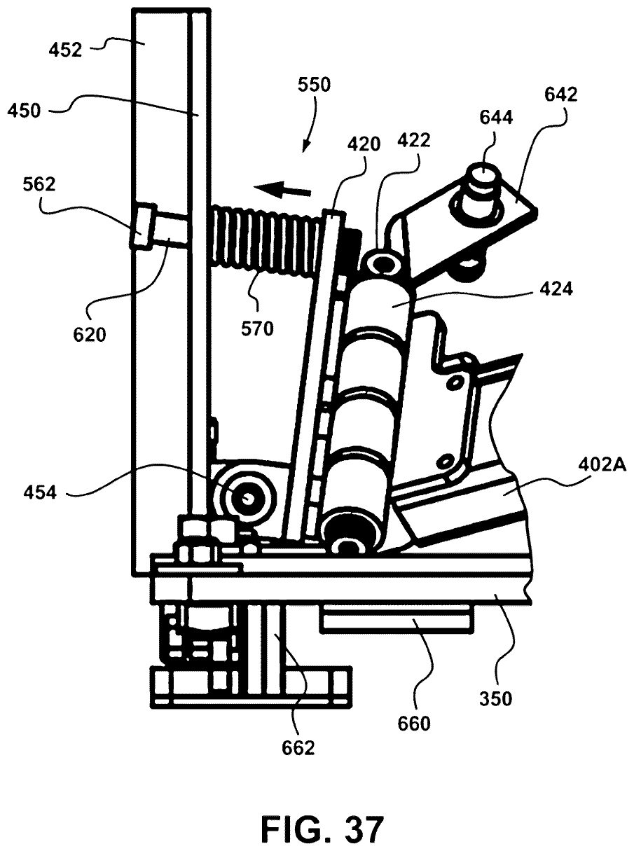

FIG. 22 shows one of the position sensors 640 that can be provided to detect the limit positions of the support arm subsystem 314. The first position sensor 640 in this example cooperates with the first proximal arm 400B and is affixed to an elongated bracket 642, for instance a band or strip of metal, affixed to the top surface of the base structure 350. The first position sensor 640 can be for instance an inductive proximity detector. The head of the first position sensor 640 is located next to where the corresponding surface on the first proximal arm 400B will be when the support arm subsystem 314 is at its fully extended position. A similar second position sensor 644 can also be provided on the bracket 642 to detect when the support arm subsystem 314 is at its fully retracted position. This second position sensor 644 is not visible on FIG. 22. However, both position sensors 640, 644 are shown in FIG. 15, and the second position sensor 644 can be seen in FIG. 37. The position sensors 640, 644 can generate analog and/or digital signals indicative of the proximity of the surface of the first proximal arm 400B. These signals can be sent to a control system or the like to indicate that the when the support arm subsystem 314 is at or near one of the limit positions. Other configurations and arrangements are possible. Among other things, the design and/or position of the position sensors 640, 644 can be different. Other methods or sensor technologies are possible. The position sensors 640, 644 can be simply for redundancy. At least one of them can be omitted in some implementations. Other variants are possible as well.

The rail 320 can have an H-shaped cross-section, as shown. The illustrated rail 320 includes two spaced apart horizontal flat elements, or flanges 650, 652, and a vertical flat element, or web 654, extending perpendicularly between the two flanges 650, 652. Other configurations and arrangements are possible. Among other things, the rail 320 can be designed and/or positioned differently in some implementations. Other variants are possible as well.

The carriage subsystem 312 can be slidably mounted onto the rail 320, as shown. The sliding engagement can include, for instance, having a plurality of low-friction elements 660, 662 located at different spaced apart locations between the base structure 350 and the rail 320. These low-friction elements 660, 662 can be made of a material such as a self-lubricating material highly that is highly resistant to abrasion, for instance ultra-high-molecular-weight polyethylene (UHMWPE, UHMW), also known as high-modulus polyethylene (HMPE). Other materials are possible. Among other things, at least some of the low-friction elements 660, 662 can be made of another polymeric material, or be made of a material that is not a polymer. They can also be made of a combination of two or more materials. At least some of the low-friction elements could be replaced by lubricants in some implementations. Other variants are possible as well.

FIG. 22 shows a first set of the low-friction elements 660, 662 provided between the base structure 350 and the rail 320 of the illustrated example. There are similar sets of low-friction elements at other locations along the length of the base structure 350.

Two low-friction elements 660 at the top are laterally spaced from one another, and they are located between the underside of the base structure 350 and the top surface of the top flange 650 of the rail 320. The upper side of these two low-friction elements 660 can be affixed to the base structure 350 so as to follow its movements along the rail 320. The other two low-friction elements 662 at the bottom of the illustrated example are affixed to corresponding brackets or other substructure features extending below the main portion of the base structure 350. These low-friction elements 662 can be configured and disposed to have an exposed surface engaging a corresponding lateral surface on the top flange 650. This arrangement can be useful to keep the carriage subsystem 312 in position over the rail 320. Using low-friction elements 660, 662 can also be desirable to lower manufacturing and maintenance costs by minimizing the number of moving parts. Nevertheless, other configurations and arrangements are possible. Among other things, at least some of the low-friction elements can be positioned and/or mounted differently compared to what is shown or described herein. The sliding engagement between the base structure 350 and the rail 320 can also involve other parts, such as wheels and/or rollers, in addition to or instead of low-friction elements. Further, the carriage subsystem 312 can be prevented from toppling or otherwise unintentionally detach from the rail 320 through other features that are not related to the sliding engagement. Other variants are possible as well.

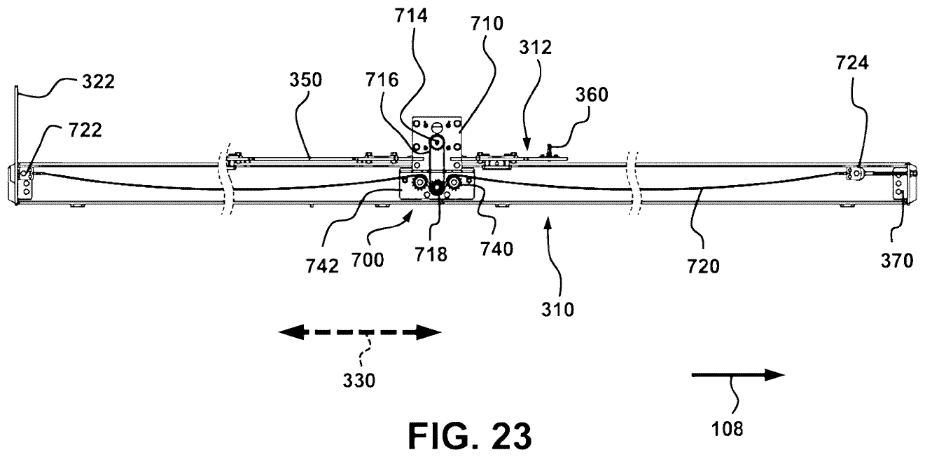

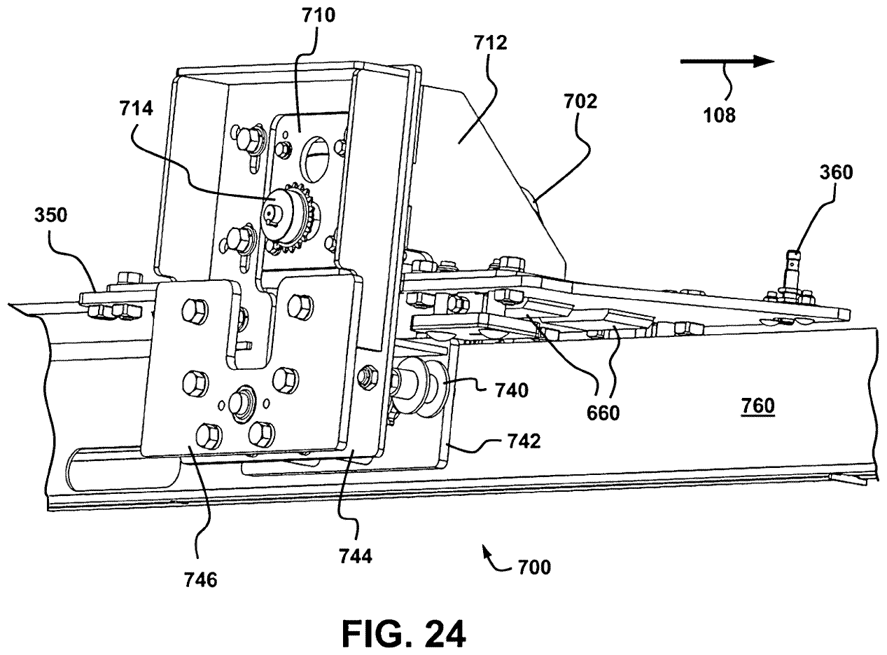

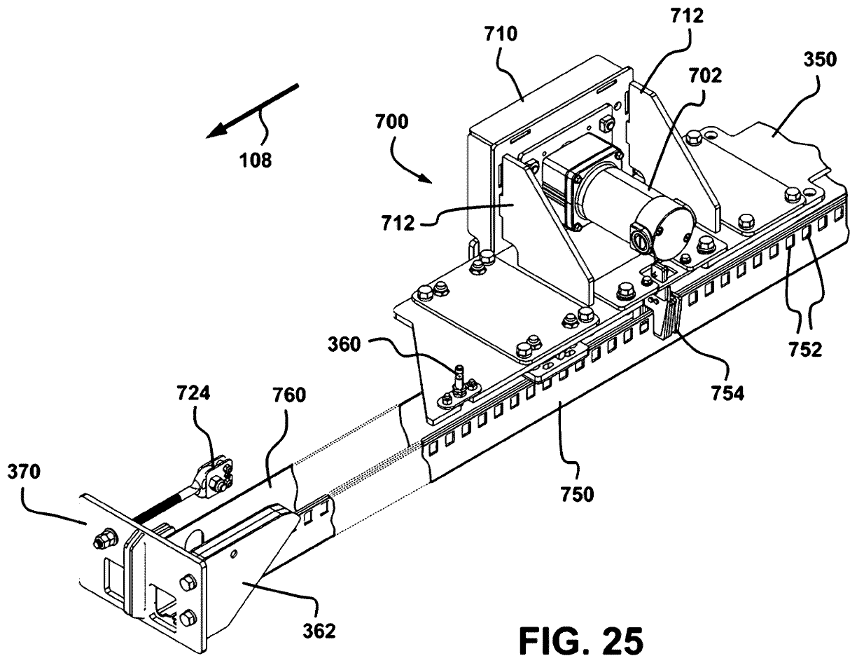

The wheel chock positioning arrangement 300 can include a translational mechanism 700 for changing the position of the carriage subsystem 312 along the rail 320. FIGS. 23, 24 and 25 are, respectively, a partial side view, a partial isometric bottom view, and a partial isometric top view illustrating some of the components of the wheel chock positioning arrangement 300 shown of FIG. 12. These figures show, among other things, that the translational mechanism 700 provided in the illustrated example. As can be seen, this translational mechanism 700 includes a drive motor 702, for instance an electric motor, extending laterally from the outboard side of an upright casing 710 mounted along the inboard side over the base structure 350 and vertically extending thereon, as shown. The mechanical connection between the base structure 350 and the casing 710 can include a pair of spaced apart vertical reinforcing walls 712 extending transversally from the outboard side of the casing 710. These walls 712 can be seen only in FIGS. 24 and 25. They are not shown in some of the other figures for the sake of simplicity. Further, FIG. 24 does not show protective covers, lids or similar features that would generally be present in a commercial implementation. Other configurations and arrangements are possible. Among other things, another kind of motor, for instance a hydraulic motor or a pneumatic motor, can be provided instead of an electric motor. One or more of these features can also be omitted entirely. Other variants are possible as well.

The translational mechanism 700 can also include a cord 720 (FIG. 23) or the like extending over most of the length of the track subsystem 310 on one side of the rail 320. The opposite ends of the cord 720 can be affixed to the track subsystem 310 at corresponding proximal and distal anchor points 722, 724. The cord 720 can be slightly longer than the distance between the opposite anchor points 722, 724. The distal anchor point 724 can include an eyebolt having one end affixed or otherwise secured to the distal end plate 370 and allowing the distance between the opposite anchor points 722, 724 to be fine-tuned or otherwise adjusted. The cord 720 can pass through a set of three juxtaposed pulleys where at least one of these pulleys is in a torque transmitting engagement with the drive motor 702, for instance through a chain 716 (FIG. 23) or the like extending between a first sprocket 714 at the output end of a gearbox located on or inside the casing 710, and a second sprocket 718 located below. The second sprocket 718 can be in a torque transmitting engagement with one or more juxtaposed pulleys around which the cord 720 passes. One of the pulleys can be seen in FIG. 24 at 740. This pulley 740 is also identified in FIG. 23. FIG. 23 shows only the inboard side of the casing 710 and the outboard mounting plate 742 to which one end of the pivot axle for the pulley 740 is attached. Its opposite end is attached to a central mounting plate 744. The illustrated translational mechanism 700 further includes an inboard mounting plate 746 extending parallel to the central mounting plate 744, leaving an interspace between them. The second sprocket 718 can be located within this interspace, with one end of its pivot axle between pivotally attached to the central mounting plate 744 and the other end being pivotally attached to the inboard mounting plate 746. In use, rotating the drive motor 702 in one direction will pull on a corresponding portion of the cord 720. It will initially pick up the slack and the carriage subsystem 312 will start moving as soon as the run of the cord 720 on that side is under tension. Then, once the carriage subsystem 312 is at the indented position or has reached one end of the rail 320, the drive motor 702 is stopped. It can also be briefly rotated in the opposite direction just enough to release the tension in the cord 720 and to create a sag in the portion that was previously under tension. It is also possible to include a clutch or the like that can automatically or selectively decouple or otherwise release the torque transmitting engagement between the drive motor 702 and the cord 720, or between the cord 720 and the pulley or pulleys. This can be useful to mitigate damages to some of the parts if an external force is transmitted to the carriage subsystem 312. Decoupling the mechanical connection between some of the parts can also be useful to reposition the carriage subsystem 312 by hand during a power outage or if the drive motor 702 cannot be operated or used for other reasons. Other configurations and arrangements are possible. Among other things, the design and/or position of at least one of the components of the illustrated example can be different in some implementations. A chain or another kind of flexible element can replace the cord 720 in other implementations. One or more of these features can also be omitted entirely. Other variants are possible as well.

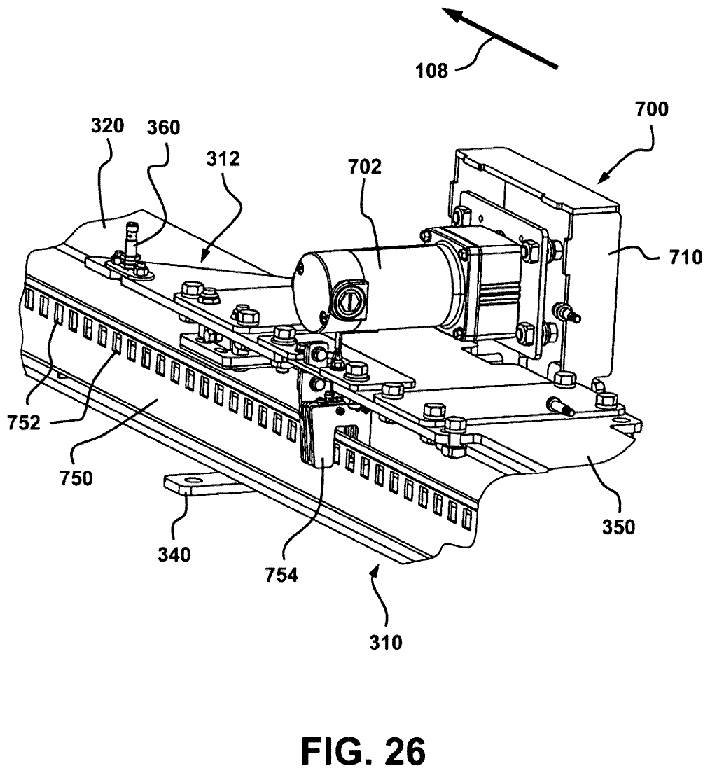

FIG. 26 is a partial isometric view of some of the components of the wheel chock positioning arrangement 300 shown in FIG. 12. FIG. 26 shows that the wheel chock positioning arrangement 300 can include a guide bar 750 extending vertically within the track subsystem 310. The proximal end of the guide bar 750 can also be seen in FIG. 22. This guide bar 750 can include regularly spaced apertures 752 positioned near the top edge thereof along the entire length. These apertures 752 are rectangular in the illustrated example. The top edge of the guide bar 750 is generally unobstructed and this allows a position sensor 754 attached under the base structure 350 and generally oriented in the transversal direction to straddle the top edge of the guide bar 750 over the entire range of motion. The position sensor 754 uses the apertures 752 to monitor its exact position along the rail 320. The position sensor 754 can be, for instance, a photoelectric device having a light source or a laser transmitter on one side and a photoelectric receiver on the opposite site that can detect a light beam or a laser beam when passing in from of one of the apertures 752. Counting the number of apertures from a given location, such as its stowed position, can be indicative of the travel distance. The information can then be sent, for instance, to a control system in the form of an output signal or using another method. Other configurations and arrangements are possible. Among other things, the shape and/or position of the apertures 752 can be different in some implementations. A position sensor 754 can be implemented using a transmitter/receiver located on the same side, and a reflector on the opposite side. Other kinds of sensors, detectors and/or methods can also be used, including ones that do not involve apertures or even a guide bar. Other variants are possible as well.

The guide bar 750 can be a substantially vertical wall made of a narrow band of metal or of any other material. As can be seen in FIG. 22, the bottom of the guide bar 750 can be bent and affixed to the rail 320 through a mounting arrangement. This arrangement can further include a second wall 760 extending parallel to the guide bar 750 next to the web 654 of the rail 320, as shown. The second wall 760 can also be seen in FIGS. 24 and 25. This second wall 760 can be attached to the web 654 of the rail 320 at multiple spaced apart locations along the rail 320 using mechanical fasteners (not shown). Other configurations and arrangements are possible. Among other things, the second wall 760 and/or at least one of the other features can be designed and/or positioned differently, or be omitted in some implementations. Other variants are possible as well.

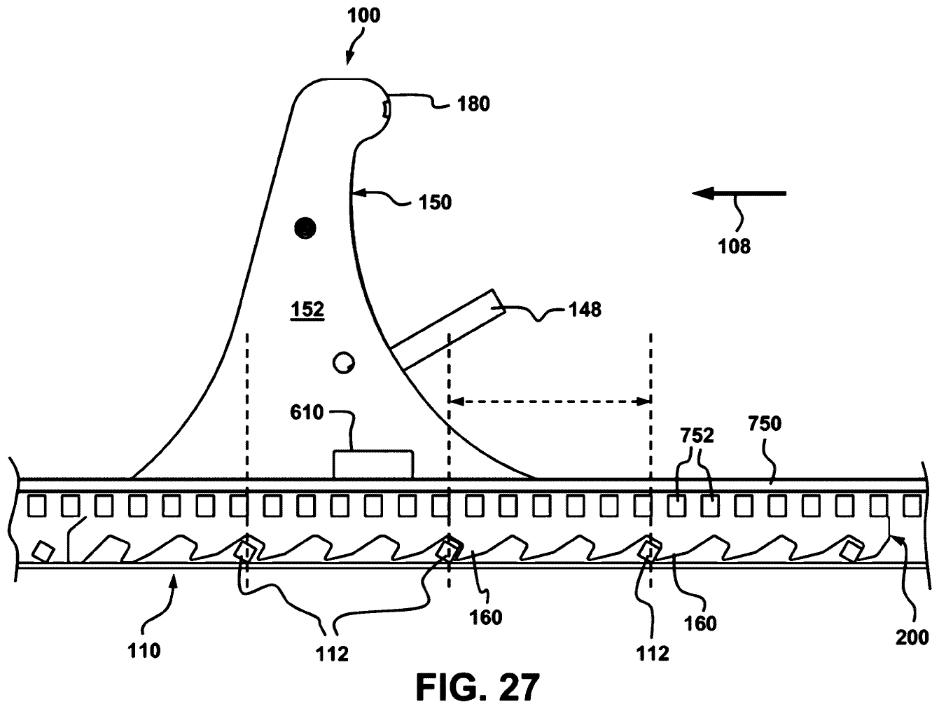

FIG. 27 is an abridged and semi-schematic side view of the wheel chock 100 being in a latched engagement with the base plate 110. This figure is only provided for the sake of explanation.

As previously mentioned, the longitudinal distance between two successive teeth 160 under the wheel chock 100 can be subdivided approximately into a fraction of the longitudinal distance between two successive blocking elements 112 on the base plate 110. The spacing between the apertures 752 on the guide bar 750 can also be a fraction of the longitudinal distance between two successive blocking elements 112 on the base plate 110. For instance, the spacing between each aperture 752 on the guide bar 750 can correspond approximately to one sixth of the spacing between two successive blocking elements 112, and the width of each aperture 752 can match the width of the solid surface between two adjacent apertures 752. The relative position between the base plate 110 and the guide bar 750 will remain the same once the wheel chock positioning arrangement 300 is installed and if no major modifications are made to these components afterwards. Other configurations and arrangements are possible. Among other things, the overall layout and/or configuration can be different in some implementations. Other variants are possible as well.

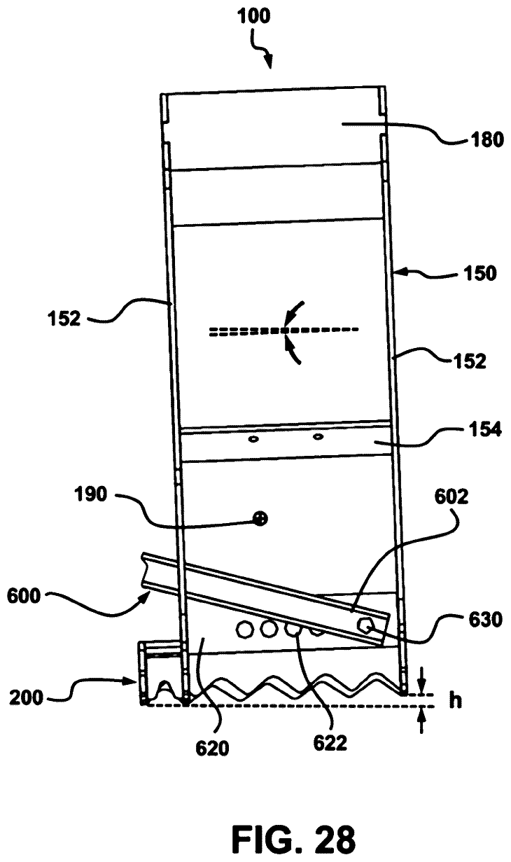

FIG. 28 is a partial cutaway view illustrating the wheel chock mount 600 inside the wheel chock 100 shown in FIG. 22. This view was simplified and abridged for the sake of illustration. It shows, among other things, the supporting member 602 inside the main body 150, one of the transversal walls 620 and its corresponding holes 622. FIG. 28 also shows that the wheel chock 100 is not perfectly horizontal and its top side is leaning slightly towards the West direction in this example. The wheel chock 100 depicted in the example includes an extension 200, and this results in the center of gravity 190 being slightly offset with reference to the medial plane, or geometric center, of the main body 150. The wheel chock 100 is pivotally attached to the distal end of the wheel chock mount 600 and the widthwise position of the pivot axis 606 (FIG. 21) does not coincide with the widthwise position of the center of gravity 190. They are both on opposite sides of the medial plane, or geometric center, of the main body 150 in the illustrated example. This causes the wheel chock 100 to lean on one side, as shown. The tilt angle is limited by the available space between the top side of the support member 602 (FIG. 19) of the wheel chock mount 600, and the upper edge of the side opening 610 (FIG. 20). Other configurations and arrangements are possible. Among other things, one or more of these features can be designed and/or positioned differently in some implementations, and at least one of them can be omitted in others. Other variants are possible as well.

FIG. 28 further shows the height difference h between the inboard and outboard edges of the wheel chock 100 created by slightly tilting the wheel chock 100 when it is suspended above the base plate 110, the inboard edge (at the right in the figure) being vertically above the outboard edge (at the left). As shown for instance in FIG. 21, teeth under the wheel chock 100 can be formed by parts that were cut away from the bottom edge of the side members 152 and under the extension 200 when one is present. The extension 200 is often provided along the outboard side of the main body 150 since such extension 200 is generally placed next to the wheel 102. The outboard side will then have teeth located away from the geometric center of the main body 150 and for this reason, it may be desirable that the outboard side first contacts the base plate 110 just in case the wheel chock 100 is misaligned. The inboard side is generally easier to position, and allowing the outboard edge to first engage the base plate 110 can mitigate the risks of jamming the wheel chock 100 on the blocking elements 112. This also increases the tolerance of the wheel chock positioning arrangement 300 to a misalignment of the wheel chock 100 when it initially engages the base plate 110.

When the suspended wheel chock 100 is moved downwards towards the base plate 110, there is always a likelihood that the bottom surface between two adjacent cutaway portions somewhere under the wheel chock 100 contacts the top of one of the blocking elements 112 while the others are not. The longitudinal width of the free space between two successive teeth 160 is relatively tight compared to the overall longitudinal width of each blocking element 112. Even with an automatic control system and various features to keep track of the exact position of the wheel chock 100 along the North-South directions, a misalignment of the wheel chock 100 with reference to the longitudinal axis 108 can cause the slopping surface next to a cutaway portion to engage the top of a blocking element 112 while the other blocking elements 112 under the wheel chock 100 are in registry and almost in registry with a corresponding free space. This problem may be caused by a single mispositioned slopping bottom surface, but it could also involve more than one mispositioned slopping bottom surfaces in some cases. The mispositioned slopping bottom surface or surfaces can urge the wheel chock 100 to pivot in one direction around a vertical pivot axis while the others can prevent the wheel chock 100 from pivoting or even urge it to pivot in the opposite direction. Further pushing on the side of the wheel chock 100 in the East direction could then result in the wheel chock 100 being tightly wedged. Unwedging the wheel chock 100 may require the intervention of a person, and even the use of tools such as a hammer, to free a jammed wheel chock.

Using stringent tolerances in the various parts of the support arm subsystem 314 could, in theory, decrease the likelihood of such a problem, but this may create other challenges. Among other things, it will most likely increase the manufacturing and maintenance costs. It may also prevent the wheel chock 100 to self-correct its position and prevent the longitudinal position of the wheel chock 100 from shifting very slightly so that the blocking element 112 can move into the corresponding free spaces. In other words, the wheel chock 100 could remain in engagement with the top of the blocking elements 112, thus not in position where the wheel chock 100 will be in a latching engagement with the base plate 110. A more permissible tolerance can mitigate this problem, but can also increase the risks of having a misalignment.

It is worth mentioning that despite the potential benefits of having a slight tilt angle with reference to the horizontal when placing the wheel chock 100 on the base plate 110, it remains possible to keep the wheel chock 100 substantially at the horizontal in some implementations.

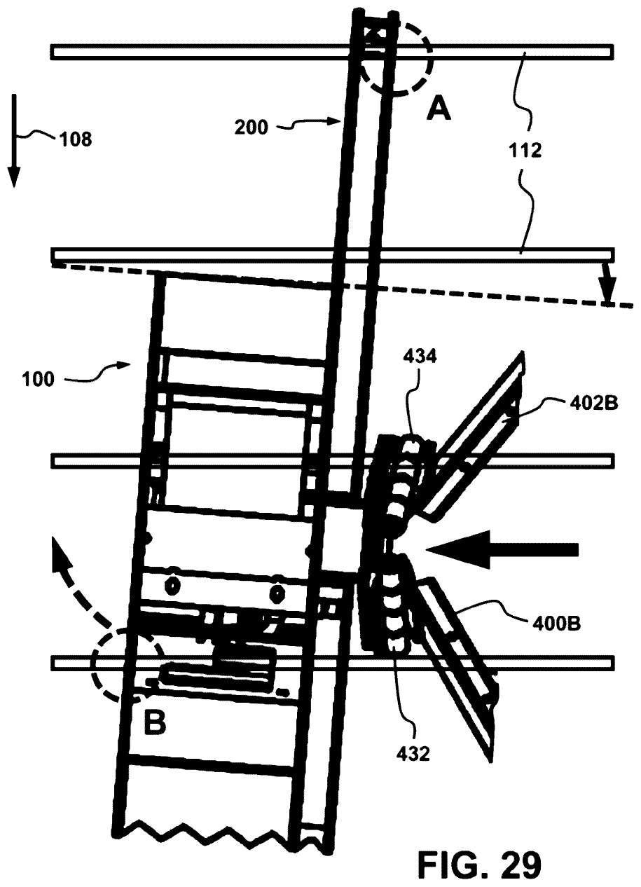

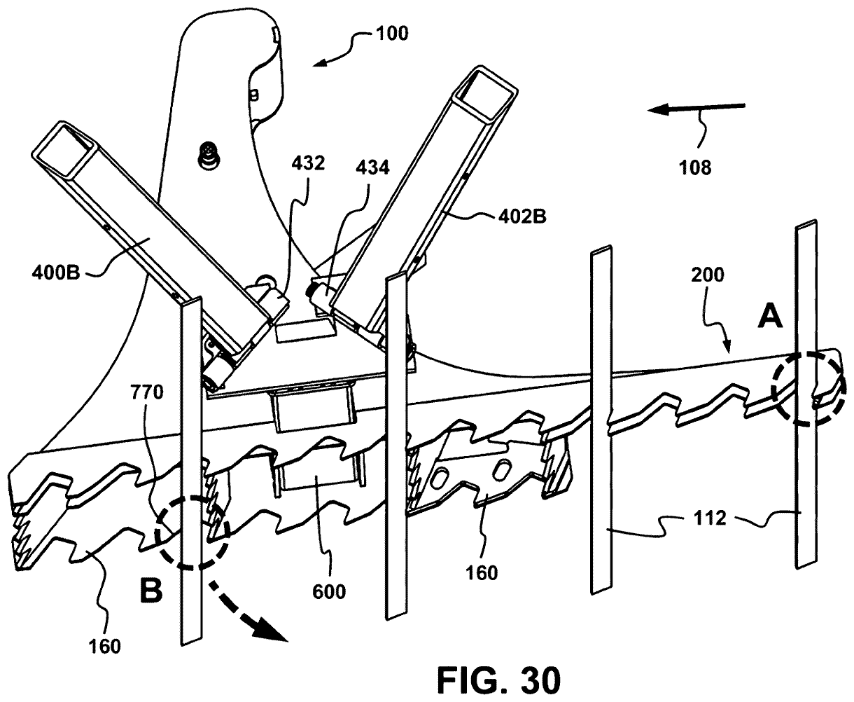

FIG. 29 is a semi-schematic top view depicting semi-schematically an example of the engagement of the wheel chock 100 over the blocking elements 112 of the base plate 110 when the wheel chock 100 is misaligned in a first direction about a yaw axis. FIG. 30 is a bottom isometric view corresponding to the situation shown in FIG. 29. In this first hypothetical example, the wheel chock 100 had a flat posture or attitude when it arrived on the base plate 110. Some of the teeth 160 under the wheel chock 100 engaged a corresponding one of the blocking elements 112. However, because the wheel chock 100 is continuously pushed sideways, as depicted in FIG. 29 using the large arrow, the wheel chock 100 is unable to self-align by gravity and realign with the blocking elements 112. In this case, the tooth 160 at the free end of the extension 200 engages one of the blocking elements 112. The outboard portion of the tooth 160 is fully engaged on the front edge of the blocking element 112 while the inboard portion is slightly away therefrom due to the skew angle of the wheel chock 100. This constitutes the first contact point, namely point A depicted in FIGS. 29 and 30 using a dashed circle. The other contact point is point B, also depicted in FIGS. 29 and 30 using a dashed circle. Point B is located on the inboard side under the main body 150. As can be seen in FIG. 30, the slopped surface 770 engages the top of the corresponding blocking element 112 and the force applied on the wheel chock 100 will cause the slopped surface 770 to slide on this blocking element 112 away from where the blocking element 112 should be, thereby further pivoting the wheel chock 100 in the same direction as its initial misalignment with reference to point A and, most likely, causing the wheel chock 100 to be jammed shortly thereafter.

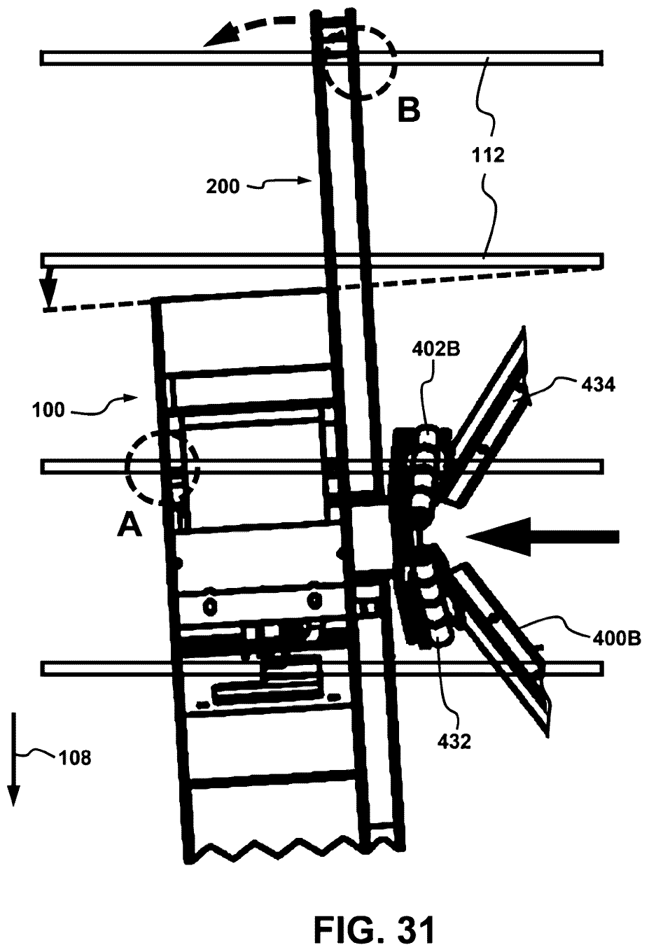

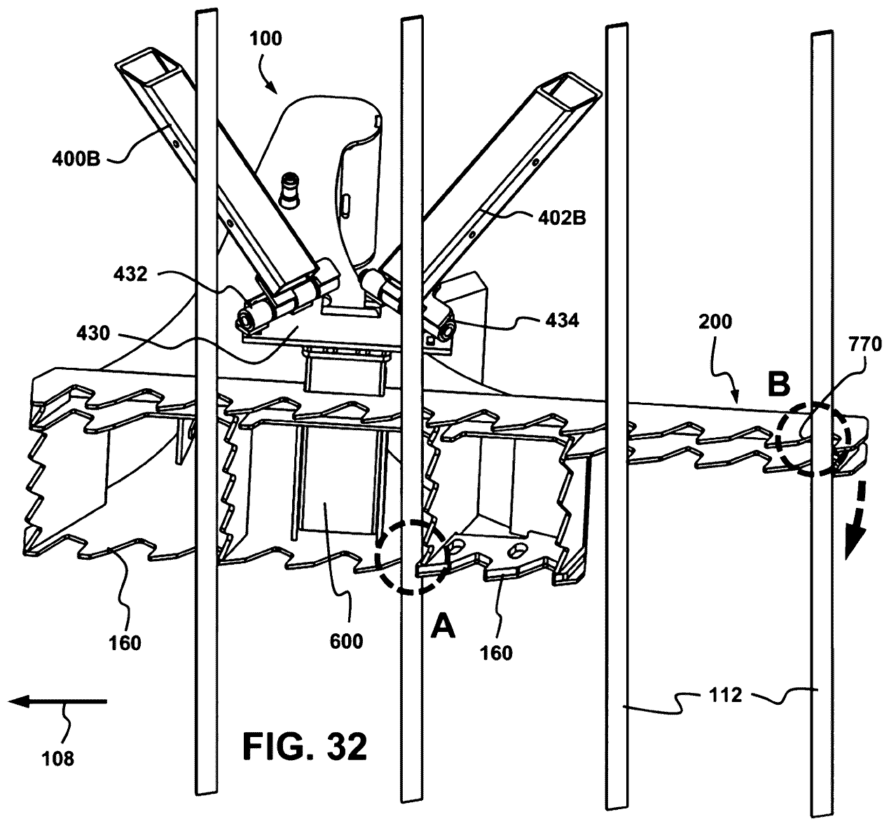

FIG. 31 is a semi-schematic top view similar to FIG. 29 where the misalignment is in a second direction that is opposite to the first direction in FIG. 30, and FIG. 32 is a bottom isometric view corresponding to the situation shown in FIG. 31. The first contact point, namely point A, is now located on the inboard side under the main body 150. Point B is located under the outboard portion of the tooth 160 at the free end of the extension 200. This is where the slopped surface 770 is located in this case. The slopped surface 770 engages the top of the corresponding blocking element 112 and the force applied on the wheel chock 100 will cause the slopped surface 770 to slide on this blocking element 112 away from where the blocking element 112 should be, thereby further pivoting the wheel chock 100 in the same direction as its initial misalignment with reference to point A and, most likely, also causing the wheel chock 100 to be jammed shortly thereafter.

The height difference between the inboard and outboard edges of the wheel chock 100, as shown for instance in FIG. 28, helps to align all chock surfaces with reference to the blocking elements 112 on the base plate 110 by gravity. When all inboard tooth surfaces are aligned, the wheel chock 100 corrects its posture and the other tooth surfaces will be properly aligned.

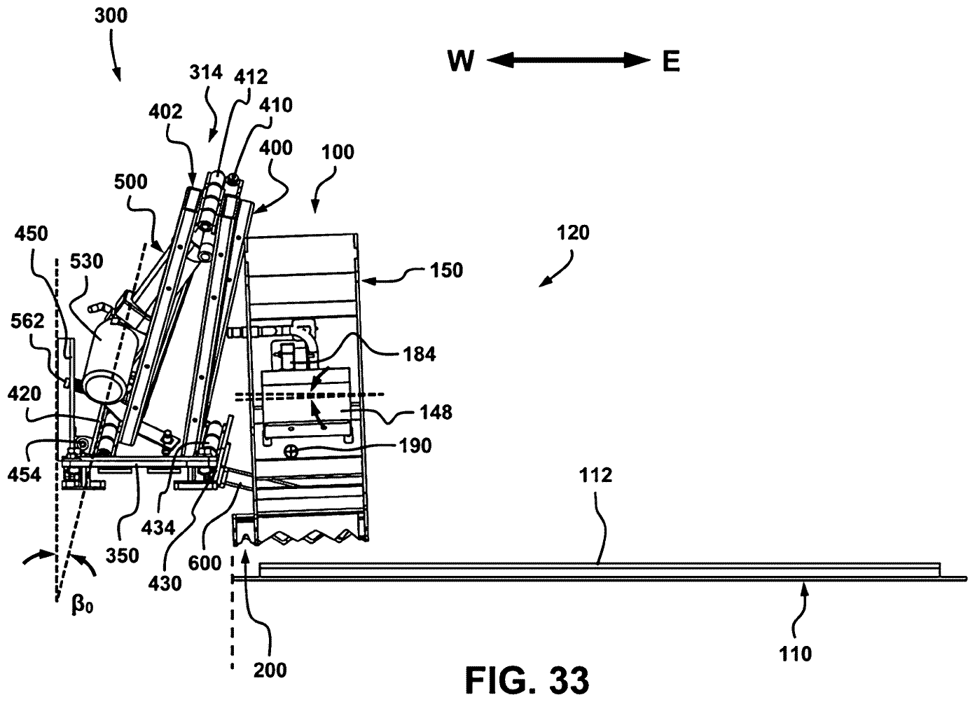

FIGS. 33 to 36 are simplified end views illustrating in sequence the support arm subsystem 314 moving from a retracted position to a fully extended position to set the wheel chock 100 on the base plate 110.

FIG. 33 shows the support arm subsystem 314 in a retracted position. The wheel chock 100 is now at the closest position from the base structure 350 of the carriage subsystem 312. The bottom of the wheel chock 100 is also above the top edge of the blocking elements 112 on the base plate 110. This stance allows the wheel chock 100 to travel freely along the North and South directions while remaining at least partially above the base plate 110.

In FIG. 33, the weight of the wheel chock 100 is supported by the support arm subsystem 314. The wheel chock 100 is connected to the distal end of the support arm subsystem 314 through the wheel chock mount 600, itself attached to the two articulated cantilever arm assemblies 400, 402. The proximal hinges 422, 424 at the proximal ends of the two articulated cantilever arm assemblies 400, 402 are oriented at a 90-degree angle relative to one another, and the distal hinges 432, 434 at their distal ends are also oriented at a 90-degree angle relative to one another. Since the proximal mounting plate 420 and the distal mounting plate 430 maintain each corresponding pair of hinges in juxtaposition at a constant distance from one another, and since the actuator mechanism 500 can prevent the second proximal and distal arms 402A, 402B from pivoting relative to one another in the illustrated example, the support arm subsystem 314 becomes a static armature, and the weight of the wheel chock 100 and that of the support arm subsystem 314 become mainly a moment of force at the pivot joint 454. The counterbalancing mechanism 550 partially counterbalances this moment of force, thus the weight of the wheel chock 100 and the weight of the support arm subsystem 314. It can also be designed to prevent the proximal mounting plate 420 from pivoting beyond a maximum pivot angle because the bolt heads 562 abut against the back side of the lateral support 450, as shown in the illustrated example. This maximum pivot angle is depicted as the pivot angle β0 in FIG. 33. Other configurations and arrangements are possible. Among other things, one or more of these features can be designed and/or positioned differently in some implementations, and at least one of them can be omitted in others. Other variants are possible as well.

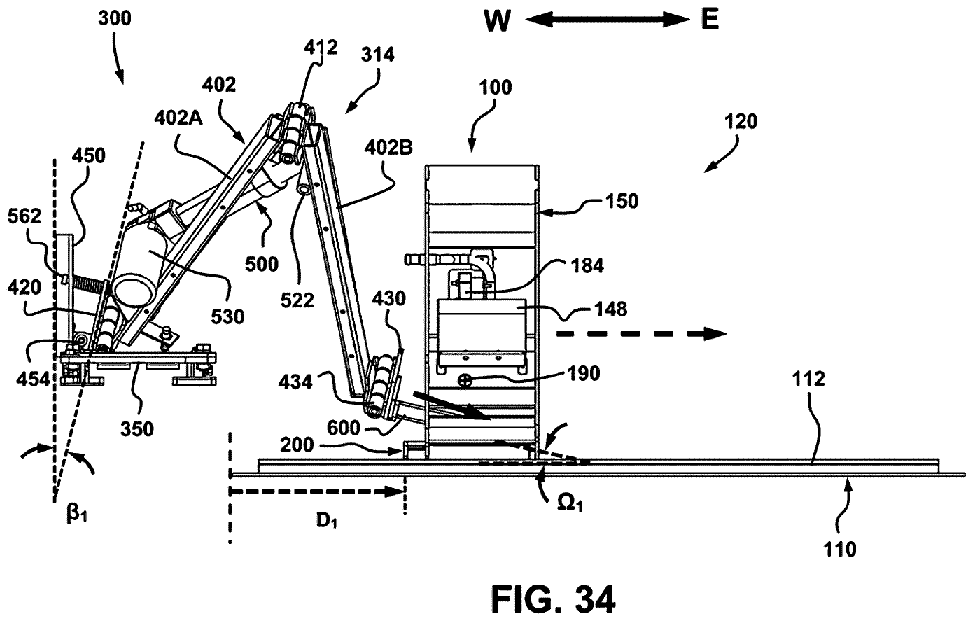

FIG. 34 shows the support arm subsystem 314 at a first partially extended position. The actuator mechanism 500 was extended and this caused the distal end of the support arm subsystem 314, thus the wheel chock 100 attached thereto, to move in the East direction over a transversal horizontal distance D1. FIG. 34 shows the wheel chock 100 shortly after it made the initial contact with the base plate 110.

The resulting motion of the distal end of the support arm subsystem 314 with reference to its proximal end is essentially linear when the actuator mechanism 500 extends or retracts. However, because the proximal mounting plate 420 at the proximal end of the support arm subsystem 314 is at an oblique angle with reference to the vertical, the initial portion of the path followed by the wheel chock 100 when the support arm subsystem 314 is moved away from its retracted position is oriented slightly downwards. This allows the wheel chock 100 to be lowered and engage the base plate 110 after moving along the East direction using only a single actuator 510. Hence, the illustrated wheel chock positioning arrangement 300 does not require a separate actuator or lifting mechanism to move the wheel chock 100 up or down. Other configurations and arrangements are possible.

FIG. 34 also shows that the wheel chock mount 600 is now at an angle Ω1 with reference to the upper surface of the base plate 110. The wheel chock 100 is also at a leveled position since its underside rests on the base plate 110. The weight of the wheel chock 100 is no longer supported by support arm subsystem 314.

The exact distance over which the wheel chock 100 must travel from its original position before engaging the base plate 110 can vary from one implementation to another. A relatively short distance can be desirable if the lateral side of the vehicle 104 is close to the rail 320 and the wheel chock 100 can only reach its intended position if it is already on the base plate 110 and pushed sideways into position because the available space is extremely limited.

FIG. 34 shows the wheel chock 100 being pushed by the support arm subsystem 314 in the East direction as the actuator mechanism 500 extends. The moment of force applied around the pivot joint 454 is counterbalanced by the return force generated by the springs 570 of the counterbalancing mechanism 550. The bolt heads 562 moved very slightly away from the back side of the lateral support 450. The proximal mounting plate 420 now has a pivot angle β1 that is smaller than the pivot angle β0 in FIG. 33.

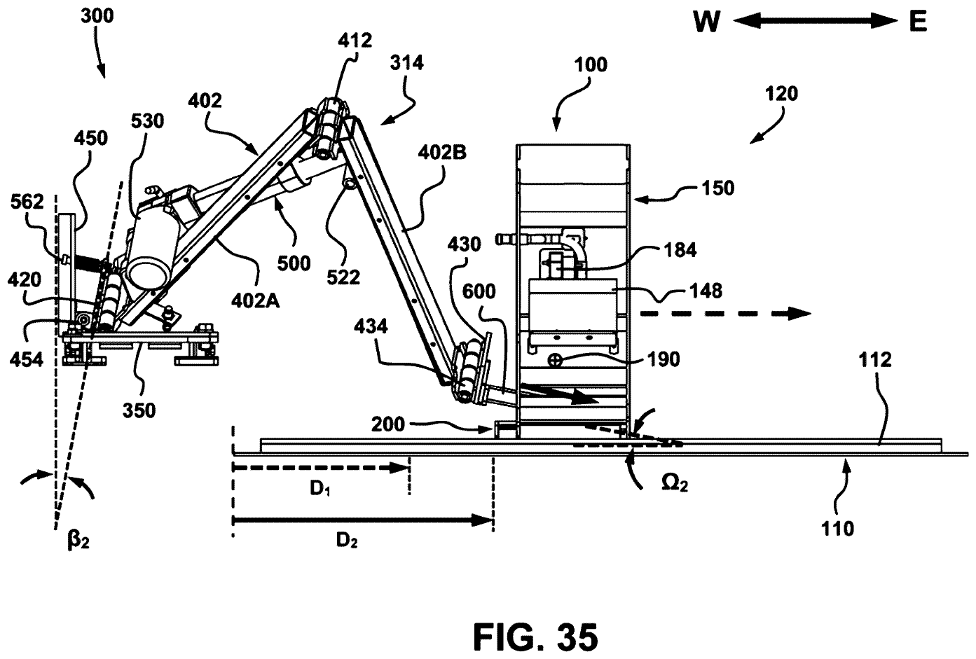

FIG. 35 shows the support arm subsystem 314 at a second partially extended position. The actuator mechanism 500 was extended further, and the wheel chock 100 is now at the distance D2. The distance D1 is also shown in FIG. 35 for the sake of comparison.

The force applied by the support arm subsystem 314 at its junction with the wheel chock 100 is not parallel to the upper surface of the base plate 110. It is instead slightly downwards, the orientation of the force vector corresponding approximately to the lengthwise axis of the wheel chock mount 600. The wheel chock mount 600 transfers this force to the wheel chock 100 at a location within the main body 150 that is relatively close to the bottom of the wheel chock 100, hence well below the center of gravity 190. The material of the main body 150 in a wheel chock 100 is generally harder than that of the base plate 110, and it is generally desirable to prevent the underside of the wheel chock 100 from damaging the upper surface of the base plate 110 by minimizing the vertical downward component of the force vector. The vertical component of the force also increases the frictional resistance. Still, pushing the wheel chock 100 sideways at a location close to its bottom can mitigate the risks inadvertently tipping the wheel chock 100.

FIG. 35 also shows that the wheel chock mount 600 is now at an angle θ2. The angle Ω decreases as the distance D increase, and the angle Ω2 is smaller than the angle Ω1 in FIG. 34. This is a desirable feature since the wheel chock 100 is being pushed further sideways in the East direction by the support arm subsystem 314. The proximal mounting plate 420 is now at a pivot angle β2 that is smaller than the pivot angle β1 in FIG. 34.

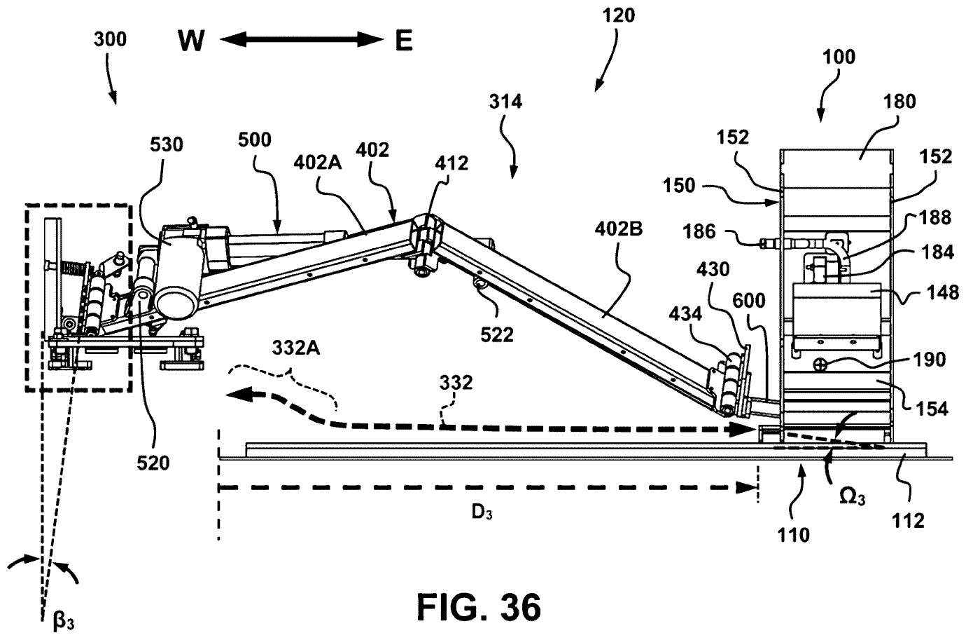

FIG. 36 shows the support arm subsystem 314 of the illustrated example in an outstretched state and at its fully extended position. The actuator mechanism 500 has reached the maximum extension, and the wheel chock 100 is now at the distance D3. The proximal mounting plate 420 is also at a pivot angle β3 that is smaller than the pivot angle β2 in FIG. 35.

FIG. 36 further shows that the overall transversal path 332 includes a somewhat curved initial portion 332A. This represents the approximative vertical trajectory followed by the wheel chock 100 in the first part of the extension of the support arm subsystem 314, for instance at the connector 630. The same curved portion 332A will occur in the West direction.

When positioning the wheel chock 100 next to a wheel, for instance the wheel 102, the wheel sensor 184 can be useful to fine-tune the positioning of an incoming wheel chock 100 or at least to provide a confirmation that the wheel chock 100 was placed next to a wheel.

It should be noted that FIGS. 33 to 36 are only for the sake of explanation, and the stretched length does not necessarily need to be the same in some implementations. However, it shows that the wheel chock 100 can travel in the East/West directions over a considerable distance compared to a system simply using a blocking feature positioned in the path of a wheel and where the forces involved during an unauthorized or accidental maneuver attempt are transferred to the system itself. The maximum distance over which a blocking feature can extend sideways in most of these systems is often approximately 16 inches (40.6 cm). By comparison, to give an order of magnitude, the distance D3 in FIG. 36 is approximately 33 inches (83.8 cm). For a loading area where both small delivery vans and semi-trucks can access the same loading door, this increased range can be desirable to bring greater versatility with the possibility of securing several types of vehicles with the same equipment. Still, even if the diversity of the vehicles is limited, the increased range can allow the rail 320 to be placed further away on the side so as to give more room for the incoming vehicles, among other things.

FIG. 37 is an enlarged end view of the parts at the proximal end of the support arm subsystem 314 shown in FIG. 36. The corresponding enlarged area is identified in FIG. 36 by the rectangle drawn using a stippled line. As can be seen, when the proximal mounting plate 420 of the illustrated example is at the smallest pivot angle β3, the bolts 560 of the counterbalancing mechanism 550 are further extending out through their corresponding holes made across the lateral support 450 and the bolt heads 562 are now at a certain distance from the back side surface of the lateral support 450. The springs 570 are no longer extended.

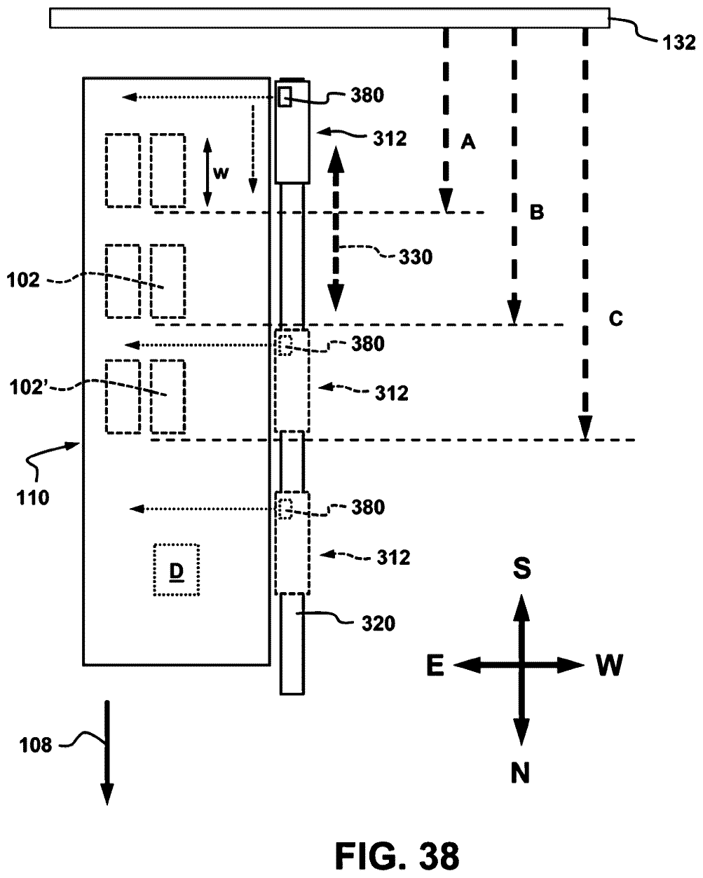

FIG. 38 is a schematic top view depicting an example of a carriage subsystem 312 moving along the rail 320 to detect where the wheel chock 100 can be set on the base plate 110. As previously mentioned, the wheel chock positioning arrangement 300 can include a scanning device 380 to detect the position of the wheels and the presence of any obstacles. FIG. 38 is a simplified representation of the example shown in FIG. 11 where the vehicle 104 includes three juxtaposed axles. Like in most implementations, the carriage subsystem 312 will be parked at the proximal end of the rail 320 when the incoming vehicle 104 backs up into position. The support arm subsystem 314 will then be in a retracted position. The vehicle 104 will eventually stop moving and the wheel chock positioning arrangement 300 can be activated by someone, for instance, by pressing a button or by sending a command remotely. This can be done by a site operator or manager, by someone working at the site, and by the driver of the vehicle. It can also be entirely automatic in some implementations. The operator can also be the person granting clearance for a departure and issuing a command to a given wheel chock positioning arrangement 300 for removing the wheel chock 100. Other procedures and approaches are possible.

A loading dock often receives vehicles having a wide range of different configurations and characteristics. Some vehicles may have a single axle at the rear, others may have two or more. The spacing between two axles may also vary from one vehicle to another, and some vehicles may have ancillary features in the vicinity of the wheels. Hence, the position of the wheel chock 100 along the longitudinal path 330 will generally often vary constantly. The position of the wheel chock 100 along the transversal path 332 will also vary due to the wide range of configurations and characteristics of the vehicles, but also to a possible deviation between the longitudinal axis of the vehicle and the geometric centerline of the loading dock. The scanning device 380 can be useful for positioning the wheel chock 100 in all these cases.

When a newly arrived vehicle parks at a loading dock and the wheel chock positioning arrangement 300 is activated, the carriage subsystem 312 will start moving in the North direction along the rail 320. The line-of-sight of the scanning device 380 is oriented in the East direction and, when installed on the carriage subsystem 312, it is placed at a location where the wheel chock 100 and the support arm subsystem 314 will not hinder its field of view when the support arm subsystem 314 is a retracted position. The range of the scanning depth can be adjusted if necessary.

The carriage subsystem 312 will conduct the scanning operation at the carriage subsystem 312 is moving at a relatively slow but constant speed. The information obtained from the scanning device 380 can be sent to a control system as analog and/or digital signals. The control system can be programmed to identify different objects, for instance the wheels, encountered along the way. For instance, as schematically shown in FIG. 38, the diameter of the wheel can be deducted from the presence of a large object during the scanning process and the width during which something was detected. The width of the space between two adjacent wheels is also measured. The information gathered by the scanning device can further verify if something may prevent the wheel chock 100 from being placed at a potential location, such as an accessory on the vehicle itself, or a debris on the base plate 110. The control system can be programmed to ignore relatively small objects, such as mud guards, and/or ignore relatively large objects, such as an underride bar. The scanning is done with the support arm subsystem 312 remaining in the retracted position or at least in a position where the underside of the wheel chock 100 is at least a few centimeters above the top of the blocking elements 112.

The optimum position for the wheel chock 100 will often be the location right in front of the wheel 102′. This wheel 102′ is the frontmost one among those provided on the three axles. It is the closest to the center of gravity when the vehicle is loaded. However, the control system can be programmed so that when a second axle is detected along the North direction and there is most likely enough space to place the wheel chock 100 in front of the wheel 102 on the second axle, the control system can interrupt the scanning process and proceed immediately with the positioning of the wheel chock 100. This can often be a suitable compromise between the time needed to complete the scanning and the positioning of the wheel chock 100, and the level of retention capacity. The example shows that there are three possible positions for the wheel chock 100 along the longitudinal path 330. They are identified as position A, position B and position C. The corresponding arrows are indicative of the distance of these positions from the wall 132. While placing the wheel chock 100 at position C, thus in front of the wheel 102′ at the end of the third axles, would generally maximize the retention capacity, the difference between position B and position C is generally not incredibly significant. In other words, the added benefits of selecting position C instead of position B are often marginal and, in most cases, they may not justify the additional time needed for the carriage subsystem 312 to bring the scanning device 380 further away in the North direction to scan the wheel 102′ at the end of the third axle. For instance, it can be desirable to have the wheel chock 100 in the wheel blocking position within 30 seconds of the activation. This can be a goal based on the average time. The time needed to bring the wheel chock 100 in position can be longer in one instance, and then be shorter in the next. For example, if the control system determines there is not enough space to set the wheel chock 100 at position B, then the carriage subsystem 312 will continue in the North direction and scan the wheel at the end of the third axle. The control system will set the wheel chock 100 at position C if possible. It can also set the wheel chock 100 at position A if this is the only available option, or if the vehicle present at that moment only has a single rear axle. When moving in the North direction and looking for an additional axle, the control system can limit the travel distance, for instance using a predetermined value, over which the carriage subsystem 312 will continue in the North direction before the control system concludes that no additional axle is present when no wheel was detected after the last one. The control system can also be programmed to determine that only a container 104B is present, thus that the wheel chock 100, for instance a bidirectional model, must be set at a position D located further away on the base plate 110, as shown. Other configurations and arrangements are possible. Among other things, the sequence of operation and/or time limits can be different. The selection of the position of the wheel chock 100 can also be done using another system or method, or even be done manually by a user, for instance after a visual inspection. Other variants are possible as well.

FIG. 39 is a simplified block diagram schematically depicting an example of a control system that can be provided with the wheel chock restraint system 120 as provided herein. The relative positions of the various components is only for the sake of explanation and to give a general overview. It does not necessarily include all the components or suggest that the ones present in this figure must be present.

FIG. 39 includes a schematic representation of the base structure 350 of the carriage subsystem 312 installed over the rail 320. The components mounted on the base structure 350 include, among other things, the two proximity sensors 360, the scanning device 380, the first and second position sensors 640, 644 for the support arm subsystem 314, the drive motor 702 of the translational mechanism 700, and the position sensor 754 for the guide bar 750. There is also the drive motor 530 of the actuator 500 that is mounted on the support arm subsystem 514. This drive motor 530 can have a wired connection with another unit located on the carriage subsystem 312 and/or with one located elsewhere using a wire 780, as schematically shown. The wheel chock 100 can also have a similar wire connection using a corresponding wire 782. These wires 780, 782 can transmit data, electrical power and/or a fluid such as compressed air or a hydraulic fluid, depending on what is needed. Some of the components mounted on the base structure 350 can be interconnected directly or indirectly with one another through a local connection arrangement or unit (not shown). The wheel chock positioning arrangement 300 can include a wired connection with outside components and a portion of this wire connection can be made using a wire 784 located inside the rail 320 and that can follow the motion of the base structure 350 along the rail 320. The wire 784 can also be a bundle of different wires, cables or conduits, and this wire 784 may include at least one of the wires 780, 782. The wire 784 can include an interface with the outside components at a junction box 786, and this junction box 786 can have a wired connection to a control unit 790, located for instance inside the building, this wired connection being schematically depicted in FIG. 39 using the wire 792. The control unit 790 can receive signals and/or data from at least some of the components, and transmit command signals. The control unit 790 can also be connected to a safety panel 794 or the like using a wire 796. The safety panel 794 can display visual and/or audible signals, for instance light signals, and provide an interface with ancillary systems such as a controller to open or close the door through which the interior of the vehicle can be accessed. The control unit 790 can be a computer, a server or a dedicated machine, and it can also be programmed to exchange data and other signals or information with remote devices. Other configurations and arrangements are possible. Among other things, at least some of these features can be different and/or omitted in some implementations. Other variants are possible as well.

FIG. 39 further illustrates that the wheel chock 100 can include other electronic components in additional to or instead of a wheel sensor 184. One can be a vehicle proximity sensor 800 that is configured and disposed to detect the presence of an incoming vehicle at a given distance. Another is a base plate sensor 802 that is configured and disposed to detect, for instance using induction, that the wheel chock 100 is positioned right over one of the main plate members 114 of the base plate 110. Such base plate sensor 802 can be useful to check if there is something between the underside of the wheel chock 100 and the base plate 110, for instance a thick layer of ice, packed snow, sand or dirt, which could prevent the wheel chock 100 from establishing a latching engagement with the base plate 110 in case of an unauthorized or accidental maneuver attempt. Other configurations and arrangements are possible. Among other things, at least some of these features can be different and/or omitted in some implementations. Other variants are possible as well.

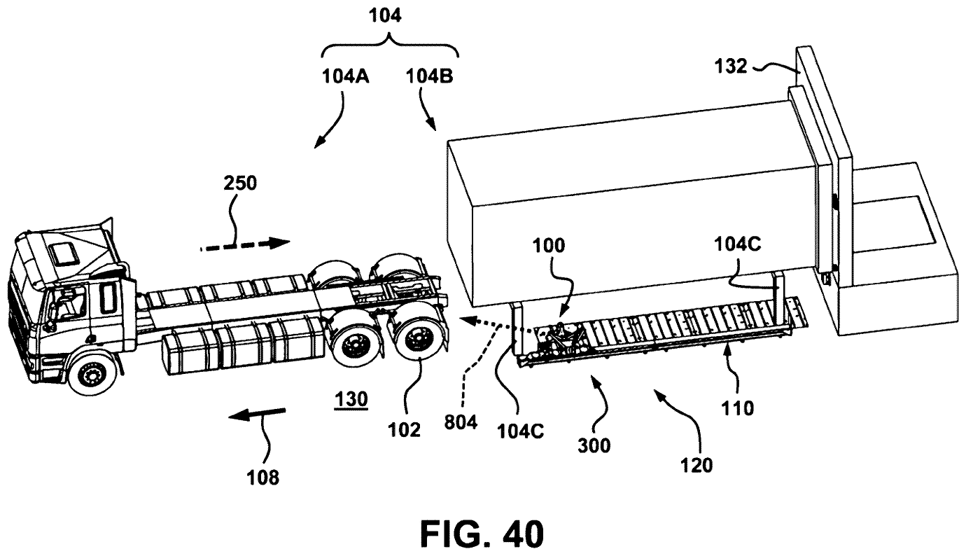

FIG. 40 is an isometric view illustrating an example of a generic vehicle having a swap body configuration at a loading dock where the wheel chock restraint system 120 of FIG. 12 is provided. The figure shows, among other things, that the wheel chock 100 in this example, for instance a bidirectional model, includes a vehicle proximity sensor 800 (FIG. 39). FIG. 40 depicts a beam 804 coming from the vehicle proximity sensor 800, for instance a laser, which can detect a chassis 104A being close to the wheel chock 100.

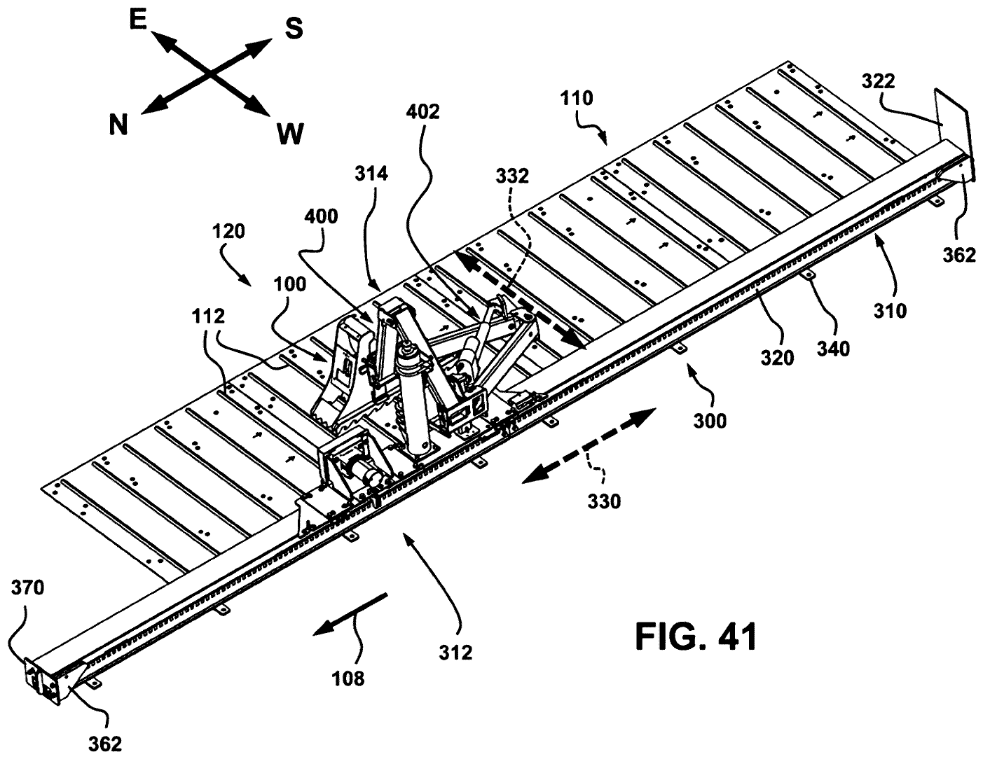

FIG. 41 is an isometric view illustrating another example of a wheel chock restraint system 120 having a wheel chock positioning arrangement 300 as proposed herein. This wheel chock positioning arrangement 300 also includes, among other things, a track subsystem 310, a carriage subsystem 312, and a support arm subsystem 314. The support arm subsystem 314 is mounted onto the carriage subsystem 312, and the wheel chock 100 is mounted at the distal end of the support arm subsystem 314 when the wheel chock restraint system 120 is fully assembled.

The track subsystem 310 illustrated in FIG. 41 includes an elongated rail 320 extending substantially parallel to the longitudinal axis 108. Its construction can be similar to that of the wheel chock positioning arrangement 300 shown in FIG. 12, and its support arm subsystem 314 can also include a first articulated cantilever arm assembly 400 and a second articulated arm assembly 402 that create a mechanism for moving the distal end in a linear manner. However, these two articulated cantilever arm assemblies 400, 402 are disposed a substantially L-shaped manner. The first articulated cantilever arm assembly 400 has essentially an upright vertical orientation, and the second articulated cantilever arm assembly 402 has essentially a flat horizontal orientation. These articulated cantilever arm assemblies 400, 402 are at a 90-degree angle with reference to one another.

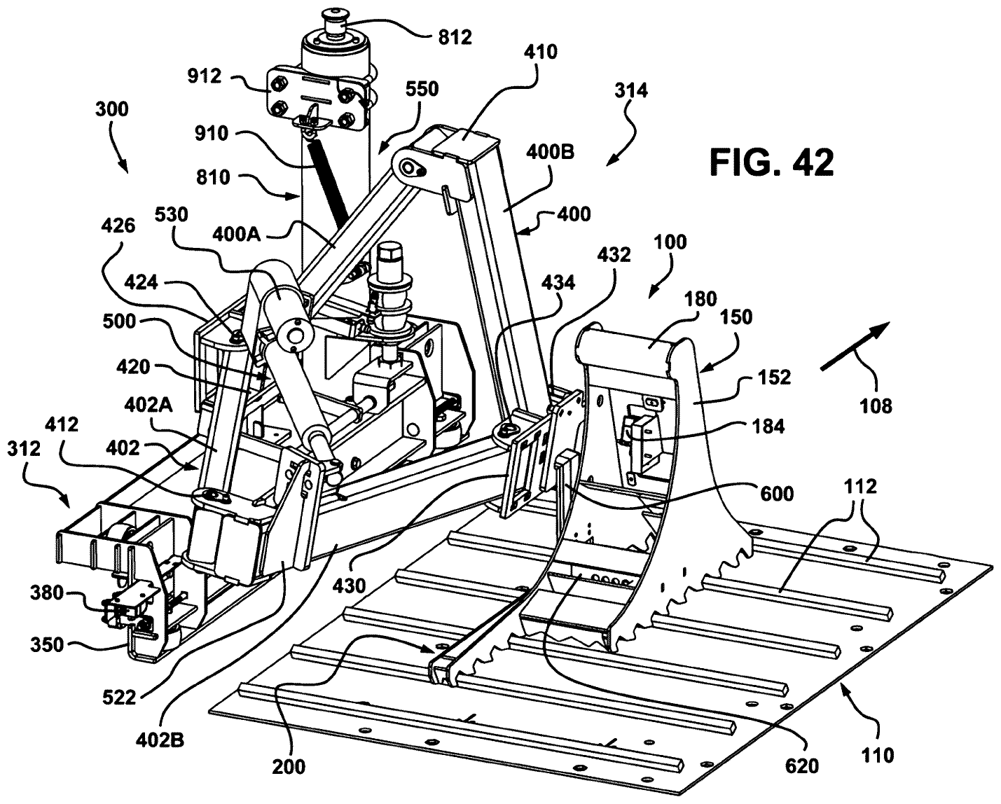

FIG. 42 is a partial isometric view of a wheel chock restraint system 120 similar to the one shown in FIG. 41. The track subsystem 310 is different from the one shown in the example of FIG. 41. However, the track subsystem 310 is not visible in FIG. 42. The first articulated cantilever arm assembly 400 and the second articulated cantilever arm assembly 402 each include a proximal end and a distal end. Both proximal ends are pivotally attached to a proximal mounting plate 420, and both distal ends are pivotally attached to a distal mounting plate 430. The first articulated cantilever arm assembly 400 includes a first proximal arm 400A and a first distal arm 400B, and the second articulated cantilever arm assembly 402 includes a second proximal arm 402A and a second distal arm 402B. The distal end of the first proximal arm 400A is pivotally interconnected with the proximal end of the first distal arm 400B through a first intermediate hinge 410, and the distal end of the second proximal arm 402B is pivotally interconnected with the proximal end of the second distal arm 402B through a second intermediate hinge 412. The proximal end of the first proximal arm 400A and the proximal end of the second proximal arm 402A are pivotally attached to the proximal mounting plate 420 through corresponding first and second proximal hinges 422, 424. These proximal hinges 422, 424 are spaced apart from one another and are located on the outboard side of the proximal mounting plate 420. The distal end of the first distal arm 400B and the distal end of the second distal arm 402B are pivotally attached to the distal mounting plate 430 through corresponding first and second distal hinges 432, 434. These distal hinges 432, 434 are spaced apart from one another and are located on the inboard side of the distal mounting plate 430. Other configurations and arrangements are possible. Among other things, the support arm subsystem 314 and/or at least some of the parts can be designed and/or positioned differently. Other variants are possible as well.

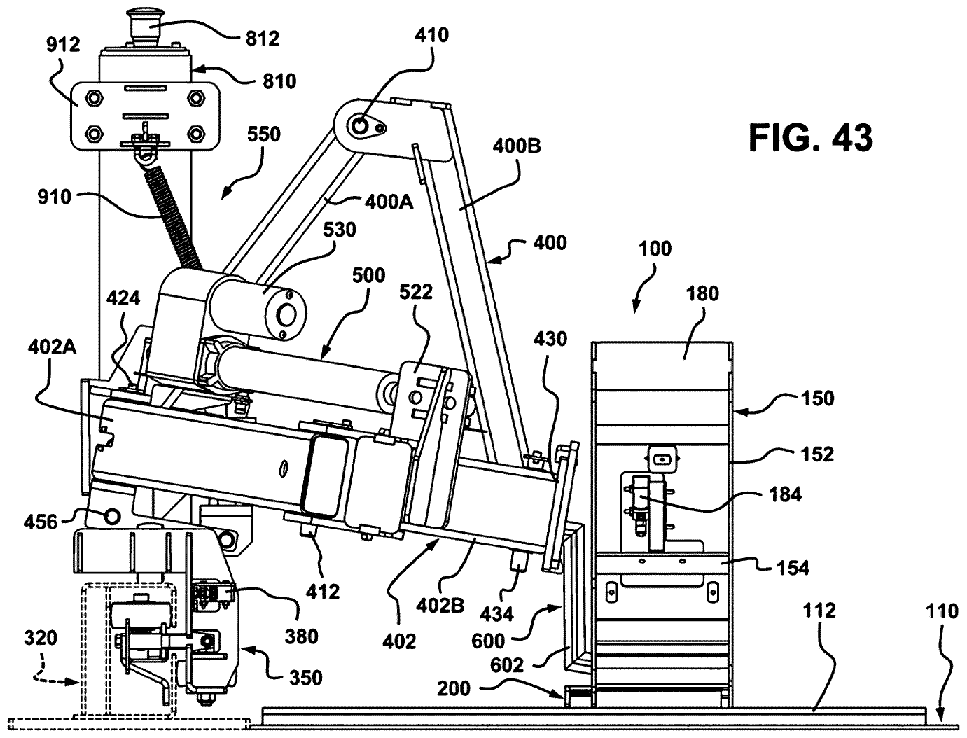

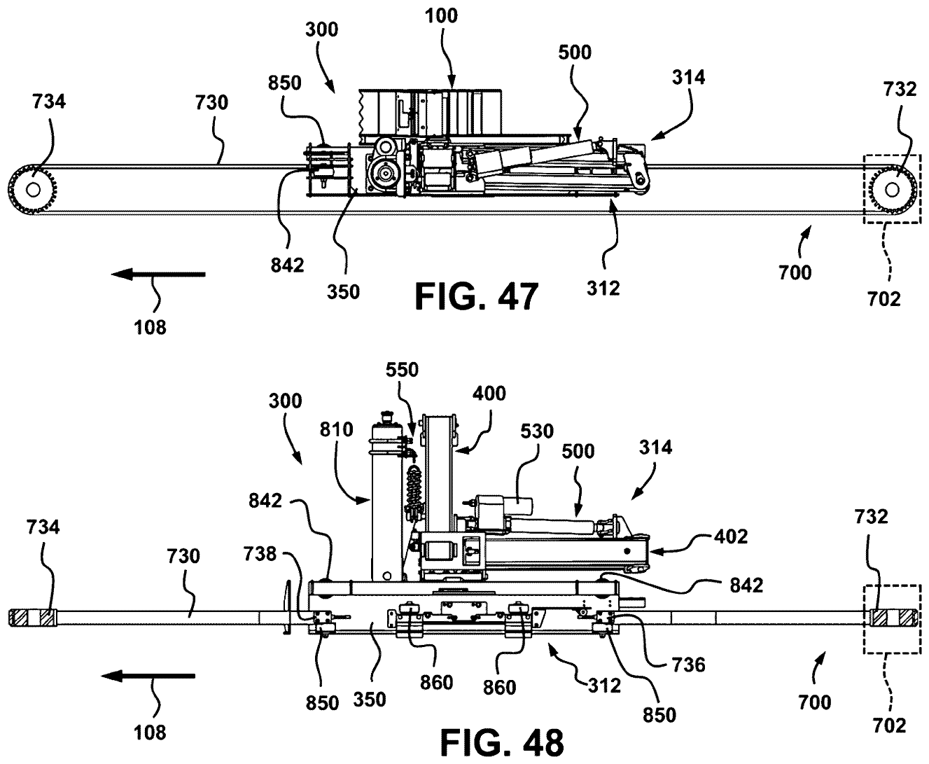

Each one of the two intermediate hinges 410, 412 can have a single axis that is in registry with the interior of the corresponding proximal arm 400A, 402A, and the proximal end of each of the distal arms 400B, 402B can then be pivotally connected to the corresponding intermediate hinge 410, 412 through a lateral extension, for instance one that includes two side plates, as shown for instance in FIGS. 42 and 43. This feature can allow each pair of arms to be parallel to one another when the support arm subsystem 314 is in a fully retracted position, as shown for instance in FIGS. 47 to 49. Other configurations and arrangements are possible. Among other things, the junctions between the proximal and distal arms can be designed differently in some implementations. Other variants are possible as well.

FIG. 42 further shows that the distal mounting plate 430 of the support arm subsystem 314 in the illustrated example is vertically higher than that of the example shown in FIG. 12. The support member 602 of the wheel chock mount 600 in this implementation is L-shaped. It includes a first straight segment extending downwards to the proximal end of a second straight segment going through the side opening 610 (see FIG. 43) and inside the wheel chock 100. Other configurations and arrangements are possible. Among other things, the wheel chock mount 600 can be designed and/or positioned differently. Other variants are possible as well.

The illustrated wheel chock positioning arrangement 300 includes an upright post 810 mounted on the carriage subsystem 312. It includes an emergency stop button 812 at the top. Other configurations and arrangements are possible. Among other things, the upright post 810 can be designed and/or positioned differently in some implementations. It can be omitted in others, but it can also be provided in the example shown in FIG. 12. Other variants are possible as well.

The proximal mounting plate 420 is pivotally attached to the base structure 350 of the carriage subsystem 312. However, the pivot joint 454 is located under the proximal mounting plate 420. This proximal mounting plate 420 further includes a back plate 426 for reinforcement. Other configurations and arrangements are possible. Among other things, the number and/or layout of the parts can be different from what is shown and/or described herein. At least some of the parts can be omitted in some implementations. Other variants are possible as well.

The wheel chock positioning arrangement 300 of the wheel chock restraint system 120 shown in FIG. 41 include an actuator mechanism 500 mounted next to the second articulated cantilever arm assembly 402. The proximal mount 520, however, is mounted to the proximal mounting plate 420 in this example. Its drive motor 530 is also oriented differently, and it is attached to a gearbox. Other configurations and arrangements are possible.

FIG. 43 is an end view of the wheel chock restraint system 120 shown in FIG. 41.

The wheel chock positioning arrangement 300 in this example also includes a counterbalancing mechanism 550 to remove some of the weight when the wheel chock 100 is on the base plate 110. This counterbalancing mechanism 550, however, is configured differently compared to the one in the previous example.

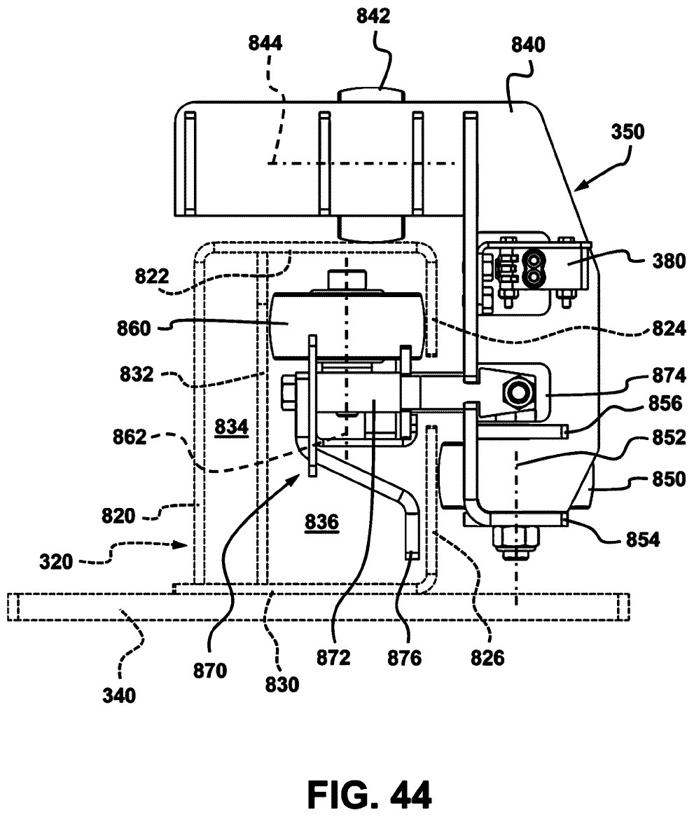

FIG. 44 is an enlarged view of the track subsystem 310 and some of the components of the carriage subsystem 312 of FIG. 43. Unlike the track subsystem 310 of the previous example, this one includes rollers and the rail 320 has a different configuration. FIG. 44 shows that this rail 320 is generally in the form of a hollow tube having a substantially rectangular cross section. It is depicted in stippled lines in this figure for the sake of illustration. The bedplate 340 at the bottom is also in stippled lines. The rail 320 includes, among other things, an outboard wall 820, a top wall 822, a top inboard wall portion 824, a bottom inboard wall portion 826, and a bottom wall 830. The top and bottom inboard wall portions 824, 826 are separated from one another by a rectilinear slot extending continuously over substantially the entire length of the rail 320. It also includes an internal vertical partition wall 832 extending longitudinally. The partition wall 832 divides the interior of the rail 320 in two inner sections or channels, namely an outboard inner section 834 and the inboard inner section 836, the inboard inner section 836 being wider than the outboard inner section 834. The outboard inner section 834 can be useful to run wires, cables or powerlines. As can be seen, the outboard wall 820, the top wall 822 and the top inboard wall portion 824 can be made from a single piece of metal bent to form the desired shape. The bottom inboard wall portion 826 and a bottom wall 830 can also be made integral with one another using a piece of metal bent to form the desired shape. The rail 320 can be formed by assembling and welding the partition wall 832 to one of two bent pieces, and welding the other one to the subassembly. Other configurations, arrangements and manufacturing methods are possible.

The bottom of the base structure 350 can include a rigid supporting frame 840. The frame 840 includes a top section extending substantially parallel to the top wall 822 of the rail 320, and a lateral section extending substantially parallel to the top inboard wall portion 824 thereof. The frame 840 carries three different pairs of spaced apart rollers. The rollers of each pair are positioned at spaced apart locations along the longitudinal length of the base structure 350. FIG. 44 shows one roller of each pair. The first is a top roller 842 engaging the flat and continuous upper surface of the top wall 822 of the rail 320. This top roller 842 rotates about a horizontal axis 844 extending in the transversal direction. The two top rollers 842 can be seen in FIG. 48. They support substantially the entire vertical load. The second roller is a lateral roller 850 engaging the flat and continuous lateral exterior surface of the bottom inboard wall portion 826 of the rail 320. This lateral roller 850 rotates about a vertical axis 852 extending between a bottom horizontal wall 854 and a flanged wall 856 extending parallel to the bottom horizontal wall 854. The two lateral rollers 850 can be seen in FIG. 48 because this figure does not show the rail 320 for the sake of illustration.

The third roller of each pair in the illustrated example is a central roller 860 located within the rail 320, at the center, just under the interior side of the top wall 822. This central roller 860 rotates about a vertical axis 862. The two central rollers 860 can be seen in FIG. 48. Each central roller 860 can be provided within the inboard inner section 836 through a corresponding supporting arrangement 870 located inside the inboard inner section 836, as shown. The outer peripheral surface of the central roller 860 is located close to the inner surface of the top inboard wall portion 824 and, on the opposite side, close to the inner surface of the partition wall 832. The width of this space, however, is larger than the outer diameter of the roller 860. Each supporting arrangement 870 can be rigidly attached to the frame 840 using a plurality of transversal connectors 872. These connectors 872 extend laterally from the outboard side of the lateral section of the frame 840, and can include a large nut 874 on the inboard side thereof. The connectors 872 can extend through the intervening space between the top and bottom inboard wall portions 824, 826 up to a central location where other structural components are present. At least one of the supporting arrangements 870 can include a substantially curved (S-shaped) flange 876 extending at the bottom. The bottommost portion of this curved flange 876 is located close to the inner surface of the bottom inboard wall portion 826. This bottommost portion provides a relatively large inboard surface area in the event of an engagement of these surfaces. This engagement can occur when the wheel chock 100 is deployed and/or retracted. The carriage subsystem 312 generally travels along the rail 320 only when the support arm subsystem 314 is in a retracted position and the rollers 842, 850, 860 normally keep it in position over the rail 320. Extending and retracting the support arm subsystem 314, however, can create a moment of force exceeding what the rollers 842, 850, 860 could hold. The bottommost portion of the curved flange 876 can prevent the parts from pivoting further when it temporarily engages the adjacent inner surface. Other configurations and arrangements are possible.

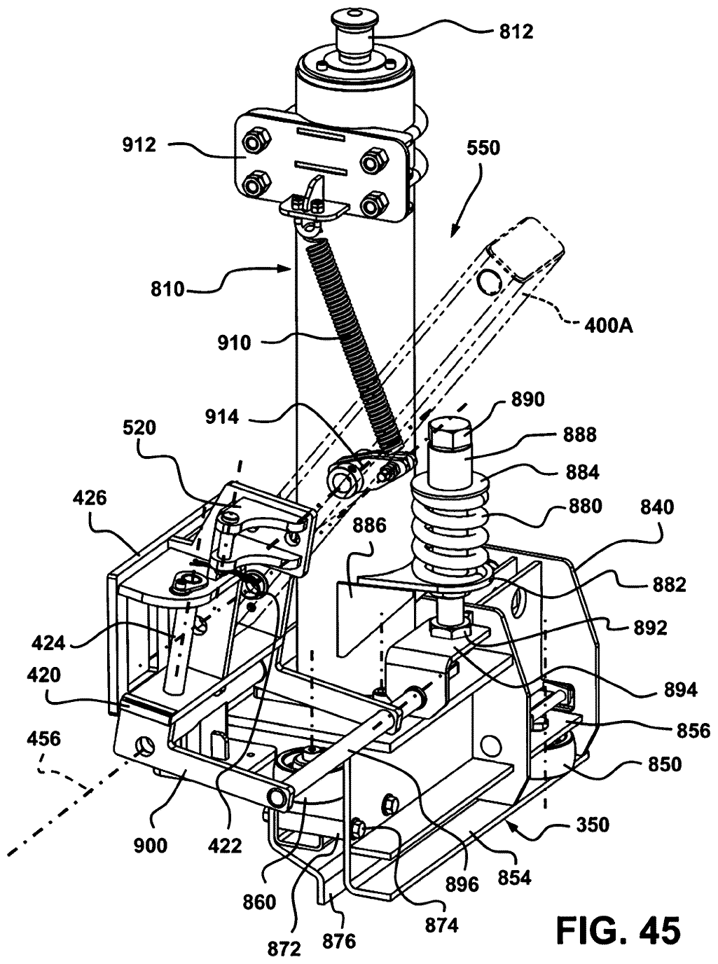

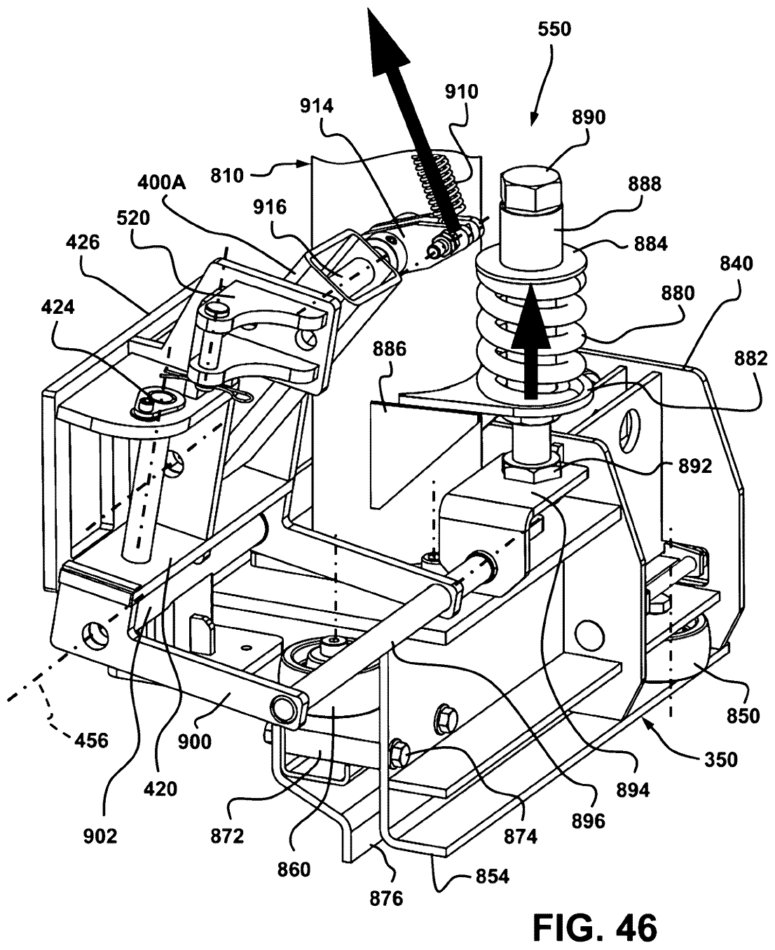

FIG. 45 is a partial isometric view of some of the parts at the proximal end of the support arm subsystem 314 of FIG. 41. FIG. 46 is an enlarged cutaway view of what is shown in FIG. 45.

FIGS. 45 and 46 show that the counterbalancing mechanism 550 in this example includes two complementary spring units working mostly sequentially. The first unit provides most of the counterbalancing force during the first half of the travel distance of the wheel chock 100 along the transversal path 332, and the second unit provides most of the counterbalancing force during the second haft thereof. The two units work in conjunction in the midway section.

The first spring unit can include a powerful compression spring 880 extending vertically between a supporting flange 882 at the bottom and a washer 884 at the top. The supporting flange 882 can be rigidly attached to the exterior surface of the post 810, for instance using brackets 886, as shown. The spring 880 generates an upward spring force pushing a tubular spacer 888 against the bottom peripheral surface of the head of an elongated bolt 890 around which the first spring 880 and the other associated parts are coaxially mounted in this example. The bottom end of the spring 880 rests against the top surface of the supporting flange 882 around the periphery of a central hole made across the supporting flange 882. The shank of the bolt 890 extends through this hole and its bottom end is attached to a corresponding nut 892 located underneath the supporting flange 882. The nut 892 is rigidly attached onto the top horizontal side of an L-shaped bracket 894, in registry with a hole made across the thickness of the bracket 894 to allow a variable length of the threaded end portion to extend under the bottom surface of the bracket 894. As shown in FIG. 46, the spring force generated by the first spring 880 urges the bolt 890 upwards and thereby also pulling the bracket 894 upwards. The bracket 894 further includes a vertical portion extending downwardly from one of the short side edges of the first rectangular portion to which the nut 892 is affixed. The first and second portions of the bracket 894 can be made integral with one another. The spring force generated by the spring 880 can be adjusted by rotating the bolt 890 using a tool. This will increase or decrease the spring force. Other configurations and arrangements are possible.

The second portion of the bracket 894 can pivotally receive the free end of a rectilinear axle 896 through which the spring force generated by the first spring 880 can be transferred to the proximal mounting plate 420. The axle 896 can be attached to the base of the proximal mounting plate 420 through a rectilinear pair of opposite arms 900 extending approximately in the transversal direction, as shown. The proximal end of the arms 900 can be affixed to a tubular member 902 coaxially disposed with reference to the pivot axis 456. The proximal mounting plate 420 is pivotally mounted to the base structure 350 by this pivotal joint. Other configurations and arrangements are possible.

The second spring unit can include a tension spring 910 extending between a static mount 912 attached near the top end of the post 810 and a swivel mount 914 that is pivotally attached to one side of the first proximal arm 400A. The static mount 912 can include a main rectangular plate affixed to the surface of the post 810 through a pair of U-bolts. The illustrated static mount 912 includes a bracket with an inverted U-bolt to which the upper end of the second spring 910 can be attached. FIG. 46 shows that the swivel mount 914 to which the bottom end of the second spring 910 can be attached is pivotally mounted on the side of the first proximal arm 400A using an axle 916 extending across the width of this arm. Other configurations and arrangements are possible.

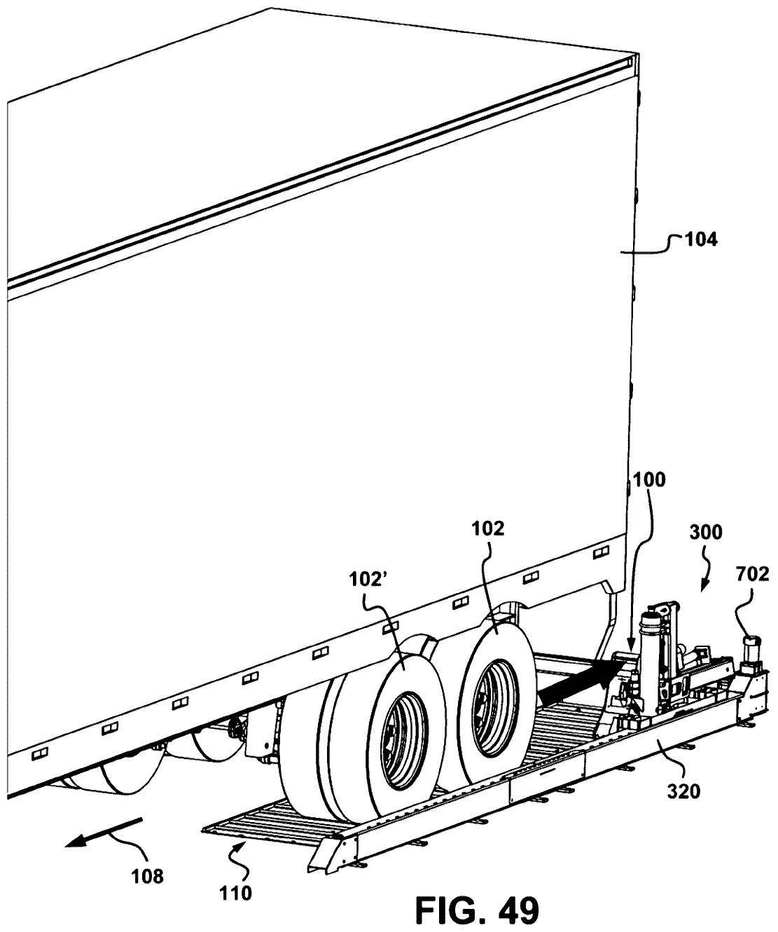

FIG. 47 is an abridged top view illustrating a wheel chock positioning arrangement 300 similar to the one of FIG. 41 but having another kind of translational mechanism 700. FIG. 48 is a side view of what is shown in FIG. 47. This translational mechanism 700 includes a drivebelt 730 forming a loop around a proximal pulley 732 at one end, and around a distal pulley 734 at the opposite end. The pulleys 732, 734 can be pivotally attached to the rail 320 or to another structure, and both rotate around a corresponding vertical axis. One end of the drivebelt 730 can be attached to the base structure 350 at a proximal anchor point 736, and the opposite end can be attached on the other side at a distal anchor point 738. The position of at least one of these anchor points 736, 738 can be made adjustable so as to adjust the tension in the drivebelt 730. A drive motor 702 can be provided at one of the ends to move the drivebelt 730 in one direction or the other, thereby moving the carriage subsystem 312 in the North-South directions. The illustrated example schematically shows the drive motor 702 (this drive motor 702 can be seen in FIG. 49). It is located at the proximal end of the wheel chock positioning arrangement 300, where it can be in a torque transmitting engagement with the proximal pulley 732. It is also possible to implement a clutch or the like that can automatically decouple or otherwise release the torque transmitting engagement between the drive motor 702 and the drivebelt 730. The drive motor 702 can be, for instance, an electric motor. Other configurations and arrangements are possible. Among other things, the design and/or position of at least one of the illustrated components can be different in some implementations. One or more of these components can also be omitted in others. The drive motor 702 can be another kind of motor, for instance a hydraulic motor or a pneumatic motor, instead of an electric motor. Other variants are possible as well.

It is worth noting that other configurations and arrangements are possible for one or more of the subsystems and/or the components thereof. Many features are also interchangeable. Among other things, the carriage subsystem could be implemented as a cart, such as a wheeled cart. This wheeled cart can be positioned at least partially over the ground surface. The track subsystem can have at least a portion located on the ground surface, such as a pair of longitudinally extending shallow channels in which the wheels of a cart can be guided. Also, the support arm subsystem could be implemented, for instance, as a mechanism similar to a pantograph having a proximal section and a distal section and an actuator to extend or retract these sections. Other variants are possible as well.

FIG. 49 depicts an example of a generic vehicle 104 backing up within the loading dock 130 without being properly aligned with the geometric centerline. This misalignment causes the side of the vehicle 104 to be close to the rail 320. The wheel chock 100 is shown at a storage position located at the proximal end of the rail 320 where it is suspended above the ground surface. However, in the example, the rear underride guard will eventually engage and collide with the wheel chock 100 if the vehicle 104 continues moving backwards along the same trajectory. The wheel chock 100 is a very solid object but forcefully pushing on it when it is in such a position can damage one or more parts of the support arm subsystem 314 and/or other parts within the wheel chock positioning arrangement 300. An analogous situation can occur if the driver of a vehicle departs from the location where it was parked just a few seconds before the support arm subsystem 314 completed the withdrawal of the wheel chock 100 from the base plate 110 and returned to a completely retracted position where the wheel chock 100 will be out of the way of the departing vehicle.

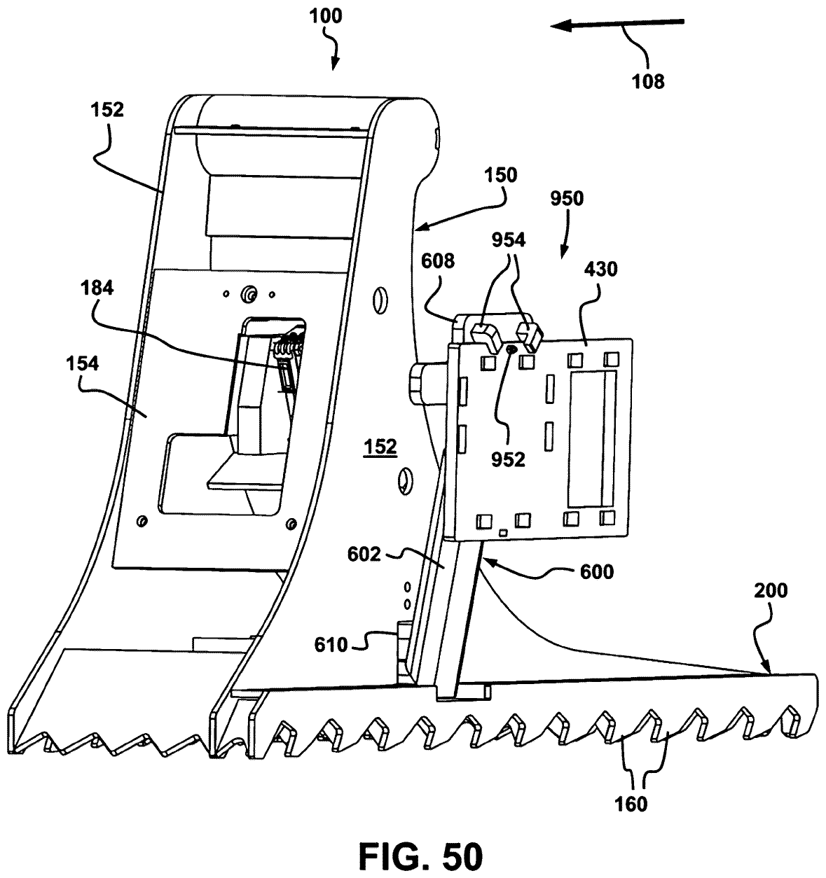

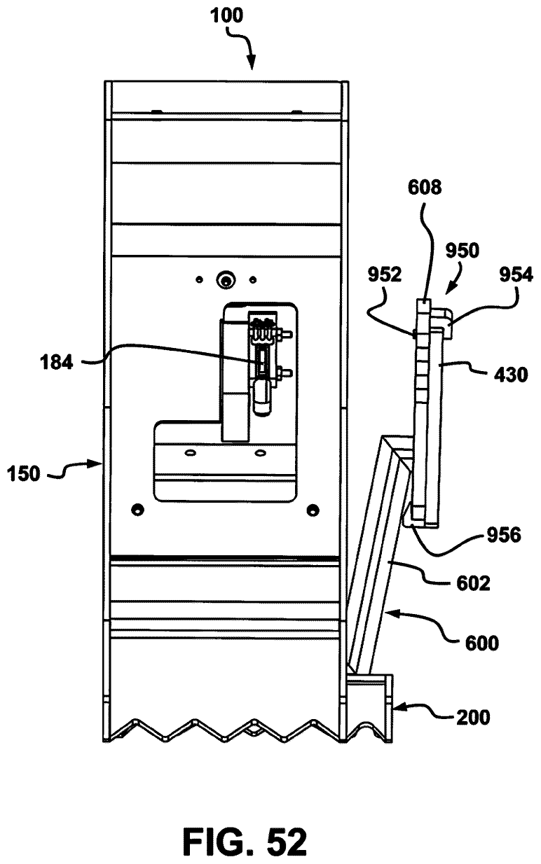

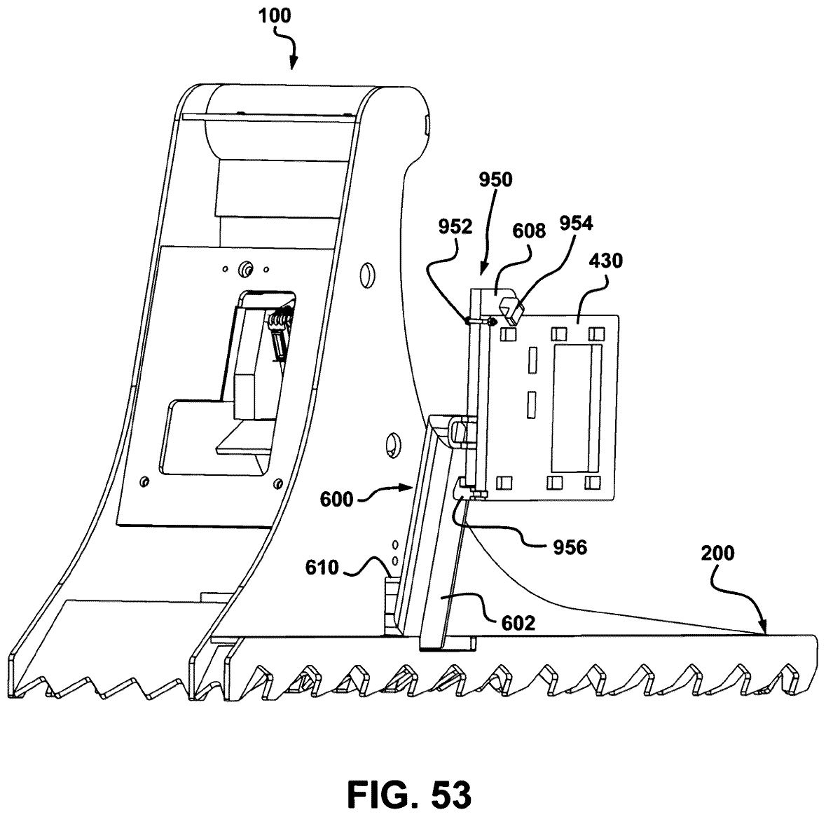

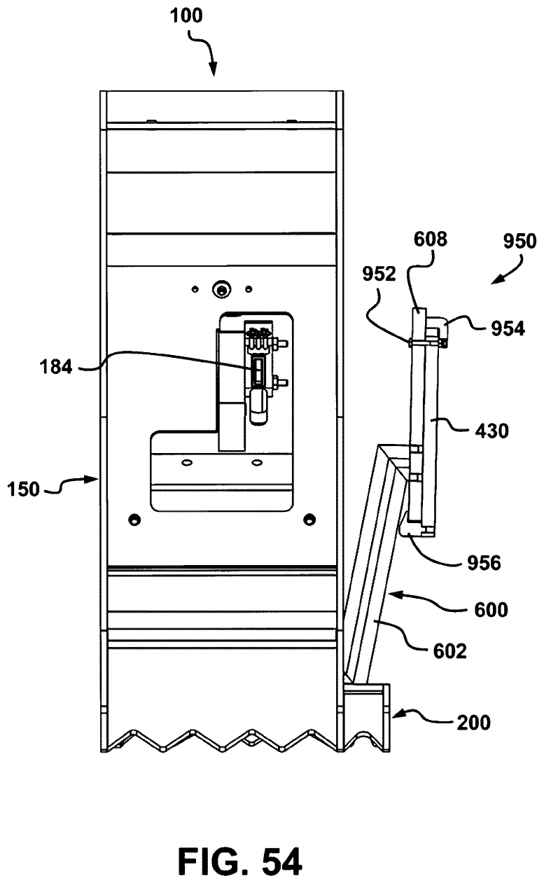

FIGS. 50 to 54 are views illustrating an example of a mechanical fuse subassembly 950 that can be provided on the wheel chock positioning arrangement 300 as proposed herein. FIGS. 53 and 54 show the mechanical fuse subassembly 950 in cross-section.

The mechanical fuse subassembly 950 can be added to the wheel chock positioning arrangement 300 in some implementations. It allows the wheel chock 100 to detach from a main section of the support arm subsystem 314 in the event of a collision. The mechanical fuse subassembly 950 can include a frangible element 952, such as a bolt or the like, that can rupture when subjected to a shear force exceeding a predetermined load, for instance forces applied on the wheel chock 100 in the South direction that could damage the support arm subsystem 314 or other parts of the wheel chock positioning arrangement 300.

The frangible element 952 is designed to be easily replaced when broken. The mechanical fuse subassembly 950 is provided near the distal end of the support arm subsystem 314, but it is not necessarily at the distal end. For instance, in the illustrated example, the mechanical fuse subassembly 950 is interposed between the distal junction of the articulated arms and the wheel chock mount 600 to which the wheel chock 100 is attached in this implementation. The mechanical fuse subassembly 950 has an inboard portion and an outboard portion that are held together by the frangible element 952. When it breaks, the wheel chock mount 600 and the outboard portion of the mechanical fuse subassembly 950 can detach from the rest of the support arm subsystem 314 and they will fall to the ground with the wheel chock 100. Other configurations are arrangements are possible. Among other things, the parts can be constructed and/or positioned differently in some implementations. Some parts can also be replaced by other features or be omitted entirely. Other variants are possible as well.

The mechanical fuse subassembly 950 can also be designed to break more easily when subjected to a force applied on the wheel chock 100 in a first direction compared to a second direction. For example, the breaking force in the horizontal direction can be different compared to the breaking force in the vertical direction. The frangible element 952 is designed to break if a load exceeding a predetermined value is applied on the side of the wheel chock 100 when the wheel chock 100 is not in a latching engagement with the base plate 110 that transfers the forces to the base plate 110. For instance, if the vehicle 104 collides forcefully with the wheel chock 100 when it is in a storage position, like in the example shown in FIG. 49, the shear force will break frangible element 952 and the wheel chock mount 600 will detach from the distal mounting plate 430. The wheel chock 100 can then pivot to drop on the ground surface.

The mechanical fuse subassembly 950 can include two spaced apart L-shaped hooks 954 on the proximal base portion 608 and extending over the top edge of the distal mounting plate 430. The top hooks 954 can be rigidly attached to the proximal base portion 608, for instance being welded. The mechanical fuse subassembly 950 can also include a bottom holding member 956 located under the bottom edge of the proximal base portion 608. Other configurations are arrangements are possible. Among other things, the parts can be constructed and/or positioned differently in some implementations. Some parts can also be replaced by other features or be omitted entirely. Other variants are possible as well.

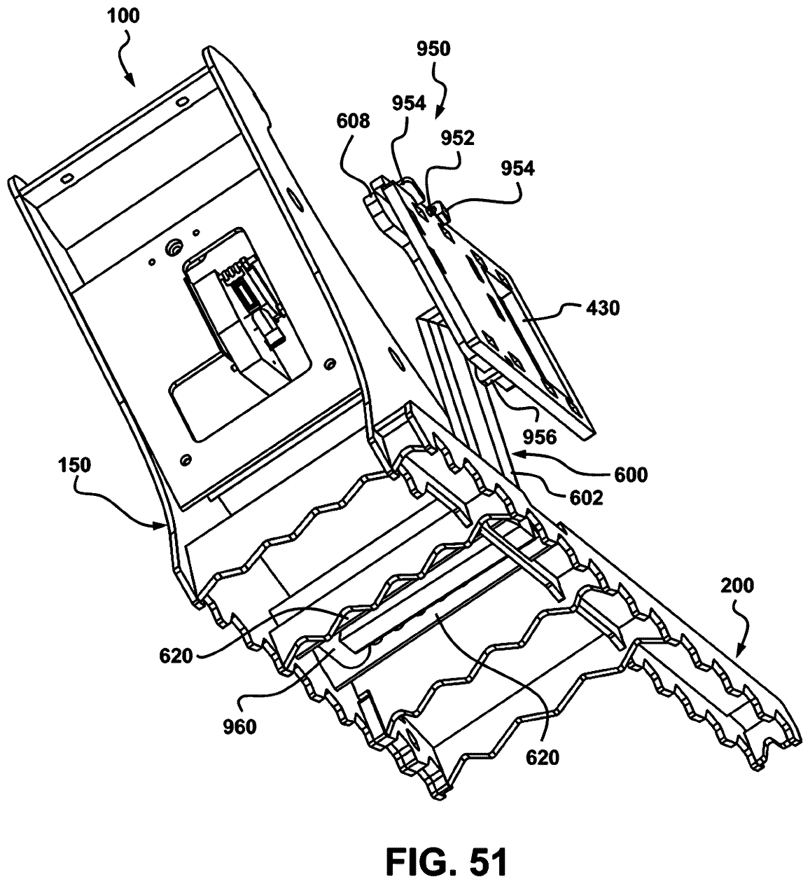

FIG. 51 further shows that the distal end of the wheel chock mount 600 can include a sleeve 960 instead of a hole 604 (FIG. 19). The sleeve 960 is affixed to the support member 602. Other configurations and arrangements are possible.

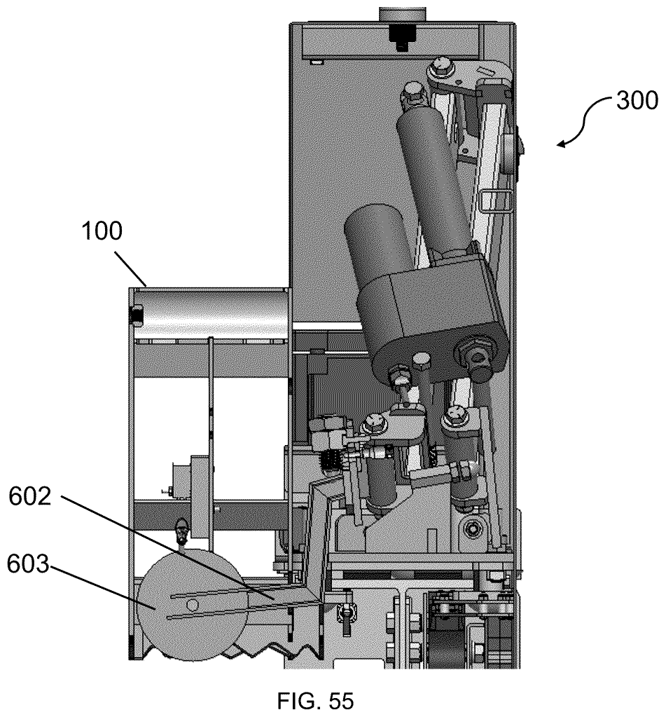

FIG. 55 shows a detail of a wheel chock positioning system according to the present description comprising a support member 602 and a positioning wheel 603. It has been discovered that using a positioning wheel 603 to assist the movement of the wheel chock 100 and of the wheel chock positioning arrangement 300 reduces the normal downward force exerted by wheel chock 100 and by the arrangement 300. For example, it has been discovered that the arrangement 300 shown in FIG. 28 may exert approximately 65 lb of downward force. Accordingly, the actuating mechanism for the wheel chock positioning arrangement 300 exerts a force greater than 65 lb to move the wheel chock 100 into and out of position. Use of a positioning wheel 603 as shown in FIG. 55 reduced the exerted downward force by approximately 43%. Reducing the downward force improves the performance of the wheel chock positioning arrangement 300 by reducing component wear and friction, as well as reducing the energy needed to displace the wheel chock 100. Accordingly, operating costs for the wheel chock positioning arrangement 300 are also reduced. Advantageously, the wheel chock positioning arrangement 300 shown in FIG. 55 allows the wheel chock 100 to exert force on an object present in its path, including but not limited to snow, ice and/or debris, without requiring increased force exertion by the actuator. Accordingly, the arrangement 300 shown in FIG. 55 provides improved safety and operability regardless of the presence of objects or other obstacles in the wheel chock's path.

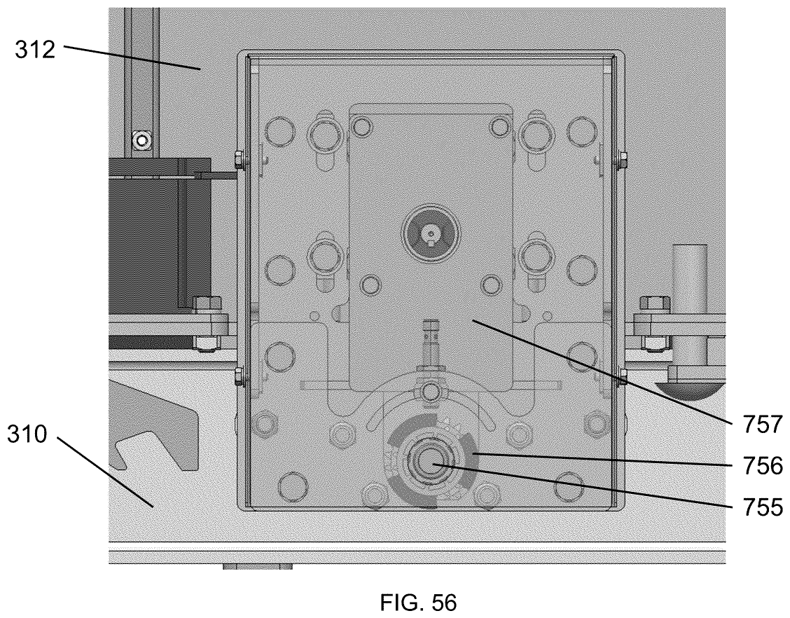

Referring now to FIG. 56, a detail of components for detecting, monitoring and/or measuring a position of the wheel chock positioning arrangement 300 comprises a guide wheel 755 having a plurality of indexing means 756 thereon. In the embodiment shown on FIG. 56, the indexing means 756 comprise three elements of equal size and equally spaced from each other placed along the perimeter of the guide wheel 755. The guide wheel 755 is configured to rotate when the wheel chock positioning arrangement 300 extends or retracts to position the wheel chock 100. Similarly to how the wheel chock positioning arrangement 300 measures displacement in FIG. 26, a sensor 757 uses the index means 756 or the gaps therebetween to monitor the position of the positioning system. As described for the embodiment shown in FIG. 26, the sensor 757 may be a photoelectric device operatively connected to a processor and/or to control means for the positioning system. For example, the sensor 757 may comprise a light source or a laser transmitter outside of the perimeter of the guide wheel 755, and a photoelectric receiver inside the perimeter of the guide wheel that can detect a light beam or a laser beam when passing through a gap between the index means. In another example, the light source or laser transmitter and the receiver may be located on the same side of the guide wheel 755 and the index means 756 may be configured to reflect the light or the laser beam towards the receiver. Accordingly, absence of an incident beam on the receiver corresponds to the beam traveling through a gap between the index means 756. Counting the detections of a light or laser beam, or lack thereof, can be indicative of the distance travelled by the positioning system from a given location or position.

It is understood that the wheel chock positioning arrangement 300 as described herein is operable without measuring and/or detecting means such as the guide bar 750 and the guide wheel 755. In general, the wheel chock positioning arrangement 300 may be configured to position one or more wheel chocks 100 in predetermined positions without requiring feedback.

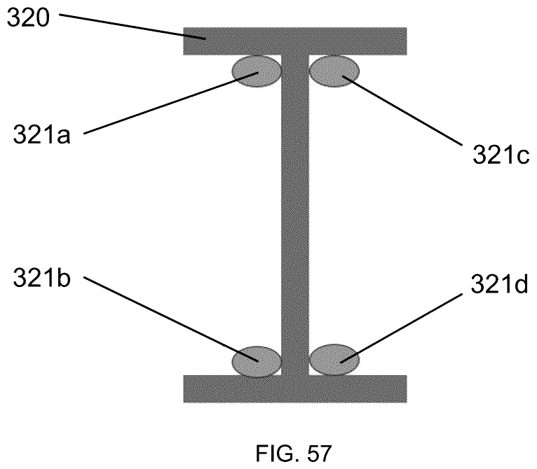

Referring now to FIG. 57, in an embodiment a rail such as the rail 320, shown in FIG. 22, is provided with a plurality of heating means. FIG. 57 shows a cross-section of the rail 320 having four heating wires 321a-321d positioned such that the upper and lower operating surfaces of the rail 320 can be heated. The heating wires 321a-321d in FIG. 57 extend longitudinally along at least a portion of the length of the rail 320, and may extend along the entire length of the rail 320. It is understood that less than four heating wires, and/or different means for delivering heat to the rail 320 are possible. For example, two heating wires may be provided such that the upper operating surface of the rail 320 is heated. Heating the rail 320 facilitates the operation of the wheel chock positioning arrangement 300 in cold weather, for example in truck receiving areas having frequent exposure to very cold outside air, or having no barrier between the outside environment and the wheel chock positioning arrangement 300. The wheel chock positioning arrangement 300 having one or more heating means positioned on the rail 320 may operate at very cold temperatures, for example up to −20 degrees.

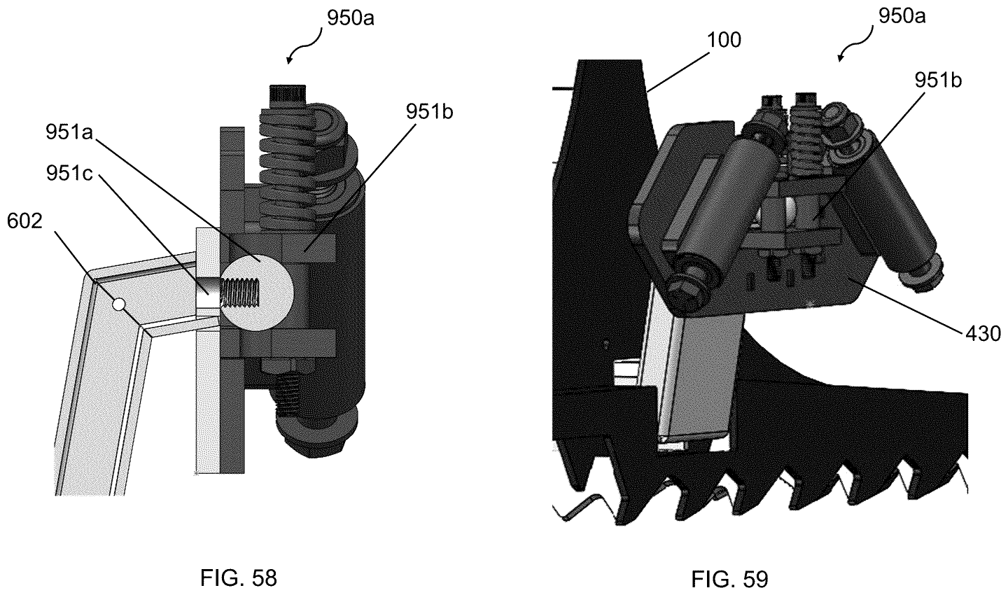

Referring now to FIG. 58 and FIG. 59, a mechanical fuse subassembly 950a according to an embodiment comprises a ball-and-socket system configured to disengage the wheel chock 100 from the wheel chock positioning arrangement 300 in response to a predetermined force. As shown in FIG. 58, a ball portion 951a is mounted to the support member 602 by means of a screw 951c. A socket subassembly 951b is mounted to the distal mounting plate 430 and is located between the hinges 432 and 434. The socket subassembly 951b is configured to receive the ball portion 951a therein and to retain the ball portion 951a during normal operation of the wheel chock positioning arrangement 300. Shown in FIG. 59 is a socket subassembly 951b having a combination of plates and rods for constraining the translational movement of the ball portion 951a. It is understood that other configurations for the socket subassembly 951b are possible, including but not limited to substantially hemispherical configurations and other configurations suitable for receiving a ball joint therein and for disengaging from said ball joint in response to a predetermined force. During displacement, the wheel chock 100 may encounter an obstacle, such as ice or debris. Portions of the wheel chock 100 may accidentally catch on the base plate 110. Accordingly, a force is exerted on the ball and socket mechanical fuse subassembly 950a. The ball portion 951a may disengage from the socket subassembly 951b in response to a predetermined force being exerted, for example by the wheel chock positioning arrangement 300 continuing to attempt to displace the wheel chock 100. The ball portion 951a may disengage from the socket subassembly 951b in response to a force being exerted in a particular direction. For example, the socket subassembly 951b may be configured to disengage the ball portion 951a in response to a force angle exceeding a predetermined threshold, which would indicate an impairment to the movement of the wheel chock 100.

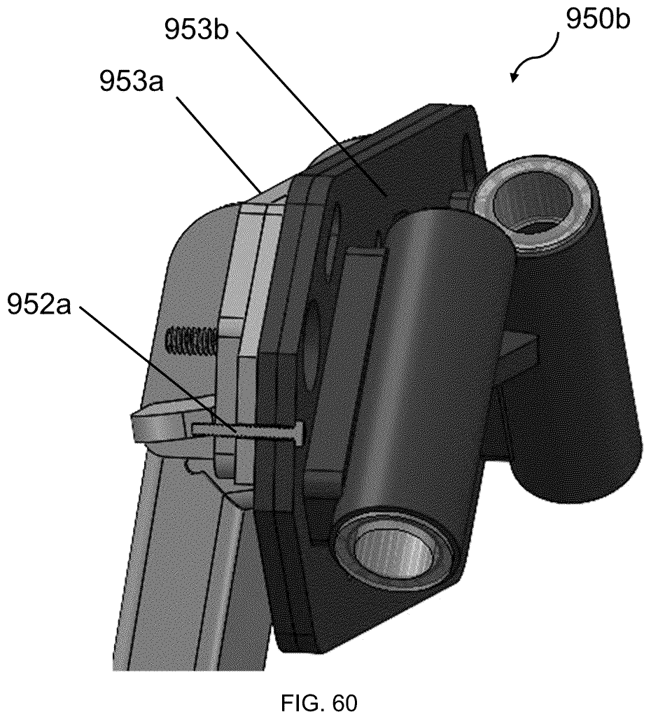

Referring now to FIG. 60, a mechanical fuse subassembly 950b similar to the mechanical fuse subassembly 950 shown in FIG. 54 comprises a frangible element 952a connecting an outboard portion 953a and an inboard portion 953b of the mechanical fuse subassembly 950b. The frangible element 952a is positioned substantially adjacent to the distal end of the support member 602 and is configured to break in response to a shear force greater or equivalent to a predetermined threshold being exerted thereon. It is understood that suitable combinations of the position of the frangible element 952a with respect to the support member 602 and of the mobility of the outboard and inboard portion of the fuse subassembly 952a with respect to each other will produce different shear forces in response to an obstacle or to another impediment to the movement of the wheel chock positioning arrangement 300. Accordingly, the wheel chock positioning arrangement 300 can comprise a mechanical fuse subassembly adapted to the intended use and to the conditions in which the arrangement 300 is expected to operate.

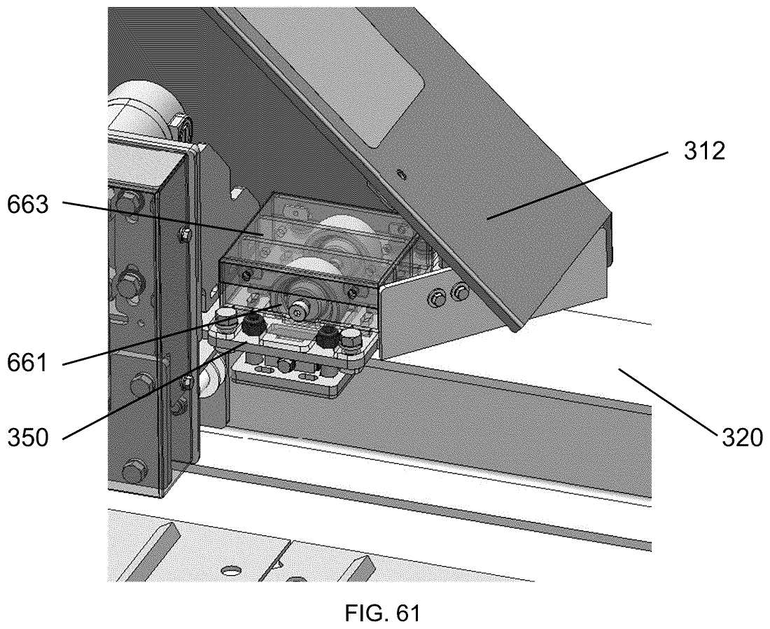

Referring now to FIG. 61, means for displacing the wheel chock positioning arrangement 300 in a north-south direction comprise, in one embodiment, one or more wheels 661 configured to be mounted to the base structure 350. It is understood that the one or more wheels 661 can replace one or more, or all the low-friction elements 660. Additionally, the bottom low-friction element 662 may also be replaced by one or more wheels. In the embodiment shown in FIG. 61, the base structure 350 comprises apertures, each aperture being configured to receive a wheel 661 therethrough. The wheels 661 are mounted to a carrying assembly 663 configured, in turn, to retain the wheels 661 in position and to be mounted to the base structure 350, such that the wheels 661 extend through the apertures to contact the rail 320 and support the base structure 350 above the rail 320.

It is understood that the wheel chock positioning arrangement 300 as described herein may be implemented as a semi-automated or as a fully automated vehicle immobilization system. Such a system comprises at least one wheel chock received on a support member supported by a transversal displacement means, the transversal displacement means being configured to extend in a transversal direction from a storage position to an extended position and to at least partially pivot downwards during the extension, thereby lowering the wheel chock. The system also comprises longitudinal displacement means, such as a carriage subsystem for moving along a track subsystem, the carriage subsystem having the transversal displacement means mounted thereto. At least some or all the steps of immobilizing a vehicle may be automated. For example, one or more sensors can detect a position of at least one wheel of the vehicle to be immobilized. The sensors provide data to a controller, a processor, or both. In response to the sensor data, the processor or the controller may determine a blocking position in which to position the wheel chock such that accidental departure of the vehicle is prevented. The controller or the processor then cause the system to displace the chock both longitudinally and transversally using the displacement means described above to place the chock in the blocking position. While it is understood that the steps described above may be implemented by a simple controller, for example a Programmable Logic Controller (PLC), the system as described herein may be implemented using in-situ processors, remote processors or both, and comprise either or both local and remote memories for storing data and instructions required to operate the wheel chock positioning arrangement 300 and the system as described above.

The present detailed description and the appended figures are meant to be exemplary only, and a skilled person will recognize that variants can be made in light of a review of the present disclosure without departing from the proposed concept. Among other things, and unless otherwise explicitly specified, none of the parts, elements, characteristics or features, or any combination thereof, should be interpreted as being necessarily essential to the invention simply because of their presence in one or more examples described, shown and/or suggested herein.

### LIST OF REFERENCE NUMERALS

100 wheel chock
102 wheel
102′ wheel
104 vehicle
104A chassis (swap body)
104B container (swap body)
104C leg (swap body)
106 ground surface
108 longitudinal axis
110 base plate
112 blocking element
114 main plate member
120 wheel chock restraint system
122 rim
124 tire
126 tire sidewall
128 tire tread
130 loading dock
132 wall
134 cushion
140 cargo compartment
142 dock door
144 floor (of the cargo compartment)
146 floor (in front of the garage door)
150 main body (of the wheel chock)
152 side member
154 transversal member
160 tooth
162 flange or blade
170 wheel-facing side
172 tire deformation cavity
174 upper front edge
176 top plate
180 wheel-engaging bulge
182 bulge engagement point
184 wheel sensor
186 wire connector
190 center of gravity
200 extension
210 protruding portion (of the extension)
212 base portion (of the extension)
220 lateral member
222 transversally extending bracket
224 elongated horizontally disposed top strip
250 rearward travel direction
300 wheel chock positioning arrangement
310 track subsystem
312 carriage subsystem
314 support arm subsystem
320 rail
321a-d heating means (for the rail)
322 proximal end plate
330 longitudinal path
332 transversal path
332A cured portion (of the transversal path)
340 bedplate
350 base structure (of the carriage subsystem)
360 proximity sensor
362 marker
370 distal end plate
380 scanning device
400 first articulated cantilever arm assembly
400A first proximal arm (of first articulated cantilever arm assembly)
400B first distal arm (of first articulated cantilever arm assembly)
402 second articulated cantilever arm assembly
402A second proximal arm (of second articulated cantilever arm assembly)
402B second distal arm (of second articulated cantilever arm assembly)
410 intermediate hinge (between the first proximal arm and the first distal arm)
412 intermediate hinge (between the second proximal arm and the second distal arm)
420 proximal mounting plate
422 hinge (at the proximal end of the first proximal arm)
424 hinge (at the proximal end of the second proximal arm)
426 back plate
430 distal mounting plate
432 hinge (for the distal end of the first distal arm)
434 hinge (for the distal end of the first distal arm)
450 lateral support
452 reinforcing member
454 pivot joint
456 pivot axis
500 actuator mechanism
510 actuator
512 rod
520 proximal mount
522 distal mount
530 drive motor (of the actuator)
532 connector
550 counterbalancing mechanism
560 bolt
562 bolt head
570 spring
600 wheel chock mount
602 support member (of the wheel chock mount)
603 positioning wheel (of the wheel chock mount)
604 distal through holes/sleeve (of the wheel chock mount)
606 pivot axis
608 proximal base portion (of the wheel chock mount)
610 side opening
612 interspace
620 transversal wall
622 hole
630 connector
640 first position sensor
642 bracket
644 second position sensor
650 top flange (of the rail)
652 bottom flange (of the rail)
654 web (of the rail)
660 low-friction element (top)
661 wheels
662 low-friction element (bottom)
663 carrying assembly (for the wheels)
700 translational mechanism
702 drive motor (of the translational mechanism)
710 casing
712 reinforcing wall
714 first sprocket
716 chain
718 second sprocket
720 cord
722 proximal anchor point
724 distal anchor point
730 drivebelt
732 proximal pulley
734 distal pulley
736 proximal anchor point
738 distal anchor point
740 pulley
742 outboard mounting plate
744 central mounting plate
746 inboard mounting plate
750 guide bar
752 aperture
754 position sensor (for the guide bar)
755 guide wheel
756 index means (for the guide wheel)
757 position sensor (for the guide wheel)
760 second wall
770 slopped surface
780 wire
782 wire
784 wire
786 junction box
790 control unit
792 wire
794 safety panel
796 wire
800 vehicle proximity sensor
802 base plate sensor
804 beam (from the vehicle proximity sensor)
810 post
812 emergency stop button
820 outboard wall
822 top wall
824 top inboard wall portion
826 bottom inboard wall portion
830 bottom wall
832 partition wall
834 outboard inner section
836 inboard inner section
840 frame
842 top roller
844 horizontal axis (of top roller)
850 lateral roller
852 vertical axis (of the lateral roller)
854 bottom horizontal wall
856 flanged wall
860 central roller
862 vertical axis
870 supporting arrangement
872 connector
874 nut
876 curved flange
880 first spring
882 supporting flange
884 washer
886 bracket
888 spacer
890 bolt
892 nut
894 bracket
896 axle
900 arm
902 tubular member
910 second spring
912 static mount
914 swivel mount
916 axle
950 mechanical fuse subassembly
950a mechanical fuse subassembly
950b mechanical fuse subassembly
951a ball portion
951b socket subassembly
951c screw
952 frangible element
952a frangible element
953a outboard portion
953b inboard portion
954 hook
956 bottom holding member
960 sleeve

1. A wheel chock handling apparatus comprising:
a support arm arrangement including
a lateral support;
a mounting plate connected to the lateral support;
a first cantilever arm assembly and a second cantilever arm assembly each having opposite first ends and second ends, wherein:
the first ends are pivotally mounted to the mounting plate for angular displacement of the first assembly and the second assembly in a transversal direction between a storage position and an extended position; and
the second ends are pivotally connected to a wheel chock mount configured to receive a wheel chock thereon;
a track extending in a longitudinal direction; and
a carriage for mounting the support arm arrangement thereto and configured to move along the track.

2. The apparatus of claim 1, wherein the support arm arrangement enables the mounting plate to pivot downwardly thereby lowering the wheel chock.

3. The apparatus according to claim 1, wherein the wheel chock mount comprises a support member extending substantially transversally and wherein a body of the wheel chock defines an aperture for receiving the support member therethrough.

4. The apparatus according to claim 3, further comprising a wheel mounted to the support member for supporting the support member, and wherein the wheel chock is configured to receive the support member and the wheel through the aperture.

5. The apparatus according to claim 1, further comprising displacement detection means for measuring a displacement of the carriage along the track.

6. The apparatus according to claim 5, wherein the track further comprises a guide bar including a plurality of apertures, the apertures being substantially equally sized and substantially equally spaced, and the displacement detection means comprises a sensor assembly mounted to the carriage and configured to detect a beam traveling through the apertures.

7. The apparatus according to claim 6, wherein the displacement detection means comprises an index wheel mounted to the carriage and in contact with the track.

8. The apparatus according to claim 1, wherein the carriage comprises at least one low-friction element disposed between the track and the carriage for sliding the carriage on the track.

9. The apparatus according to claim 1, wherein the carriage comprises at least one wheel mounted thereto for displacing the carriage on the track.

10. The apparatus according to claim 1, further comprising:
one or more sensors for determining a position of at least one wheel of a vehicle;
displacement detection means for measuring a displacement of the carriage along the track;
a controller operatively connected to the one or more sensors, the displacement detection means, the support arm arrangement and the carriage;
wherein the controller is configured to cause the apparatus to displace the wheel chock supported on the support arm arrangement to a wheel blocking position associated with the determined position of the at least one wheel of the vehicle.

11. The apparatus according to claim 1, further comprising at least one mechanical fuse subassembly, the mechanical fuse subassembly comprising an outboard portion proximate the wheel chock and an inboard portion proximate the second ends of the first and second assemblies, wherein the outboard portion and the inboard portion are configured to separate in response to a force exerted on the mechanical fuse subassembly exceeding a predetermined threshold.

12. The apparatus according to claim 11, further comprising at least one frangible element configured to break in response to a predetermined force, extending between the outboard portion and the inboard portion, and wherein the at least one frangible element provides the sole structural connection between the outboard portion and the inboard portion.

13. The apparatus according to claim 11, wherein the mechanical fuse subassembly comprises a ball portion on one of the outboard and inboard portions and a socket portion on the other of the outboard and inboard portions, the socket portion being configured to receive the ball portion therein and to disengage from the ball portion in response to a predetermined force.

14. The apparatus according to claim 1, wherein the track further comprises heating means for heating at least a portion of the track.

15. The apparatus according to claim 1, wherein the first assembly and the second assembly are articulated.

16. The apparatus according to claim 1, wherein the first assembly and the second assembly are telescopic.

17. The apparatus according to claim 1, wherein the first assembly and the second assembly are mounted to the mounting plate so as to define an angle between the first assembly and the second assembly.

18. The apparatus according to claim 1, wherein the first assembly and the second assembly are mounted to the mounting plate so as to substantially define a V-shape having a downwardly pointing vertex.

19. The apparatus according to claim 1, wherein the wheel chock is configured to stop both forward and rearward movement of a vehicle wheel.

20. A method of securing a wheel chock on a base plate, comprising:
determining a longitudinal and a transversal position of a wheel to be blocked by the wheel chock;
determining a blocking position for the wheel chock in response to the longitudinal and transversal position of the wheel;
displacing the wheel chock in a longitudinal direction towards the blocking position;
engaging the wheel chock with the base plate; and
sliding the wheel chock on the base plate in a transversal direction to the blocking position.

21. The method according to claim 20, further comprising providing first engagement means on a bottom portion of the wheel chock and second engagement means on the base plate, the second engagement means being complementary to the first engagement means, and wherein the engaging the wheel chock comprises engaging the second engagement means and the first engagement means to prevent movement of the wheel chock in the longitudinal direction.

22. A vehicle immobilization system comprising:
a ground-anchored base plate;
at least one wheel chock, the wheel chock having a body defining an aperture for receiving a support member therethrough;
transversal displacement means having a first end mounted to a base and a second end having the support member mounted thereto, configured to:
support the wheel chock on the support member;
displace the wheel chock in a transversal direction between a storage position and an extended position; and
longitudinal displacement means for displacing the transversal displacement means in a longitudinal direction.

23. The system according to claim 22, further comprising:
sensor means for detecting:
a position of at least one wheel of a vehicle; and
a position of the transversal displacement means in the longitudinal direction;
a processor operatively coupled to the sensor means, the transversal displacement means and the longitudinal displacement means;
non-transient storage means for storing instructions that, when executed by the processor, cause the system to:
detect the position of the at least one wheel of the vehicle;
determine a blocking position for the at least one wheel chock to block movement of the wheel in a departure direction;
cause the longitudinal displacement means to displace the transversal displacement means to a longitudinal position associated with the blocking position; and
cause the transversal displacement means to extend from a storage position towards an extended position to place the wheel chock in the blocking position.

24. The system according to claim 22, wherein the wheel chock comprises a plurality of teeth disposed on a lower surface and the base plate comprises a plurality of transversely extending projections complementary to the plurality of teeth.
